(19) United States
(12) Patent Application Publication
(10) Pub. No.: US 2026/0324590 A1
(43) Pub. Date: Oct. 22, 2026

(54) Integrated Multimodal Sensory Processing System for Cross-Species State Estimation

(71) Applicant: QOMPLX LLC, Reston, VA (US)

(72) Inventors: Jason Crabtree, Vienna, VA (US); Richard Kelley, Woodbridge, VA (US); Jason Hopper, Halifax (CA); David Park, Fairfax, VA (US)

(21) Appl. No.: 19/183,828

(22) Filed: Apr. 19, 2025

Related U.S. Application Data
(63) Continuation-in-part of application No. 19/177,640, filed on Apr. 14, 2025.
Application No. 19/177,640 is a continuation-in-part of application No. 19/172,638, filed on Apr. 7, 2025.
Application No. 19/172,638 is a continuation-in-part of application No. 19/094,808, filed on Mar. 28, 2025.
Application No. 19/094,808 is a continuation-in-part of application No. 19/078,192, filed on Mar. 12, 2025.

(51) Int. Cl. A01K 11/00; A01K 29/00; A01K 61/00

(52) U.S. Cl. CPC A01K 11/008; A01K 29/005; A01K 61/00

(57) ABSTRACT

Disclosed embodiments enable integrated multimodal sensory processing for cross-species state estimation that can enhance understanding of animal behavior and training. Environmental stimuli are gathered across multiple sensory channels, including sight, sound, scent, and touch, as experienced by an animal, such as a service dog. Simultaneously, biometric parameters such as heart rate and breathing rate are tracked, alongside brainwave data collected from non-invasive sensors. These diverse data streams are compiled into a comprehensive database, creating a time-synchronized representation of the animal's physical and cognitive state in response to its environment.

### CROSS-REFERENCE TO RELATED APPLICATIONS

Priority is claimed in the application data sheet to the following patents or patent applications, each of which is expressly incorporated herein by reference in its entirety:
Ser. No. 19/177,640
Ser. No. 19/172,638
Ser. No. 19/094,808
Ser. No. 19/078,192

### BACKGROUND OF THE INVENTION

### Field of the Art

The present disclosure relates to the field of animal study. More specifically, the invention pertains to systems and methods that relate to state estimation.

### Discussion of the State of the Art

Historically, humans and animals have formed mutually beneficial partnerships that shaped the development of societies and daily life. Humans have provided shelter, food, and care, while animals contributed their strength, skills, and loyalty to support human endeavors. Horses transformed transportation, enabling faster travel across vast distances and playing a pivotal role in warfare, such as pulling chariots, carrying soldiers, and driving cavalry forces. Mules, known for their endurance and resilience, proved essential for transporting heavy loads in agriculture, mining, and construction, particularly in challenging terrains where machines faltered. Similarly, oxen have been indispensable in early farming, pulling plows and carts to help cultivate expansive fields long before modern tractors emerged. Similarly, dogs have also served diverse roles, from tracking and retrieving game during hunts to protecting livestock and property, and providing steadfast companionship. These enduring collaborations underscore how humans have relied on animals'diverse capabilities to overcome obstacles, expand civilizations, and propel technological progress.

### SUMMARY OF THE INVENTION

Disclosed embodiments provide a system and method for integrated multimodal sensory processing for cross-species state estimation, characterization, communication, and uncertainty determination. Disclosed embodiments can enable integrated multimodal sensory processing for cross-species state estimation that provides a powerful new approach to understanding and enhancing animal behavior and training. Disclosed embodiments can gather environmental stimuli across multiple sensory channels, including sight, sound, scent, and touch, as experienced by an animal, such as a service dog. Simultaneously, disclosed embodiments can track biometric parameters such as heart rate and breathing rate, alongside brainwave data collected from non-invasive sensors. These diverse data streams are compiled into a comprehensive database, creating a rich, time-synchronized representation of the animal's physical and cognitive state in response to its environment.

A key benefit of disclosed embodiments is the capability to analyze this extensive dataset to identify patterns and similarities across different species, forming a library of species-agnostic behavioral and physiological signatures. This cross-species insight enables training methodologies developed for one species, such as horses, to inform and accelerate the training of another species, such as dogs. For example, techniques used to train horses to navigate unfamiliar terrain or respond to subtle cues may share fundamental patterns applicable to guiding service dogs through complex, unfamiliar environments. By leveraging these interspecies parallels, the system expands the available training corpus, facilitating faster learning and enabling animals to master more intricate tasks. This approach not only reduces the time and resources needed for individual animal training but also can foster more adaptable and capable service animals, broadening their potential roles and improving their performance in dynamic, real-world scenarios.

According to a preferred embodiment, there is provided a system for integrated multimodal sensory processing comprising: an animal-wearable multimodal sensory processing device, wherein the animal-wearable sensory processing device includes multiple sensors; and a computing device comprising at least a memory and a processor; and a plurality of programming instructions that, when operating on the processor, cause the computing device to: establish a communication session with the animal-wearable sensory processing device; receive sensor data from the multiple sensors, wherein the sensor data includes brainwave data for an animal; process the sensor data through a machine-learning system, wherein the machine-learning system is configured to: generate a multimodal neural signature based on the sensor data; compare the multimodal neural signature that was generated to a database of multimodal neural signatures using a multidimensional comparison process; identify a cross-species state estimation set based on the comparing; and render and present an audio/visual form of the cross-species state estimation on an output device of the computing device.

According to another preferred embodiment, there is provided a method for integrated multimodal sensory processing, comprising: establishing a communication session with an animal-wearable multimodal sensory processing device, wherein the animal-wearable sensory processing device includes multiple sensors; receiving sensor data from the multiple sensors, wherein the sensor data includes brainwave data for an animal that is wearing the animal-wearable sensory processing device; processing the sensor data through a machine-learning system, wherein the machine-learning system is configured to: generate a multimodal neural signature based on the sensor data; compare the multimodal neural signature that was generated to a database of multimodal neural signatures using a multidimensional comparison process; identify a cross-species state estimation set based on the comparing; and render and present an audio/visual form of the cross-species state estimation on an output device of a computing device.

According to another embodiment, the animal-wearable sensory processing device further includes one or more actioning transducers.

According to another embodiment, the animal-wearable sensory processing device further includes one or more actioning transducers.

According to another embodiment, the animal-wearable sensory processing device further includes one or more actioning transducers.

According to another embodiment, the one or more actioning transducers include a haptic transducer.

According to another embodiment, the one or more actioning transducers include an acoustic transducer.

According to another embodiment, the animal-wearable sensory processing device further includes a scent dispenser.

According to another embodiment, the plurality of programming instructions further includes instructions to send a sensory cue to the animal-wearable sensory processing device based on the identified cross-species state estimation.

According to another embodiment, the plurality of programming instructions further includes instructions to send the sensory cue to the animal-wearable sensory processing device based on location information.

According to another embodiment, there is further included a Simultaneous Localization and Mapping (SLAM) system, and wherein the plurality of programming instructions further includes instructions to process directional-based information that is obtained from the SLAM system.

According to another embodiment, the multiple sensors of the animal-wearable sensory processing device include a camera.

According to another embodiment, the camera comprises a multispectral camera.

According to another embodiment, the multiple sensors of the animal-wearable sensory processing device include a scent detection sensor.

According to another embodiment, the scent detection sensor comprises a miniaturized gas chromatography device.

According to another embodiment, the scent detection sensor comprises an ion mobility spectrometer.

According to another embodiment, the scent detection sensor comprises a photoionization detector.

According to another embodiment, the animal-wearable sensory processing device comprises an animal collar.

According to another embodiment, the animal-wearable sensory processing device comprises a cetacean strap.

According to another embodiment, the plurality of programming instructions further includes instructions to generate a scent vector based on data obtained from the scent detection sensor.

According to another embodiment, there is provided a non-transitory, computer-readable medium comprising programming instructions for an electronic computation device executable by a processor to cause the electronic computation device to: establish a communication session with an animal-wearable sensory processing device, wherein the animal-wearable sensory processing device includes multiple sensors; receive sensor data from the multiple sensors, wherein the sensor data includes brainwave data for an animal; process the sensor data through a machine-learning system, wherein the machine-learning system is configured to: generate a multimodal neural signature based on the sensor data; compare the multimodal neural signature that was generated to a database of multimodal neural signatures using a multidimensional comparison process; identify a cross-species state estimation set based on the comparing; and render and present an audio/visual form of the cross-species state estimation on an output device of the computing device.

### BRIEF DESCRIPTION OF THE DRAWING FIGURES

FIG. 1 shows an exemplary environment in which a system for multimodal orchestration for human-animal-robot collaborative task execution can be used, in accordance with one or more embodiments.

FIG. 2 is a block diagram illustrating components of a system for multimodal orchestration for human-animal-robot collaborative task execution, in accordance with one or more embodiments.

FIG. 3 is a block diagram illustrating details of a neural interface component, in accordance with one or more embodiments.

FIG. 4 is a block diagram illustrating details of a translation processing unit, in accordance with one or more embodiments.

FIG. 5 is a block diagram illustrating details of a multi-species output unit, in accordance with one or more embodiments.

FIG. 6 is a block diagram illustrating details of a multi-species collaboration layer, in accordance with one or more embodiments.

FIG. 7 is a block diagram illustrating details of a large language model (LLM) orchestration system, in accordance with one or more embodiments.

FIG. 8 is a block diagram illustrating details of a Simultaneous Localization and Mapping (SLAM) system, in accordance with one or more embodiments.

FIG. 9 is a block diagram illustrating an exemplary training system, in accordance with one or more embodiments.

FIG. 10 shows an exemplary environment in which a system for integrated multimodal sensor processing for cross-species state estimation can be used, in accordance with one or more embodiments.

FIG. 11 shows another exemplary environment in which a system for integrated multimodal sensor processing for cross-species state estimation can be used, in accordance with one or more embodiments.

FIG. 12 is a block diagram illustrating components of a system for integrated multimodal sensor processing for cross-species state estimation, in accordance with one or more embodiments.

FIG. 13 is a block diagram illustrating components of a system for an animal-wearable multimodal sensory processing device, in accordance with one or more embodiments.

FIG. 14 is a block diagram illustrating components of another system for an animal-wearable multimodal sensory processing device, in accordance with one or more embodiments.

FIG. 15 shows exemplary animal brainwaves that can be analyzed using one or more embodiments.

FIG. 16 is a flow diagram illustrating an exemplary method for integrated multimodal sensor processing for cross-species state estimation, in accordance with one or more embodiments.

FIG. 17 is a flow diagram illustrating an exemplary method for training a system for integrated multimodal sensor processing for cross-species state estimation, according to one or more embodiments.

FIG. 18 illustrates an exemplary computing environment on which an embodiment described herein may be implemented, in full or in part.

FIG. 19 is a block diagram illustrating details of a comprehensive dual-embedding architecture incorporated within an animal-wearable multimodal sensory processing device for cross-species neural signature processing.

The drawings are not necessarily to scale. The drawings are merely schematic representations, not intended to portray specific parameters of the disclosed embodiments. The drawings are intended to depict only typical embodiments of the invention, and therefore should not be considered as limiting in scope.

### DETAILED DESCRIPTION OF THE INVENTION

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to use in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “brainwave data” refers to the electrical signals generated by the brain's neural activity, typically measured using techniques like electroencephalography (EEG). These signals reflect synchronized activity among large groups of neurons, oscillating at different frequencies that correspond to various mental states and cognitive functions.

As used herein, “multimodal sensory processing” refers to the ability to collect, integrate, and interpret information from multiple sensory modalities, such as vision, hearing, touch, smell, and internal biometric signals, to form a more complete and accurate understanding of an environment or situation.

As used herein, “large language model” (LLM) is a type of artificial intelligence model, typically based on deep learning, that is designed to process, understand, and generate human language. These models are trained on massive datasets of text and/or other data tokens, enabling them to predict the likelihood of sequences of words and/or tokens, understand context, and produce coherent and contextually relevant responses.

As used herein, “Simultaneous Localization and Mapping” (SLAM) is a technique where a robot or device can simultaneously build a map of an unknown environment and determine its position within that map. SLAM is well-suited for autonomous navigation in scenarios where pre-existing maps are unavailable.

### Conceptual Architecture

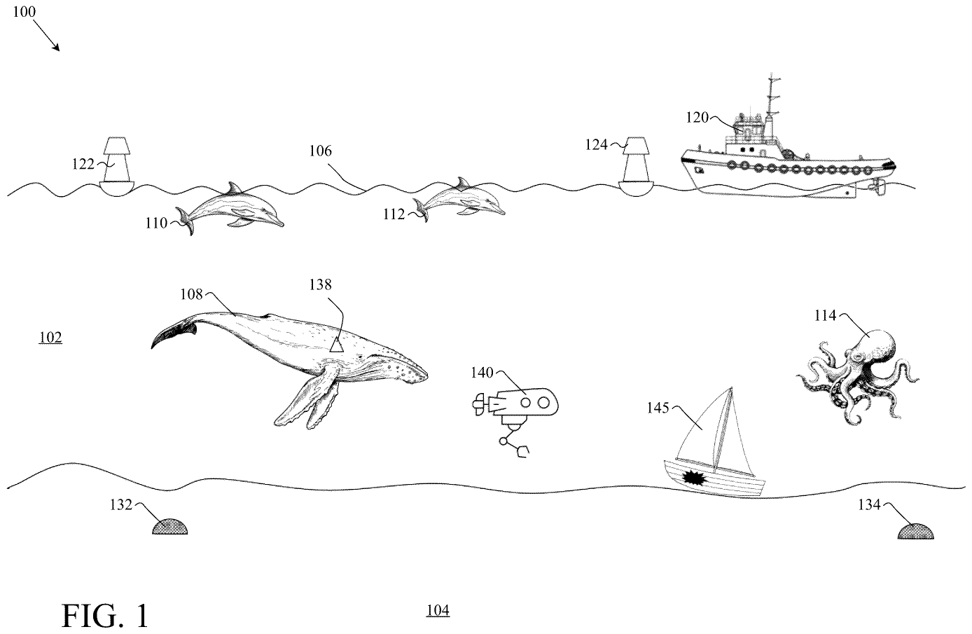

FIG. 1 shows an exemplary environment in which a system for multimodal orchestration for human-animal-robot collaborative task execution can be used, in accordance with one or more embodiments. Environment 100 can include a large body of water 102. However, disclosed embodiments are not limited to use in aquatic environments. Some embodiments may interact with land animals and/or flying animals and may be used in environments involving aquatic, land-based, and/or above-ground environments. Large body of water 102 can include an ocean (e.g., Pacific Ocean, Atlantic Ocean, etc.), a sea, (e.g., Mediterranean Sea, Baltic Sea, etc.), a lake (e.g., Lake Superior, Lake Victoria, etc.), a river (e.g., Mississippi River), a gulf (e.g., Gulf of Mexico), a bay (e.g., Hudson Bay), a strait (e.g., Bering Strait), a fjord, an estuary, a man-made reservoir, and/or other suitable large body of water.

The environment 100 can include one or more buoys, indicated as 122 and 124 in environment 100. In one or more embodiments, the buoys (122, 124) float on the surface 106 of the body of water 102, and can include a variety of equipment for sensing, receiving, storing, and/or transmitting data, as well as one or more output devices. The buoys can include one or more atmospheric sensors. The atmospheric sensors can include a wind speed sensor, wind direction sensor, air temperature sensor, air humidity sensor, barometric pressure sensor, solar radiation sensor, microphone, and/or other suitable atmospheric sensors.

The buoys can include one or more water-based sensors. The water-based sensors can include temperature sensors (to measure surface water temperature), salinity sensors (to determine the salt content of the water), pH sensors (to measure acidity/alkalinity), dissolved oxygen sensors (to monitor oxygen levels for aquatic life), and/or turbidity sensors (to measure water clarity). The water-based sensors may include wave height and direction sensors to measure ocean swell and surface conditions, current velocity sensors (to track underwater currents), tide and sea level sensors, and/or chlorophyll sensors (to estimate plankton levels and water productivity). The water-based sensors may include underwater microphones to detect underwater sounds from aquatic life and/or marine craft. The buoys can include one or more meteorological sensors, such as rain gauges and/or lightning detectors.

The buoys can include a variety of communication equipment, such as satellite transmitters (e.g., Iridium) for long-range communication. The buoys may include cellular modems, suitable for communication within areas of network coverage. The buoys may include radio transmitters to enable short-range transmission for local stations or vessels. The buoys may include Wi-Fi and/or Bluetooth modules to support local data access when in close proximity. The buoys may include GPS receivers to track buoy position and movement. Other communication systems may be present on the buoys in one or more embodiments. The buoys can include a wide variety of output devices, including, but not limited to, signal lights, audible alarms, underwater speakers, out-of-water speakers, and/or digital displays. The buoys can include a variety of computing devices, such as embedded microcontrollers, edge processors, data loggers, and/or other suitable computing equipment. In one or more embodiments, the buoys may include AI-based edge devices for advanced tasks such as detecting patterns, identifying marine life, and/or predictive analysis.

The environment 100 may further include one or more seafloor detection devices, that are located on seafloor 104, indicated at 132 and 134. Each seafloor detection device (132, 134) can include a seismometer, hydrophone array, and a wide range of other sensors and technologies for monitoring vibrations, seismic activity, and underwater sounds. The seafloor detection device can include a broadband seismometer for capturing a wide range of seismic frequencies. The seafloor detection device can further include a short-period seismometer to focus on high-frequency vibrations. The seafloor detection device can further include one or more accelerometers for measuring ground accelerations for vibrations caused by earthquakes, underwater landslides, or human-made activities such as drilling.

The hydrophone array within the seafloor detection devices can enable detecting soundwaves from marine mammals such as whales and dolphins. Other sounds may also be detected by the hydrophone array. These sounds can include sounds from underwater explosions, ship noise, or submarine movements. One or more hydrophones within the hydrophone array may be tuned for capturing low-frequency sounds from large marine animals and/or geological events. The seafloor detection devices may further include a current meter to track underwater currents that may result from tectonic and/or seismic activity.

In one or more embodiments, the seafloor detection devices may be communicatively coupled to one or more surface devices, such as buoys (122, 124), and/or ship 120. The communicative coupling can include cables, such as copper cables, fiber-optic cables, or the like, between a seafloor detection device and a buoy. The communicative coupling can include wireless communication such as RF-based communication and/or acoustic modems that can transmit data via sound waves to nearby surface buoys, ships, or other underwater devices.

The environment 100 can include ship 120. Ship 120 can contain one or more computing devices, such as a data server, virtualized computing environment, and/or other computing devices for enabling and/or supporting the multimodal orchestration system of disclosed embodiments. Additionally, ship 120 can provide long range communication to one or more remote servers, via the Internet. In one or more embodiments, ship 120 may be equipped with satellite communication (SATCOM). In embodiments, the ship 120 can be equipped with a satellite antenna. The satellite antenna can enable a connection with a geostationary satellite and/or a low-Earth-orbit (LEO) satellite, that in turn relays data to a ground station connected to the internet. The ship 120 may further be equipped with a cellular transceiver to utilize a cellular network when within the range of coastal areas.

Within the body of water 102, a wide variety of aquatic life may be present. The aquatic life can include one or more dolphins/porpoises, indicated at 110 and 112. These can include the Bottlenose Dolphin (Tursiops truncatus), Common Dolphin (Delphinus delphis), Dusky Dolphin (Lagenorhynchus obscurus), Harbor Porpoise (Phocoena phocoena), Spectacled Porpoise (Phocoena dioptrica), Orca or Killer Whale (Orcinus orca), and/or other varieties of dolphin/porpoise. These intelligent and diverse marine mammals contribute significantly to marine ecosystems and hold a special place in human culture and scientific research. Each species has its unique adaptations to its habitat, from the open ocean to coastal regions and even rivers. In embodiments, communication between the dolphins/porpoises for the multimodal orchestration system of disclosed embodiments may be accomplished by sending acoustic signals to the dolphins/porpoises and/or receiving acoustic signals from the dolphins/porpoises via buoys (122, 124) and/or seafloor detection devices (132, 134).

The aquatic life within body of water 102 can include one or more octopus/squid, indicated at 114. The octopus can include a Common Octopus (Octopus vulgaris), Giant Pacific Octopus (Enteroctopus dofleini), Mimic Octopus (Thaumoctopus mimicus), and/or other types of octopus. The squids can include a Giant Squid (Architeuthis dux), Colossal Squid (Mesonychoteuthis Hamiltoni), Common Squid (Loligo vulgaris), and/or other types of squids. Both octopuses and squids are among the most intelligent invertebrates, exhibiting behaviors that suggest advanced cognitive abilities, such as learning, problem-solving, and communication. In particular, octopuses have been known for their ability to solve complex puzzles, such as opening jars, navigating mazes, and manipulating objects in creative ways. Octopuses like the common octopus (Octopus vulgaris) have demonstrated learning through observation and trial-and-error. Additionally, some squids can learn to avoid predators by associating specific cues (like the presence of certain predators) with danger. These traits and abilities can be used for enabling multimodal orchestration for human-animal-robot collaborative task execution.

The aquatic life within body of water 102 can include one or more whales, indicated generally at 108. The whales can include Baleen whales (Mysticeti) and/or toothed whales (Odontoceti). The Baleen whales can include the Blue Whale (Balaenoptera musculus), Humpback Whale (Megaptera novaeangliae), Fin Whale (Balaenoptera physalus), Minke Whale (Balaenoptera acutorostrata), and/or other varieties of Baleen whale. The toothed whales can include a Sperm Whale (Physeter macrocephalus), Beluga Whale (Delphinapterus leucas), Narwhal (Monodon monoceros), and/or other types of toothed whale.

The environment 100 may include one or more marine life wearable electronic devices, such as indicated at 138, affixed to whale 108. The marine life wearable electronic device 138 can include one or more sensors, such as a GPS receiver. The GPS receiver may obtain geolocation data for the whale 108 at times when the whale surfaces. The marine life wearable electronic device 138 may further include one or more acoustic positioning sensors for using triangulation with other devices, such as buoys (122, 124) and/or seafloor detection devices (132, 134) to determine a relative position. The marine life wearable electronic device 138 may further include an accelerometer and gyroscope for tracking movement data, including swimming behavior, diving depth, and/or orientation.

Since whales may communicate via sound, and some whales use echolocation to navigate and find prey, the marine life wearable device 138 may include sensors to detect these sounds or transmit sounds to communicate with the whale 108. The sensors can include a hydrophone to detect vocalizations from the whale (such as songs, calls, or clicks) and record ambient underwater sounds. The marine life wearable device 138 may further include a transducer configured and disposed to emit sounds or vocalizations that can be heard by the whale, facilitating communication and/or behavioral studies. In embodiments, the transducer is tuned to output sounds in frequencies that whales can hear and interact with. In one or more embodiments, the marine life wearable device 138 may further include a haptic module. The haptic module can enable the marine life wearable device 138 to provide tactile feedback to the whale. The haptic vibrations can be delivered through components such as a waterproof vibration device that creates a physical sensation, in order to provide feedback to the whale.

The acoustic communication with whale 108 can include complex vocalizations and communication methods. These sounds can serve various purposes, including navigation, identification, mating, and social interactions. The types of sounds whales produce and the patterns they follow depend on the species, as different whales communicate in different ways. The sounds can include ‘songs.’ These songs are complex, long sequences of sounds that often repeat in patterns and can last for several minutes to hours. Male humpback whales are especially known for their songs, which may be used for mating purposes. The songs consist of different “themes” that are repeated in a specific order and may change over time. The songs can carry for miles underwater, allowing males to attract females or compete with other males.

The sounds can include clicks. The clicks can be short, sharp sounds that are used primarily for echolocation (a form of biological sonar). By emitting clicks and analyzing the returning echoes, whales can navigate and detect prey. In some species, clicks are used for communication, especially in social species like orcas and dolphins, where they may serve to coordinate group behavior or signal social intentions. The sounds can include low-frequency sounds. The low-frequency sounds vary from low-frequency moans and grunts to more intense roars, which are thought to be used for communication over long distances. The sounds are often very deep and can travel hundreds of miles across the ocean. The sounds can include non-vocal sounds, such as tail slaps. Some whales, such as humpback whales, may use physical slaps of their tails (flukes) or pectoral fins to produce sounds that may be used for communication, signaling aggression, or coordinating with others in their group. In one or more embodiments, the sound patterns, and corresponding animal behaviors may be stored in a database or other suitable format to serve as training data for one or more machine learning systems to facilitate interspecies communication between humans and/or one or more non-human animal species.

The marine life wearable device 138 further includes a power source, such as a rechargeable or replaceable battery. In some embodiments, the marine life wearable device 138 may be a disposable device with a one-time use sealed battery, such as a lithium-ion battery. In one or more embodiments, the marine life wearable device 138 may be affixed via a strap to the tail fin, or other appendage of the whale. In embodiments, the strap can be comprised of a biodegradable material that dissolves or decomposes over time, enabling the marine life wearable device 138 to fall off the whale after a period of time, such that the device does not cause any permanent discomfort for the whale. In some embodiments, the marine life wearable device 138 may be affixed via a biodegradable adhesive. The biodegradable adhesive can include a starch-based adhesive, and can be formulated to wear off after a period of time, enabling the marine life wearable device 138 to fall off the whale, such that the device does not cause any permanent discomfort for the whale.

The environment 100 may further include an autonomous underwater vehicle 140. The autonomous underwater vehicle 140 can be an electromechanical device that includes an onboard computer for receiving commands and/or data from ship 120, buoys (122, 124), marine life wearable device 138, and/or seafloor detection devices (132, 134). Embodiments can include receiving additional human communication data, and outputting the additional human communication data to one or more electromechanical devices, such as autonomous underwater vehicle 140. Embodiments can include receiving additional human communication data, and outputting the additional human communication data to one or more electronic devices, such as a remote computing device located on ship 120.

The types of tasks performed by the multimodal orchestration for human-animal-robot collaborative task execution can include search and rescue, exploration, surveillance, and/or other suitable tasks. Environment 100 can include a shipwreck 145. As an example, to determine the precise location of the shipwreck, size of the debris field of the shipwreck, and/or other information, a collaborative task involving humans (e.g., on ship 120), robots (e.g., autonomous underwater vehicle 140), and non-human animals (e.g., whale 108, octopus 114, and/or dolphins 110, 112) can be executed by using AI-enabled interspecies communication techniques, along with Simultaneous Localization and Mapping (SLAM) techniques enabled by sensors, satellite receivers, radar, lidar, RF-based triangulation, and/or other suitable techniques, as will be further described in the description for the figures that follow.

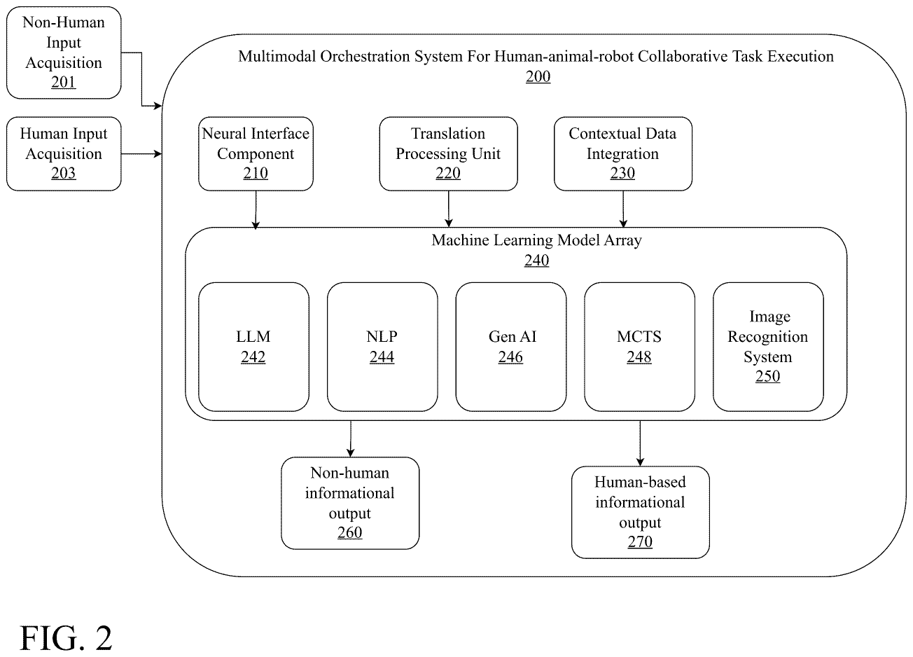

FIG. 2 is a block diagram illustrating components of a system for multimodal orchestration for human-animal-robot collaborative task execution, in accordance with one or more embodiments. System 200 can receive as input, non-human input acquisition 201, and human input acquisition 203. The non-human input acquisition 201 can include input from animals. The input can include audio input. The audio input can include vocalizations such as songs, clicks, chirps, groans, roars, and the like. The audio input can include phonemes and/or words, such as from certain species of birds that are capable of mimicking and producing phonemes from human languages. The audio input can include non-vocal sounds such as tapping or banging sounds from tapping limbs, appendages, or the like. The non-human input acquisition 201 can further include visual information such as sign language gestures, such as may be performed by various primates. The human input acquisition 203 can include spoken language, text input, sign language, and/or other suitable input. The non-human input acquisition 201 and human input acquisition 203 are input to the system for multimodal orchestration for human-animal-robot collaborative task execution 200, and the resulting output can include a non-human informational output 260, and a human-based informational output 270, thereby facilitating interspecies communication.

The system 200 can include a neural interface component 210. The neural interface component 210 can enable the detection of nuanced neural responses from animals that indicate social, emotional, and environmental interactions. The animals can include land animals, such as horses, cats, and dogs. The animals can include aquatic animals, such as whales, dolphins, fish, octopus, and squid. The animals can include birds and other flying animals. In embodiments, the neural interface component 210 may be coupled to the animals to obtain signals indicative of emotional states, and/or other communication patterns. The system 200 can include a translation processing unit 220. The translation processing unit 220 can utilize machine learning models which are trained to correlate neural patterns of animals to known behaviors, vocalizations, and intentions. The system 200 can include a contextual data integration module 230. The contextual integration module 230 can combine modalities (such as neural signals, vocalizations, gestural data, and/or scent vectors) in a multimodal fusion layer. A sliding time window provides temporal alignment, associating changes in scent concentration with concurrent neural or behavioral shifts. The outputs of the neural interface component 210, translation processing unit 220, and/or contextual data integration model 230 are input to machine learning model array 240.

Machine learning model array 240 may include one or more machine learning models, neural networks, and/or other systems for processing and interpreting input data. The machine learning model array 240 can include a large language model 242. The large language model (LLM) 242 can be trained for specific animals (e.g., species-specific or even individual-specific) and can ingest continuous streams of neural population data recorded across multiple tasks and states. These models go beyond simple language: they become multimodal encoders of animal neural signals, motor outputs, observed behaviors, and contextual cues. By structuring training data to include “high-incentive” versus “neutral” tasks, the LLM can learn when the animal's neural signature deviates from its optimal preparatory patterns. In embodiments, the machine-learning system includes a large language model (LLM).

The machine learning model array 240 can include a natural language processing (NLP) module 244. The NLP module 244 can enable the conversion of human speech to animal-understandable patterns. The NLP module 244 can include NLP pipelines that parse human language into semantic tokens. These tokens can then be mapped onto a species-specific “neural command embedding space.” For whales, this might involve converting a request such as ‘swim to the surface’ into a neural stimulation pattern, along with an auditory output pattern such as a song or pattern of clicks. For canines, this might involve converting a request like “Fetch the red ball” into a neural stimulation pattern plus a subtle auditory or tactile cue that aligns with the dog's pre-trained internal representations of the action “fetch” and the visual concept “red ball.”

The machine learning model array 240 can include a generative artificial intelligence (Gen AI) module 246. The Gen AI module 246 can enable supplementing training data with synthesized data, such as vocal data (e.g., canine vocalizations or whale codas), where the vocal data is created with properties such as number and regularity of signal units (clicks, barks), spectral means, and/or amplitude envelopes. The Gen AI module 246 can include a generative adversarial network (GAN), such as WaveGAN, InfoGAN, fiwGAN, and/or other suitable GAN.

The machine learning model array 240 can include a Monte Carlo Tree Search (MCTS) module 248. The MCTS module 248 can enable adaptive, look-ahead scheduling decisions. Instead of applying fixed heuristics or static load-balancing, disclosed embodiments can simulate and/or evaluate multiple future states of the pipeline before choosing the next action. By repeatedly exploring and exploiting different pipeline routing decisions (e.g., which specialist model to send partial outputs to, or how to scale certain pipeline segments), MCTS can minimize the cumulative regret over time, converging toward near-optimal scheduling policies that are robust to changing conditions, input distributions, and latency constraints. In one or more embodiments, the MCTS module 248 can enable enhanced resource allocation, such as allocating more GPUs, selecting specialized hardware accelerators, and/or adjusting batch sizes downstream.

The machine learning model array 240 can include an image recognition system 250. Image recognition system 250 may utilize machine learning to identify objects and gestures in images and video clips. The training can include obtaining a large dataset of labeled images or video clips that include the objects and/or gestures that are to be identified. Using techniques such as convolutional neural networks (CNNs), relevant features from the images are automatically extracted. A machine learning model (e.g., a deep learning model) is trained on the extracted features. Once trained, the model can be used to predict the presence of objects or gestures in new, unseen images and/or video clips. The images and/or video clips can include images of non-human animals exhibiting facial expressions, performing gestures, and/or other interpretable behaviors. Image recognition system 250 may further utilize Haar cascades for object detection. One or more embodiments can include training the Haar cascade classifier using a combination of positive samples and negative samples. The training process can include selecting the most relevant features and creating a cascade of classifiers.

The machine learning model array 240 can include, as an output, non-human informational output 260. The non-human informational output 260 can include audio output. The audio output can include species-specific audio waveforms such as clicks and songs for cetaceans, growling and/or barking sounds for canines, and so on. In an aquatic environment such as depicted in FIG. 1, the audio output may be provided by underwater speakers or other suitable transducers. The non-human informational output can include visual output, such as flashing lights, and/or patterns rendered and presented on an electronic display that is visible to the animals that are participating in the system and/or method for multimodal orchestration for human-animal-robot collaborative task execution.

The machine learning model array 240 can include, as an output, human-based informational output 270. The human-based informational output 270 can include visual information such as text and/or symbology. The human-based informational output 270 can include audio information. The audio information can include synthesized speech, tones, and/or other sounds to convey information identified by the machine learning model array 240. Referring again to the example depicted in FIG. 1, for investigation of the shipwreck 145, the non-human informational output 260 can include audio waveforms that may be interpreted by a whale 108 to swim to a location proximal to the shipwreck 145. The whale 108 may then output audio vocalizations in response to viewing the shipwreck. The output audio vocalizations can be translated by the system 200 to human-based informational output 270 for interpretations by humans. In this way, the non-human informational output 260 and the human informational output 270 can work in tandem to enable human-animal-robot collaborative task execution.

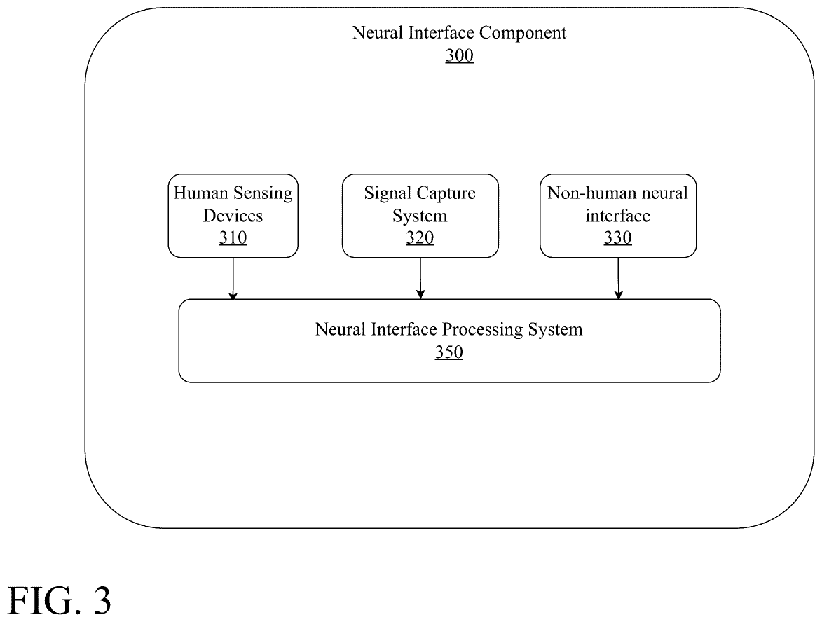

FIG. 3 is a block diagram illustrating details of a neural interface component, in accordance with one or more embodiments. Neural interface component 300 may be similar to neural interface component 210 of FIG. 2, and can include one or more human sensing devices 310. The human sensing devices 310 can include wearable sensors, such as pulse sensors, brainwave monitors, and the like. The human sensing devices 310 can further include cameras, microphones, and/or other sensors for obtaining cognitive state information from a human. The data received by the human sensing devices may be used with NLP module 244 to extract additional context and sentiment from humans participating in human-animal-robot collaborative task execution.

Neural interface component 300 can include a signal capture system 320. The signal capture system 320 can include one or more sensors for capture of neural and physiological signals without distress, adjusted for the physical characteristics of animals, such as cetaceans. In embodiments, neural sensors are embedded within wearable and/or attachable devices suited for underwater and open-ocean deployment. In embodiments, the neural interface includes components tailored to the species'specific anatomy, such as the head or dorsal regions in whales, and made from materials that ensure durability and comfort even in the deep-sea environment.

Neural interface component 300 can include a non-human neural interface 330. The non-human neural interface 330 can include non-invasive sensors that can detect and measure animal brain activity without causing discomfort. These sensors capture neural signals associated with emotions, intentions, and responses to stimuli. The non-human neural interface 330 can further include implanted sensors. Embodiments can include surgically implanting sensor probes inside an animal's brain. In embodiments, this technique can be used in place of a non-invasive sensor package, and can yield additional control and benefits that include the ability to record specific thoughts, evaluate mental state, and other aspects outside of the direct intent to communicate. This also enables capturing the animal's sensory data such as vision and scent. This allows human/animals to not only communicate freely, but opens additional options for working animals. For example, a dog must pass extensive training before it can sniff drugs. With disclosed embodiments, the training may be drastically shortened by reading the animal's brain patterns directly and identifying targeted substances via this data. As part of the training, the non-human informational output 260 (of FIG. 2) may produce a signal to cause happiness or the notion of correctness as a positive reward and drastically speed training times and animal willingness.

The output of the human sensing devices 310, signal capture system 320, and non-human neural interface 330 can be input to neural interface processing system 350. Neural interface processing system 350 can include an AI-based processing unit that analyzes and interprets vocalization data, behavioral cues, and environmental contexts to foster bidirectional communication between humans and non-human animals. Disclosed embodiments can be well-suited for applications ranging from enhancing human-animal interactions for conservation to advancing scientific understanding of animal languages, particularly in highly social and intelligent species such as sperm whales. Furthermore, disclosed embodiments can enable the use of environmental and behavioral metadata integration, as well as robust machine learning frameworks, allowing creation of an adaptable model for studying communication across various species, making disclosed embodiments adaptable to diverse animal communication needs beyond cetaceans, such as canines, primates, and other species.

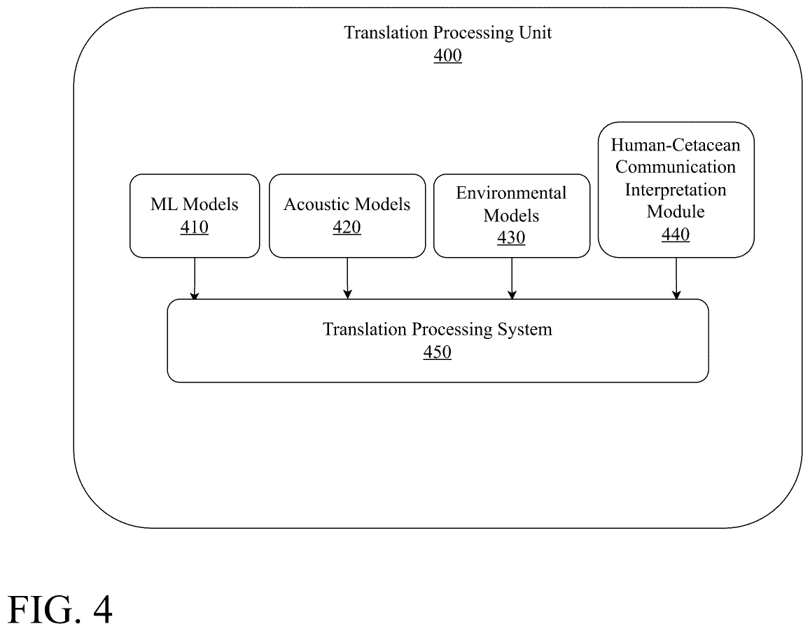

FIG. 4 is a block diagram illustrating details of a translation processing unit, in accordance with one or more embodiments. Translation processing unit 400 may be similar to translation processing unit 220 of FIG. 2, and can include one or more machine learning models 410. In embodiments, the machine learning models 410 can be trained to identify patterns in vocalization, such as codas, tempo, rhythm, ornamentation, and contextual variations like rubato. This training enables disclosed embodiments to decode structured and nuanced elements of cetacean communication, potentially revealing hierarchical or associative structures similar to human language. The translation processing unit 400 can include one or more acoustic models 420. The acoustic models 420 may enable replication of fricative production. This includes adjusting tongue position, airflow velocity, and constriction points. The translation processing unit 400 can further include one or more environmental models 430. The environmental models 430 can include probabilistic models to capture the uncertainty and variability inherent in fricative sound production and perception. The translation processing unit 400 can further include a human-cetacean communication interpretation module 440. In embodiments, the human-cetacean communication interpretation module 440 can enable mappings between humans and cetaceans. As an example, the clicks, songs, and codas of whales can be processed via machine learning, and mapped to human sentiments, such as danger, affection, joy, aggression, curiosity, and/or cooperation. In embodiments, the human sentiment can be derived from animal outputs, such as sounds made by animals, gestures made by animals, facial expressions made by animals, and so on. The danger may be represented by high-pitched whistles, rapid clicks, and/or abrupt calls. Affection may be represented by soft clicks, whistles, and/or low-pitched moans. Joy may be represented by rapid clicks, whistles, and/or varied, upbeat vocalizations. Aggression may be represented by loud, forceful vocalizations, grunts, or low-frequency rumbles. Curiosity may be represented by short bursts of clicks. Cooperation may be represented by repetitive clicking patterns. In general, cetacean sounds may be catalogued and correlated to a behavioral context.

The translation processing system 450 receives input from the ML models 410, acoustic models 420, environmental models 430, and human-cetacean communication interpretation module 440. The translation processing system 450 can be configured to convert animal neural patterns into human-comprehensible language, conveying the emotional state, intentions, and/or needs of the animal. The translation processing system 450 can further be configured to translate human speech into neural signals or cues that are meaningful and understandable to animals, allowing the animals to comprehend specific commands or sentiments directly. In embodiments, the translation processing system 450 may be configured to produce spoken translations of animal communications, thereby allowing humans to understand an animal's emotions or needs. For instance, the system might translate a dog's neural signals into phrases like “I am hungry” or “I'm feeling anxious.”

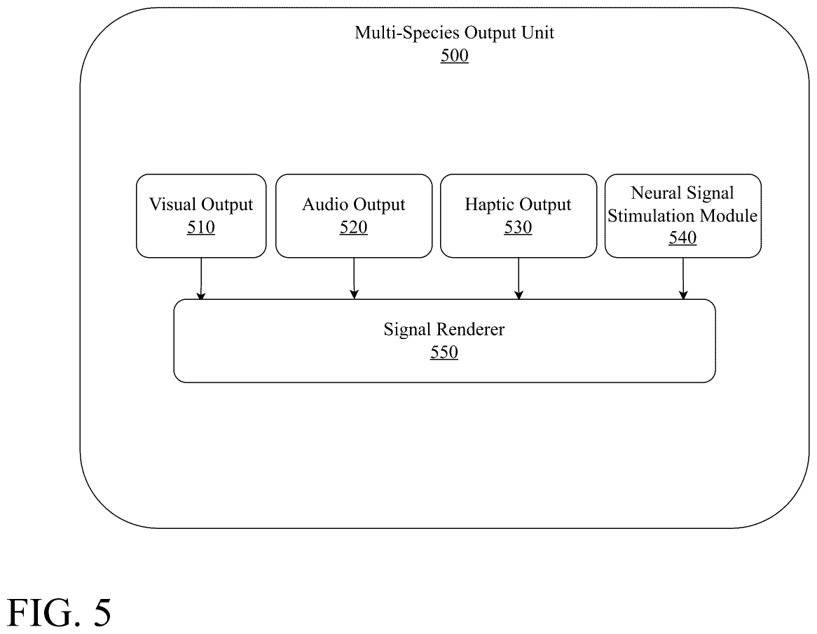

FIG. 5 is a block diagram illustrating details of a multi-species output unit 500, in accordance with one or more embodiments. The multi-species output unit is an innovative computerized system designed to facilitate communication between humans and animals by integrating multiple sensory modalities for output. The visual output subsystem 510 processes and assembles video and image data for output on an electronic display. The visual output is tailored to the perceptual capabilities of the target species, ensuring that animals or humans can interpret the visual signals effectively. The audio output subsystem 520 can be configured to generate audio waveforms that can be output through speakers or other audio devices. The audio output can include species-specific sounds, such as vocalizations, frequencies, or tones, enabling communication in a form recognizable by the intended animal. The haptic output subsystem 530 generates and modulates signals to drive vibratory devices, creating tactile sensations that can be detected via wearable sensors or directly on the animal's skin. The haptic feedback can convey information such as alerts, directions, or emotional cues. The neural signal stimulation module 540 can include electrodes capable of monitoring and interacting with brainwaves of an animal. It can record neural activity and deliver carefully modulated stimulation to influence or reinforce specific neural patterns. This capability offers potential for advanced applications, such as training, behavior modification, or facilitating direct neural communication. The signal renderer module 550 serves as the central decision-making unit, determining the most appropriate output device for each signal. It integrates the outputs from the visual, audio, haptic, and neural modules and ensures that the signals are delivered in a coherent and species-appropriate manner. In embodiments, the multi-species output unit 500 may be integrated into, or communicatively coupled with, non-human informational output 260 and/or human-based informational output 270.

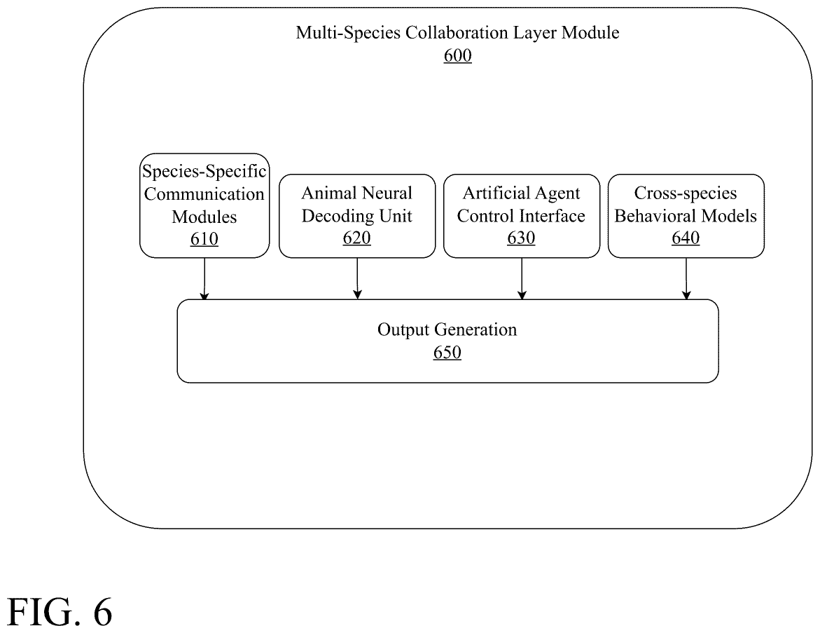

FIG. 6 is a block diagram illustrating details of a multi-species collaboration layer module 600, in accordance with one or more embodiments. The Multispecies Collaboration Layer (MCL) builds on the foundational capabilities of neural interfaces, multimodal sensory processing, and language modeling techniques, extending them to facilitate purposeful, synchronized interaction across species or between animals and machines. Its key functions are to understand interspecies “vocabularies,” align goals, and orchestrate collaborative tasks. The MCL module 600 can include one or more species-specific communication modules 610. In embodiments, each participating species (e.g., dogs, elephants) or artificial agent (e.g., a drone) has its own communication interface and representation layer.

The MCL module 600 can further include an animal neural decoding unit 620. The animal neural decoding unit 620 can be configured to extract interpretable “meaning vectors” from the animal's neural signals and observed behavior. As an example, for a dog, neural patterns plus posture/vocalization cues can produce a “conceptual state embedding” representing intentions and emotional states. The MCL module 600 can further include an artificial agent control interface 630. For a drone, sensor data (LIDAR, camera, GPS) and command frameworks are translated by the artificial agent control interface into abstract action representations (e.g., “search pattern initiated,” “altitude adjustment needed”). The MCL can further include one or more cross-species behavioral models 640. These models can utilize a library of known behavioral cues and tasks common to various species (e.g., “move towards scent,” “alert upon detection of target”) to produce standardized action and intention descriptors.

The MCL module 600 further includes an output generation module 650 that receives input from the species-specific communication modules 610, animal neural decoding unit 620, artificial agent control interface 630, and/or cross-species behavioral models 640. The output generation module 650 then generates an appropriate output signal, which can include a video signal, audio signal, haptic signal, and/or other bioelectrical signal for conveying sentiment and/or meaning among humans and non-human animals. The output generation module 650 can output data in a wide variety of digital and/or analog formats, including pulse code modulated (PCM) audio, raw video formats, compressed video formats, and/or other suitable formats.

In embodiments, the Multispecies Collaboration Layer can be configured to provide a unified, context-driven platform enabling animals of different species, as well as robots and/or drones, to collaborate effectively on shared tasks. By creating and refining interspecies dictionaries, using ML models to align intentions, and carefully timing and routing these concepts through a shared task representation space, the MCL module 600 can enable synchronized, purposeful action. This can profoundly enhance capabilities in wildlife conservation, service support, and environments where diverse species and agents work in concert to achieve common goals. In embodiments, the MCL module 600 can be integrated with, or communicatively coupled to, system 200 of FIG. 2.

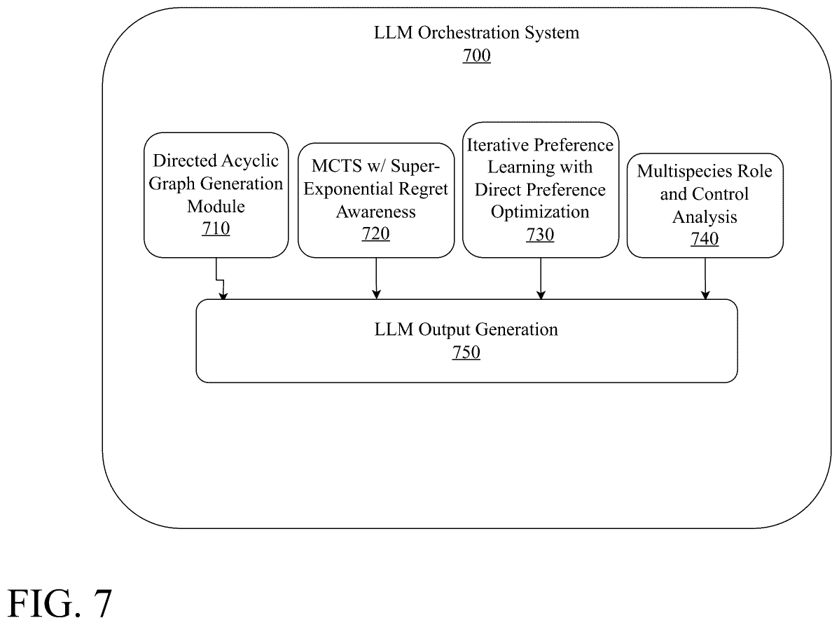

FIG. 7 is a block diagram illustrating details of a large language model (LLM) orchestration system 700, in accordance with one or more embodiments. In embodiments, LLM orchestration system 700 may be integrated with, or communicatively coupled to, LLM 242 of FIG. 2. LLM orchestration system 700 can include directed acyclic graph (DAG) generation module 710. The DAG generation module 710 can create a DAG representing complex workflows in which nodes are reasoning steps, and edges represent transitions from one partial solution to another. In some embodiments, each node encodes the current state of the environment, such as position and behavior of animals, humans'textual instructions, and/or robot sensor readings. The DAG's expansions can correspond to MCTS-like searches over possible reasoning paths, guided by previously described methods (e.g., embedding caches, semantic KGs, preference learning). Embodiments can include generating a directed acyclic graph to represent a plurality of reasoning steps corresponding to the multispecies coordinated task execution.

The LLM orchestration system 700 can include MCTS w/Super Exponential Regret Awareness module 720. In this context, “super-exponential regret” refers to the phenomenon where certain algorithms, specifically the Upper Confidence bounds applied to Trees (UCT) and its variants like AlphaGo's Monte Carlo Tree Search (MCTS), can experience regret that grows at a super-exponential rate under specific conditions. Regret, in this setting, measures the difference between the actual performance of the algorithm and the optimal performance it could have achieved. This module 720 may adjust model parameters to reduce or minimize regret, thereby improving performance. The adjustments made by module 720 can include modifying exploration-exploitation tradeoffs (e.g., fine-tuning of exploration constants in UCT).

The LLM orchestration system 700 can include iterative preference learning with direct preference optimization module 730. In embodiments, each node's expansions produce step-level preference data: which partial expansions yield better outcomes (improved translation quality, correct interpretation of animal signals). After collecting these preferences (through MCTS expansions and intermediate verification from debate steps), module 730 can apply Direct Preference Optimization (DPO) to refine the LLM's underlying policy. Over multiple cycles, on-policy sampled data enable the LLM's decision-making to improve at picking high-value expansions from the start. This reduces reliance on brute-force exploration and counters the conditions leading to super-exponential regret.

The LLM orchestration system 700 can include multispecies role and control analysis module 740. In embodiments, module 740 can model agents as having different influence roles, which can dynamically encourage certain agents to lead expansions in known-productive directions. Moreover, module 740 can be configured to let other agents anchor or block suspicious expansions (such as an octopus punching unhelpful fish), which are translated into immediate pruning of subgraphs in the reasoning DAG.

The LLM orchestration system 700 can include an LLM output generation module 750 which receives as input, outputs from the directed acyclic graph generation module 710, MCTS with Super Exponential Regret Awareness module 720, include iterative preference learning with direct preference optimization module 730, and/or multispecies role and control analysis module 740. The output from the LLM output generation module 750 can include information for human consumption, such as textual information, knowledge-based outputs, and/or structured data. The output from the LLM output generation module 750 can include information for robot consumption, such as commands, sensor data, and/or other command and control information. The output from the LLM output generation module 750 can include information for animal consumption, such as audio waveforms intended for interpretation by animals, such as tones and/or click patterns for cetaceans, tones and/or sounds for canines, and so on. Other signals for representation in visual and/or haptic domains may also be output by LLM output generation module 750 in some embodiments.

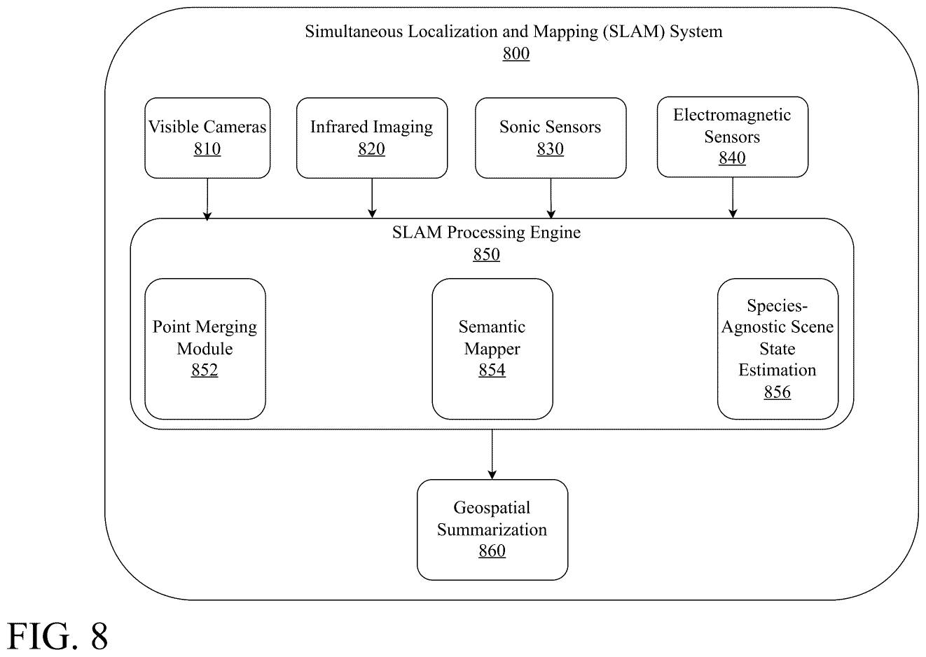

FIG. 8 is a block diagram illustrating details of a Simultaneous Localization and Mapping (SLAM) system 800, in accordance with one or more embodiments. In embodiments, SLAM system 800 may be integrated with, or communicatively coupled to, system for multimodal orchestration for human-animal-robot collaborative task execution 200 of FIG. 2. System 800 can include visible cameras 810, infrared imaging sensors 820, sonic sensors 830, and/or electromagnetic sensors 840. The visible cameras 810 may be configured to detect light in the visible spectrum (roughly 400-700 nanometers), which is the range of light perceptible to the human eye, and capture colors and details as humans see them, relying on external light sources (e.g., sunlight or artificial lighting) to illuminate a scene. The visible cameras can include wide-angle cameras, telephoto cameras, and so on. The infrared imaging sensors 820 can be configured to detect light in the infrared spectrum (beyond 700 nanometers), which is invisible to the human eye. In some embodiments, the infrared imaging sensors 820 can include thermal cameras that can capture emitted heat radiation from objects, even in complete darkness, without requiring external illumination. The sonic sensors 830 can include microphones and/or hydrophones. The microphones can include dynamic microphones, condenser microphones, electret microphones, and/or other suitable types of microphones. The hydrophones can include piezoelectric hydrophones that use piezoelectric materials to detect pressure changes in water caused by sound waves. The hydrophones can include vector sensors that measure both sound pressure and particle motion within water. The hydrophones can include a hydrophone array that includes multiple hydrophones arranged in a specific geometry to detect sound from multiple directions.

The electromagnetic sensors 840 can be configured to detect and measure electromagnetic fields or properties, such as electrical conductivity, magnetic fields, and electromagnetic radiation. The electromagnetic sensors 840 can include fluxgate magnetometers, suitable for detecting magnetic anomalies from seafloor rocks, or identifying metallic objects like shipwrecks or submarines. The electromagnetic sensors 840 can include proton precession magnetometers that can measure the magnetic field based on the precession of protons in water or a fluid. In one or more embodiments, the electromagnetic sensors can include optically pumped magnetometers, electric field detectors, capacitive sensors, electromagnetic induction sensors, and/or other suitable types of electromagnetic sensors.

The inputs from visible cameras 810, infrared imaging sensors 820, sonic sensors 830, and electromagnetic sensors 840 can be input to SLAM processing engine 850. SLAM processing engine 850 can include a point merging module 852. In embodiments, the point merging module 852 can include functions and instructions for combining multiple data points that correspond to the same real-world feature. This helps refine the map, reduce noise, and improve localization accuracy. SLAM processing engine 850 can include a semantic mapper 854. In embodiments, the semantic mapper 854 can include functions and instructions for enabling humans to interpret animal emotional states or intentions through augmented reality interfaces linked to embeddings and semantic mapping. The semantic mapper 854 may further include a Semantic Alignment Agent that can refine cross-domain mappings accordingly. Moreover, SLAM processing engine 850 can further include a species-agnostic scene state estimation module 856. In embodiments, the species-agnostic scene state estimation module 856 can include functions and instructions for utilizing data from visible light cameras to determine color and depth of a scene, enabling a 3D reconstruction of an environment. The species-agnostic scene state estimation module 856 can further include functions and instructions for utilizing data from ultraviolet (UV) and/or hyperspectral sensors, which can provide benefits as some animal signals might be visible only in UV or certain spectral bands, revealing hidden patterns (like UV-reflective markings on fish or subtle changes in an octopus's skin). The species-agnostic scene state estimation module 856 can further include functions and instructions for utilizing data from lidar scanners that produce high-resolution point clouds for both indoor and outdoor environments. In one or more embodiments, radar can complement lidar in poor visibility conditions. The species-agnostic scene state estimation module 856 can further include functions and instructions for utilizing data from sonic and/or acoustic sensors to capture vocalizations from a wide variety of animals. Embodiments can further utilize beamforming and/or signal processing in order to locate sound sources and/or identify distress calls, barks, or other meaningful vocal patterns in non-human animals.

The output of the SLAM processing engine 850 can include a geospatial summarization 860. The geospatial summarization 860 can include data that can be rendered and presented on an electronic display to show features such as a map panel that indicates animal locations, terrain features, and environmental conditions. One or more embodiments can further include icons representing animals that are updated in real-time, displaying status indicators such as color-coded stress levels, activity patterns, and the like. The data output of geospatial summarization 860 can include data in a variety of raster, vector, and/or other suitable formats.

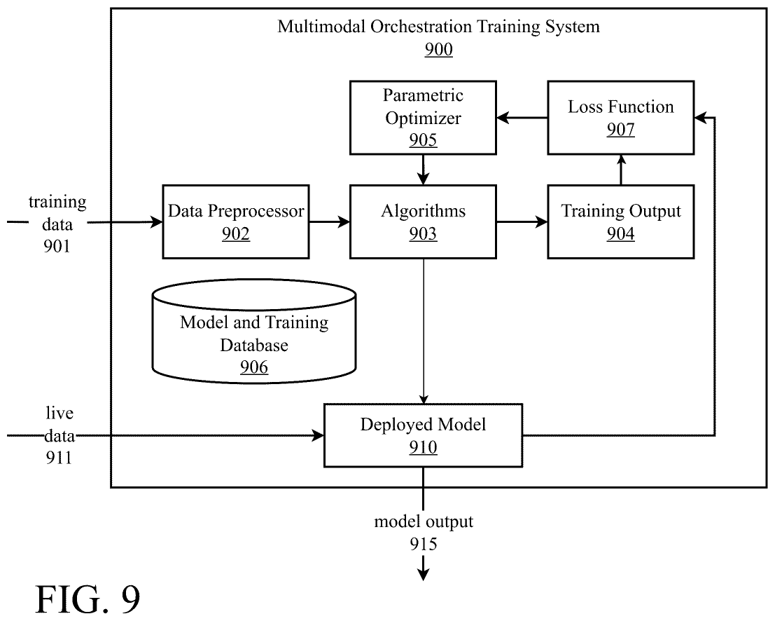

FIG. 9 is a block diagram illustrating an exemplary training system for tasks such as multimodal orchestration for human-animal-robot collaborative task execution and/or integrated multimodal sensor processing for cross-species state estimation, in accordance with one or more embodiments. In embodiments, system 900 may comprise a model training stage comprising a data preprocessor 902, one or more machine and/or deep learning algorithms 903, training output 904, a parametric optimizer 905, and a model deployment stage comprising a deployed and fully trained model 910 configured to perform tasks described herein such as enabling multimodal orchestration for human-animal-robot collaborative task execution. The system 900 may be used to train and deploy a plurality of AI subsystems in order to support the services provided by the system for multimodal orchestration for human-animal-robot collaborative task execution.

At the model training stage, a plurality of training data 901 may be received by the training system 900. Data preprocessor 902 may receive the input data (e.g., human feedback, human input data, animal input data, animal feedback, robot/sensor inputs, and the like) and perform various data preprocessing tasks on the input data to format the data for further processing. For example, data preprocessing can include, but is not limited to, tasks related to data cleansing, data deduplication, data normalization, data transformation, handling missing values, feature extraction and selection, mismatch handling, and/or the like. Data preprocessor 902 may also be configured to create a training dataset, a validation dataset, and/or a test set from the plurality of input data 901. For example, a training dataset may comprise 80% of the preprocessed input data, the validation set 10%, and the test dataset may comprise the remaining 10% of the data. The preprocessed training dataset may be fed as input into one or more machine and/or deep learning algorithms 903 to train a predictive model for tasks that can include interspecies communication, geospatial mapping, and/or object monitoring and detection.

During model training, training output 904 is produced and used to measure the accuracy and usefulness of the predictive outputs. During this process a parametric optimizer 905 may be used to perform algorithmic tuning between model training iterations. Model parameters and hyperparameters can include, but are not limited to, bias, train-test split ratio, learning rate in optimization algorithms (e.g., gradient descent), choice of optimization algorithm (e.g., gradient descent, stochastic gradient descent, of Adam optimizer, etc.), choice of activation function in a neural network layer (e.g., Sigmoid, ReLU, Tanh, etc.), the choice of cost or loss function the model will use, number of hidden layers in a neural network, number of activation unites in each layer, the drop-out rate in a neural network, number of iterations (epochs) in training the model, number of clusters in a clustering task, kernel or filter size in convolutional layers, pooling size, batch size, the coefficients (or weights) of linear or logistic regression models, cluster centroids, and/or the like. Parameters and hyperparameters may be tuned and then applied to the next round of model training. In this way, the training stage provides a machine learning training loop.

In some implementations, various accuracy metrics may be used by the training system 900 to evaluate a model's performance. Metrics can include, but are not limited to, word error rate (WER), word information loss, cetacean response times, predicted animal response compared with actual animal response, and normalization error rate, to name a few. In one embodiment, the system may utilize a loss function 907 to measure the system's performance. The loss function 907 compares the training outputs with an expected output and determines how the algorithm needs to be changed in order to improve the quality of the model output. During the training stage, all outputs may be passed through the loss function 907 on a continuous loop until the algorithms 903 are in a position where they can effectively be incorporated into a deployed model 915.

The test dataset can be used to test the accuracy of the model outputs. If the training model is establishing correlations that satisfy a certain criterion such as but not limited to quality of the correlations and amount of restored lost data, then it can be moved to the model deployment stage as a fully trained and deployed model 910 in a production environment making predictions based on live input data 911 (e.g., user preferences, user feedback, user inputs). Further, model correlations and restorations made by deployed model can be used as feedback and applied to model training in the training stage, wherein the model is continuously learning over time using both training data and live data and predictions. A model and training database 906 is present and configured to store training/test datasets and developed models. Database 906 may also store previous versions of models.

According to some embodiments, the one or more machine and/or deep learning models may comprise any suitable algorithm known to those with skill in the art including, but not limited to, LLMs, generative transformers, transformers, supervised learning algorithms such as: regression (e.g., linear, polynomial, logistic, etc.), decision tree, random forest, k-nearest neighbor, support vector machines, Naïve-Bayes algorithm; unsupervised learning algorithms such as clustering algorithms, hidden Markov models, singular value decomposition, and/or the like. Alternatively, or additionally, algorithms 903 may comprise a deep learning algorithm such as neural networks (e.g., recurrent, convolutional, long short-term memory networks, etc.).

In some implementations, the training system 900 automatically generates standardized model scorecards for each model produced to provide rapid insights into the model and training data, maintain model provenance, and track performance over time. These model scorecards provide insights into model framework(s) used, training data, training data specifications such as chip size, stride, data splits, baseline hyperparameters, and other factors. Model scorecards may be stored in database(s) 906.

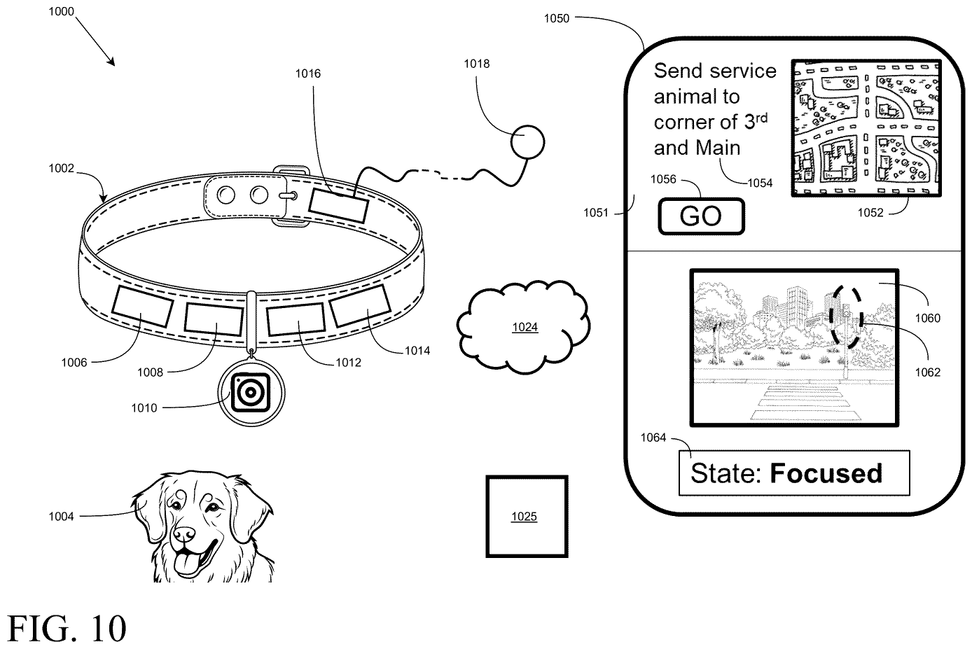

FIG. 10 shows an exemplary environment in which a system for integrated multimodal sensor processing for cross-species state estimation can be used, in accordance with one or more embodiments. The environment 1000 includes an animal-wearable multimodal sensory processing device 1002. In embodiments, the animal-wearable multimodal sensory processing device can have a wide variety of form factors to accommodate different types and sizes of animals. As depicted in FIG. 10, the animal-wearable multimodal sensory processing device 1002 has the form factor of a dog collar, suitable to be worn by a dog such as dog 1004. In one or more embodiments, the dog 1004 can include a Labrador retriever, golden retriever, German shepherd, beagle, border collie, cocker spaniel, bloodhound, and/or other suitable breed. In practice, the breed of dog 1004 may be selected as one well-suited for a given task, such as scent detection, tracking, hunting, herding, search-and-rescue, and/or therapy.

In embodiments, the animal-wearable sensory processing device 1002 further includes one or more actioning transducers. In embodiments, the one or more actioning transducers include a haptic transducer. The animal-wearable multimodal sensory processing device 1002 can include a haptic module 1006. The haptic module 1006 can include a haptic transducer such as a vibration device and/or other suitable device for applying subtle haptic cues that can be felt by the dog 1004 when the dog is wearing the animal-wearable multimodal sensory processing device 1002. In embodiments, the one or more actioning transducers include an acoustic transducer. The animal-wearable multimodal sensory processing device 1002 can include an acoustic module 1008. The acoustic module 1008 can include an acoustic transducer such as a speaker or buzzer that can produce sounds that can be heard by the dog 1004 when the dog is wearing the animal-wearable multimodal sensory processing device 1002.

In embodiments, the multiple sensors of the animal-wearable sensory processing device include a camera. The animal-wearable multimodal sensory processing device 1002 can include a camera 1010. The camera 1010 can include a camera such as a webcam that is capable of wirelessly streaming video and/or audio to a remote computing device such as computing device 1050 shown in FIG. 10. In one or more embodiments, the camera 1010 can be a multispectral camera. A multispectral camera is an imaging device capable of capturing light across multiple specific wavelengths beyond the visible spectrum, including near-infrared (NIR), short-wave infrared (SWIR), ultraviolet (UV), and/or other bands. Unlike conventional cameras that only record red, green, and blue (RGB) light, multispectral cameras can be used to break the scene into distinct spectral bands, each revealing unique information about the environment or target that would otherwise be invisible to the human eye. One or more embodiments can analyze how objects reflect or absorb light across different wavelengths in order to identify subtle differences in materials, temperatures, and/or biological markers.

For surveillance and monitoring applications, disclosed embodiments can utilize multispectral cameras to enhance visibility in challenging conditions such as low light, fog, or smoke, where traditional cameras may fail. Infrared bands, for instance, can distinguish heat signatures, making it easier to detect people or animals in darkness or through vegetation. Disclosed embodiments can also use multispectral imaging to identify camouflage or objects deliberately designed to blend into the background, which is an important benefit for applications such as security and border control. In industrial monitoring applications, the use of multispectral imaging in disclosed embodiments can help track chemical leaks, and/or environmental changes by highlighting variations in surface composition or temperature. Additionally, in one or more embodiments, the data collected can be processed using AI algorithms to improve detection accuracy, reduce false alarms, and even recognize patterns associated with abnormal behavior or potential threats.

The animal-wearable multimodal sensory processing device 1002 can include a scent processing module 1012. The scent processing module 1012 can include one or more scent dispensers that can be configured to dispense one or more scents that can be detected by dog 1004 when wearing the animal-wearable multimodal sensory processing device 1002. The scents can be used for eliciting a response based on training. The scents can include food scents, chemical scents, pheromone scents, and so on. In embodiments, the multiple sensors of the animal-wearable sensory processing device include a scent detection sensor. The scent processing module 1012 can further include one or more scent detection devices (sensors). The scent detection device(s) can be used to validate scents identified by the dog and/or collect additional data. In one or more embodiments, the scent detection devices can include miniaturized gas chromatography (GC) devices, ion mobility spectrometers (IMS), and/or photoionization detectors (PID). These devices can offer powerful, complementary ways to analyze airborne compounds. A miniaturized GC can separate complex mixtures of gases into individual components, identifying substances based on their unique retention times. This technique can be used for detecting explosives, narcotics, and/or environmental toxins. IMS can be used to measure how ionized molecules move through an electric field, also enabling rapid detection of chemicals such as drugs, explosives, and certain biological agents. PIDs are well-suited for detecting volatile organic compounds (VOCs), using ultraviolet light to ionize gases and measure their concentrations in real time. Each of these technologies brings strengths in sensitivity, speed, and portability, making them well-suited for use in disclosed embodiments.

Disclosed embodiments integrate one or more of these scent detection devices into animal-wearable multimodal sensory processing device 1002 in order to enable a hybrid detection system that combines the unmatched sensitivity and discrimination abilities of a dog's nose with the precision and objectivity of advanced sensors. Dogs are remarkable at detecting trace odors, even in complex environments, but their signals, such as sitting, pointing, or pawing, still rely on human interpretation. With the onboard chemical analysis of disclosed embodiments, the animal-wearable multimodal sensory processing device 1002 can be used to cross-check the dog's alert against the device's data to verify whether the detected scent matches the target substance or something similar. This approach can reduce false positives, build a more reliable confirmation process, and also help in training by providing real-time feedback. For example, in search-and-rescue scenarios, disclosed embodiments may be used to differentiate between human scents and animal remains, guiding responders more accurately. Similarly, in security applications, disclosed embodiments may be used to distinguish explosive precursors from benign odors that might otherwise confuse handlers. By merging the instinctive capabilities of dogs with analytical precision, disclosed embodiments can enhance operational effectiveness, speed up decision-making, and boost confidence in the results, especially in high-stakes environments.

The animal-wearable multimodal sensory processing device 1002 can include a main processing module 1014. The main processing module 1014 can include a processor, memory, power source, input/output (I/O), positional tracker(s) (e.g. GPS, cellular triangulation), one or more wireless transceivers, and/or other peripherals. The processing module 1014 may coordinate the operations of the animal-wearable multimodal sensory processing device 1002 by responding to received commands and/or received multimodal sensory processing data, and generate output such as from the haptic module 1006 and/or acoustic module 1008 in order to elicit a response from the dog 1004 based on previous training. The animal-wearable multimodal sensory processing device 1002 can include a brainwave acquisition module 1016. The brainwave acquisition module 1016 may include filters, amplifiers, analog-to-digital converters (ADCs), and/or other components, in order to process brainwaves from a non-invasive brainwave sensor 1018. In embodiments, the non-invasive brainwave sensor 1018 may be affixed to the head of the dog 1004 via a mild adhesive to enable non-invasive acquisition of brainwave data.

Data may be sent to, and/or received from, other computing devices via network 1024. In embodiments, network 1024 can include a cellular network, WiFi network, local area network (LAN), wide area network (WAN), satellite communication network, and/or the Internet. The other computing devices can include client device 1050. In embodiments, client device 1050 can include a smartphone, tablet computer, wearable computer, laptop computer, and/or other suitable computing device. Client device 1050 can include a display 1051 on which a user interface can be rendered and presented. In embodiments, the display 1051 can be a touchscreen to enable interaction with the user interface. As depicted in the example shown in FIG. 10, an instructional prompt 1054 is shown that may be received by client device 1050, such as via text-messaging. The display 1051 can also render a map view 1052 corresponding to the location of a dog wearing the animal-wearable multimodal sensory processing device 1002. The display 1051 can further include a street view 1060, which may be obtained via camera 1010. Thus, the street view 1060 can include a view that resembles the view as seen by the dog 1004 when wearing the animal-wearable multimodal sensory processing device 1002. In embodiments, video from the camera 1010 may be livestreamed to provide a real-time street view to enable a handler or trainer to see a view similar to what the dog 1004 sees. In one or more embodiments, the user of the client device 1050 can select an object in the street view 1060, such as traffic signal 1062. The object can be identified using computerized image recognition techniques. A SLAM system, such as that depicted in FIG. 8, can identify geospatial coordinates associated with the selected object. The user can invoke button 1056 which causes the client device 1050 to send one or more command via network 1024 to the animal-wearable multimodal sensory processing device 1002. In response, the animal-wearable multimodal sensory processing device 1002 can issue haptic, audio, and/or olfactory cues and/or hints to encourage the dog 1004 to move towards the selected object, which in the example of FIG. 10, is the traffic signal 1062. Embodiments can include sending a sensory cue to the animal-wearable sensory processing device based on the identified cross-species state estimation. In embodiments, the sending of the sensory cue to the animal-wearable sensory processing device is based on location information. Accordingly, disclosed embodiments can enable the feature of remotely monitored service dogs for visually impaired people. A remote handler can operate a client device such as device 1050 from anywhere in the world and monitor the location and environment reported by the animal-wearable multimodal sensory processing device 1002, and thus, can receive feedback from, and provide feedback to, the dog 1004. One or more embodiments can include a Simultaneous Localization and Mapping (SLAM) system, and the plurality of programming instructions further includes instructions to process directional-based information that is obtained from the SLAM system. Embodiments can include: identifying an intended destination for the animal; identifying a current location for the animal; and activating one or more actioning transducers on the animal-wearable sensory processing device with an output pattern to elicit an animal response to move towards the intended destination.

The client device 1050 may also indicate a cognitive state for the dog 1004, indicated at 1064. In embodiments, the cognitive state may be determined based on integrated multimodal sensor processing for cross-species state estimation. The environment 1000 can further include a remote computing device 1025. In embodiments, remote computing device 1025 can include a cloud-based server, virtual machine, bare-metal server, and/or other suitable device type. The remote computing device 1025 can implement one or more functions of the system for integrated multimodal sensory processing, and/or offload processing of data acquired by animal-wearable multimodal sensory processing device 1002, to reduce the memory and processing power required by client device 1050. In embodiments, remote computing device 1025 serves as a system for integrated multimodal sensor processing for cross-species state estimation, and can establish a communication session with an animal-wearable sensory processing device 1002. In embodiments, the communication session can include a TCP session, UDP session, and/or other suitable type of communication session.

In embodiments, the animal-wearable multimodal sensory processing device 1002 can be implemented as a smart collar for a dog that is equipped with a forward-looking camera, sensors, GPS, speakers, haptic transducers, and/or LTE/5G communication capabilities. These embodiments can offer transformative potential for service dogs, particularly those assisting visually impaired individuals. One of the most powerful use cases involves remote guidance, where a handler, potentially located miles away, can observe a live video feed from the dog's perspective via a tablet or similar device. This allows the handler to see exactly what the dog sees, making real-time decisions to support the visually impaired person. By selecting an object in the scene, such as the traffic signal 1062, embodiments can determine the object's coordinates using a lookup database or other geolocation methods. Coupled with a GPS data from the collar, the dog's precise position can be tracked, enabling the handler to issue location-specific commands.

When a command is given, such as directing the dog to move towards the selected traffic signal, the collar can engage its built-in audio cues, haptic vibrations, and/or scent dispensers to gently guide the dog toward the destination. For example, a vibration on the left side of the collar could prompt the dog to turn left, while a particular sound might encourage forward movement. This multi-sensory approach ensures the dog receives clear, non-verbal guidance without confusing the visually impaired handler or relying on physical leash corrections. One or more embodiments may further be configured to adapt to environmental changes, providing features such as rerouting the dog around obstacles. Additionally, the LTE/5G connectivity allows for real-time coordination between the dog, the handler, and potentially emergency services if needed. These features provided by disclosed embodiments not only enhance the safety and independence of visually impaired users but also extend the working range and versatility of service dogs, enabling them to navigate unfamiliar environments with confidence, even when their human partner cannot directly interpret the surroundings. In embodiments, the animal-wearable sensory processing device comprises an animal collar.

In one implementation, the animal-wearable multimodal sensory processing device 1002 incorporates the dual-embedding architecture directly into its main processing module 1014. The device's firmware partitions incoming sensory data and operational commands into separate processing streams, with brainwave data, biometric measurements, and environmental readings routed through the data pathway, while calibration parameters and control commands flow through the instruction pathway.

The main processing module 1014 implements a compact version of the dual-embedding architecture optimized for edge deployment, with reduced dimensionality and quantized weights to minimize power consumption while maintaining separation integrity. The remote computing device 1025 implements the full-scale architecture, enabling more sophisticated analysis while maintaining consistent role separation between the edge and cloud components of the system.

In another embodiment, inspired by recent advancements in convolutional multi-hybrid architectures, the disclosed system incorporates a highly specialized multimodal convolutional neural network module adapted for robust cross-species signature extraction and recognition. Specifically, this embodiment employs a multi-hybrid convolutional architecture that integrates multiple convolutional operator types—short explicit, medium-length regularized, and long implicit convolutions—into a unified computational framework, enabling differentiated and hierarchical processing of multimodal physiological and behavioral sensor data. For instance, short explicit convolutional filters efficiently detect localized rapid fluctuations such as abrupt EEG beta-wave power increases or transient accelerometer peaks indicative of immediate stress or alertness responses. Medium-length regularized convolutions simultaneously process longer temporal windows of data, capturing sustained changes in thermal signatures, heart rate variability patterns, or hormone-level fluctuations, which evolve over tens to hundreds of seconds. Finally, long implicit convolutions aggregate comprehensive contextual information across extended periods, ensuring a robust, species-invariant representation of higher-order behavioral states such as prolonged vigilance, anxiety, or fatigue.

Crucially, this multi-hybrid convolutional architecture is configured to be adaptive, dynamically adjusting filter parameters and convolutional operations based on real-time input data characteristics and computational efficiency constraints, as demonstrated by recent state-of-the-art methods utilizing input-dependent convolutions and hardware-aware algorithm design. Moreover, the system synergistically integrates these convolutional multi-hybrid representations with attention-based and semantic sensor-fusion modules, facilitating multimodal data blending between animals, humans, and robotic teammates. The combined architecture thus delivers a highly precise and scalable mechanism for real-time, species-agnostic state estimation, significantly outperforming traditional single-modality or static convolution-based systems. Through its innovative utilization of multiple complementary convolutional operators, adaptive filter optimization, and integrative multimodal fusion, this embodiment not only enables superior accuracy in recognizing analogous behavioral and physiological states across diverse species but also sets forth a novel and distinctive capability for real-time, cooperative interaction and task execution among humans, animals, and robotic systems in complex, dynamic operational environments.

In one aspect of this embodiment, the disclosed system leverages a multi-hybrid convolutional neural network (CNN) architecture specifically crafted for detecting, extracting, and recognizing cross-species physiological and behavioral signatures in real time. This specialized architecture orchestrates three distinct classes of convolutional operators—short explicit, medium-length regularized, and long implicit convolutions—into a tiered pipeline that processes high-throughput streams of multimodal data. In a representative configuration, the short explicit convolutions (e.g., 1D or 2D filters with limited receptive fields and minimal temporal depth) focus on capturing rapidly fluctuating features such as transient EEG beta-wave spikes, abrupt accelerometer deviations, or brief bursts in acoustic signals. By applying localized filter kernels, these short convolutional layers isolate micro-events within the data stream, providing near-instantaneous alerts corresponding to acute stress or sudden alertness changes. For example, as soon as a dog's EEG shows a beta-wave amplitude surge alongside momentarily spiking accelerometer readings, the short convolutional filters trigger preliminary classification cues that may indicate a heightened state of vigilance.

In another aspect, medium-length regularized convolutional operators (often employing filter sizes that span tens of samples in the temporal domain) concurrently analyze sustained physiological fluctuations and slower behavioral shifts. This approach proves indispensable for extracting meaningful variations in heart rate variability (HRV), prolonged temperature gradients visible in the thermal imaging data, and evolving hormone-level changes captured by the biochemical sensors (e.g., cortisol or adrenaline). By integrating specialized regularization strategies—such as dropout, batch normalization, or penalized kernel norms—these medium-length convolutions remain robust against sensor noise or environmental artifacts while preserving the signal fidelity required for mid-range temporal analysis. Thus, when an animal demonstrates a gradually increasing HRV signature over several tens of seconds or a slow thermal shift indicative of mounting stress, the medium-length filters can cohesively detect and encode these continuous evolutions.

Concurrently, the long implicit convolutional operators incorporate extended receptive fields that span hundreds to thousands of samples, allowing the system to integrate context over substantial time windows (e.g., minutes to hours). This upper tier of the pipeline focuses on extracting higher-order constructs—such as persistent fatigue, chronic anxiety, or extended periods of vigilance—by aggregating historical sensor data into a contextually relevant latent representation. For instance, a horse participating in a lengthy search-and-rescue operation may experience a gradual but consistent elevation in stress hormones combined with incremental EEG drift into a lower alpha-band ratio over extended intervals. The long implicit convolutions capture these slow-evolving changes and consolidate them into a “state trajectory,” effectively yielding a robust, species-invariant depiction of ongoing physiological and psychological status.

Crucially, this multi-hybrid convolutional architecture is configured to operate adaptively, leveraging input-dependent filter optimization techniques and real-time hardware-aware algorithm design. For example, if computational constraints escalate—such as those associated with limited bandwidth in an active disaster zone or battery restrictions on wearable devices—the system can strategically reduce the number of active long implicit filters or shorten their temporal windows in response. Conversely, when ample computational resources are available, the system may automatically expand its set of short explicit and medium-length filters, thereby enhancing resolution in capturing rapid micro-events alongside mid-duration phenomena. Additionally, state-of-the-art attention-based modules are interwoven with the convolutional layers to automatically emphasize salient features—such as abrupt EEG transitions or distinctive spatiotemporal thermal patterns—while de-emphasizing background noise or redundant signals. By implementing advanced sensor-fusion techniques, data originating from multiple species (e.g., a dog, a horse, or other working animals) and robotic counterparts (e.g., LiDAR scans or infrared footage) are jointly processed via cross-attention mechanisms, resulting in contextually enriched embeddings that transcend what any single modality or species-specific algorithm could achieve in isolation.

Moreover, the system further refines these multi-hybrid representations through dynamic meta-learning algorithms that periodically re-tune the convolutional kernels and their hierarchical connections based on evolving data distributions. In particular, when encountering a new species or a novel behavioral context (e.g., introducing a search-and-rescue canine to a marine mammal environment for aquatic operations), the architecture can incorporate incremental updates that pivot the existing filters towards capturing the newly observed physiological or environmental signatures. This not only preserves the robust knowledge gained from prior data but also ensures rapid adaptability in uncharted applications. The synergy between such meta-learning strategies and attention-driven sensor fusion provides an unparalleled capacity for modeling interspecies homologies, permitting the system to extrapolate learned features—like stress or alertness cues—from one species to another with minimal recalibration.

Furthermore, the cooperative operational layer capitalizes on these refined multi-hybrid CNN outputs for real-time decision support, coordinating tasks among human handlers, animals, and robotic units. By dynamically categorizing states and generating precise alerts regarding an animal's level of stress, fatigue, or vigilance, the system can distribute specialized guidance instructions (e.g., via the haptic feedback module), reposition robotic agents (such as drones or ground-based vehicles), and inform human operators through augmented-reality interfaces. Notably, the long implicit layers'capacity to monitor cumulative changes over extended intervals ensures that mission-critical decisions—for example, whether to allow an animal to continue in a search zone or to rotate it out for rest—are informed by comprehensive, context-sensitive data. Hence, the synergy of short, medium, and long convolutional filters yields a holistic state representation bridging instantaneous events, mid-range trends, and protracted behavioral shifts.

This novel multi-hybrid convolutional architecture, with its adaptive filter optimization, hierarchical convolutional strategies, and integrated attention-based fusion, exceeds the capabilities of conventional single-modality or static CNN systems by providing a real-time, species-agnostic analysis pipeline. By enabling the recognition and projection of complex physiological and behavioral states across diverse species boundaries, it facilitates an entirely new paradigm of interspecies collaboration, including high-precision, multi-agent coordination in fluid and unpredictable contexts. Thus, this embodiment definitively pushes the boundaries of the state-of-the-art, introducing a fundamentally distinct technological capability to perceive, interpret, and utilize multispecies sensor data for cohesive teamwork and operational success in search-and-rescue, disaster relief, security, agricultural monitoring, and a range of other mission-critical domains.

In another novel embodiment, inspired by advanced concepts in neuro-symbolic architectures and robot constitution-based semantic safety frameworks, the disclosed system integrates a sophisticated hybrid neuro-symbolic framework enabling dynamic, adaptive robot and animal collaboration through cognitive models that mimic human dual-process thinking. Specifically, the system comprises two parallel processing modules: a neural reasoner configured to rapidly analyze and adapt to immediate, sensory-rich contextual tasks, and a symbolic reasoner designed for deliberate, explicit, and interpretive reasoning, capable of logical inference across complex, compositional multi-agent task scenarios. The neural reasoner employs convolutional neural networks (CNNs) and multilayer perceptrons (MLPs) to instantaneously interpret sensor-derived multimodal physiological, behavioral, thermal, biochemical, and environmental data streams for real-time responses, optimized for rapid execution and intuitive decision-making akin to human fast-thinking processes. Concurrently, the symbolic reasoner implements structured logic and probabilistic graph-based reasoning models, which decompose situational inputs into clearly defined subconcepts—such as specific animal behaviors, stress signatures, and inter-agent spatial relationships—facilitating interpretable, step-by-step analysis and contextually adaptive decision-making.

In this embodiment, each collaborative scenario—such as a disaster-response mission involving human rescuers, sensor-equipped dogs, autonomous ground robots, and aerial drones—is represented as compositional knowledge graphs encoding abstracted state information, multimodal sensory attributes, and semantic safety constraints, derived from established robot constitutions dynamically generated through Constitutional AI methodologies. For example, the symbolic reasoner references constitutionally encoded safety rules, automatically generated and continuously refined through data-driven semantic benchmarks, to interpret scenarios involving potential risks, such as a dog indicating a hazardous environment detected via biochemical and thermal stress signatures. Through the continuous interaction of both reasoning modalities, the system can quickly execute intuitive tactical adjustments based on neural interpretation (e.g., guiding the dog via subtle adaptive haptic cues) while simultaneously maintaining higher-level strategic oversight, logical safety verification, and coordination across species through symbolic reasoning.

Moreover, the hybrid neuro-symbolic architecture uniquely facilitates lifelong adaptive learning and continuous refinement of both neural and symbolic subsystems through an automated knowledge integration mechanism. This mechanism leverages real-time performance data, such as animals'physiological responses and environmental changes, to iteratively update the neural models with task-specific knowledge and progressively refine the symbolic reasoner's abstracted rules and constitutionally defined ethical constraints. As a result, the system evolves toward increasingly nuanced, personalized, and robust interspecies state estimation and interaction frameworks, significantly reducing the risks of semantic misunderstandings, unintended behaviors, or unsafe interactions. This embodiment thus sets forth an unprecedented technical innovation, effectively combining cutting-edge neuro-symbolic reasoning architectures, semantic safety benchmarks, robot constitutions, and lifelong adaptive learning to achieve novel levels of robustness, transparency, and functional capability in collaborative multi-agent robotic-animal-human operational environments.

In one aspect of this embodiment, the disclosed system's hybrid neuro-symbolic framework is underpinned by a dual-process cognitive model, mirroring the interplay between rapid, intuitive “System 1” thinking and deliberate, analytical “System 2” thinking in human cognition. The neural reasoner—analogous to System 1—encompasses a suite of deep learning modules, such as convolutional neural networks (CNNs), transformers, or multilayer perceptrons (MLPs), trained to rapidly process high-frequency sensor data. These data streams include, but are not limited to, EEG-derived neural activity, animal biochemical markers (e.g., cortisol measurements), inertial measurements (e.g., abrupt acceleration or rotation), robotic LiDAR scans, and thermal or optical images. This neural reasoner is configured to produce instantaneous classification outputs or continuous probability estimates that inform time-critical interventions—such as adjusting a dog's haptic feedback pattern or repositioning a drone for improved visual coverage—thereby enabling swift, reflexive decision-making under dynamic operational conditions.

By contrast, the symbolic reasoner—mirroring System 2—implements a suite of structured logic-based engines and probabilistic graphical models capable of performing compositional, step-by-step reasoning over abstracted representations of the mission environment. In practice, these representations take the form of compositional knowledge graphs constructed from domain-specific ontologies, robotic constitution rules, semantic safety constraints, and high-level policy guidelines. Nodes within the knowledge graph may represent individual agents (e.g., rescue dogs, robots, human operators), environmental features (e.g., architectural elements, debris fields, temperature hotspots), and recognized events or behaviors (e.g., “dog indicates stress,” “human requests medical kit,” or “sensor anomaly at coordinates X, Y”). Edges capture relational dynamics, such as proximity, causal links, or hierarchical task decompositions. By referencing a constitutionally enforced set of safety rules—generated through Constitutional AI methods and refined via data-driven semantic benchmarks—the symbolic reasoner ensures that candidate actions (e.g., dispatching a robot into a partially collapsed building) are explicitly evaluated against constraints such as hazard thresholds, ethical policies, and operational protocols.

To facilitate seamless integration and real-time performance, a bidirectional interface links the neural and symbolic reasoning modules, managed by an orchestration layer that continuously reconciles the outputs of each module. On one side, the neural reasoner's rapid classifications (e.g., “alert state in canine,” “unstable ground detected by drone LiDAR”) are fed into the symbolic knowledge graph as labeled events or conditions. On the other side, the symbolic reasoner's interpretive inferences (e.g., “structural collapse risk above threshold—deploy alternative route,” “safety constraint triggered—revise search parameters”) are propagated back to the neural reasoner as contextual signals or gating variables. This interplay fosters a multi-tiered decision-making pipeline wherein the neural reasoner handles instantaneous, data-driven predictions while the symbolic subsystem applies extended logic to refine or override those predictions when higher-level safety, ethical, or strategic considerations come into play. The result is a dynamic, situationally aware system that avoids the blind spots of purely neural or purely symbolic approaches, thus reducing susceptibility to overfitting, sensor noise, or high-level logical oversights.

In another aspect, the system's knowledge integration mechanism implements lifelong adaptive learning, wherein real-time operational data is routinely logged and evaluated to update both neural and symbolic components. For the neural reasoner, incremental learning or meta-learning algorithms (e.g., few-shot learning, continual learning strategies) enable rapid assimilation of novel data—such as the physiological idiosyncrasies of a newly introduced horse or the sensory peculiarities of a specialized search-and-rescue drone—without catastrophic forgetting of previously acquired expertise. Parallel to this, the symbolic reasoner's rule sets and logical models are expanded or refined through algorithmic processes that compare observed outcomes against constitutionally encoded safety or ethical frameworks. For example, if a dog repeatedly flags a hazard during inclement weather, and subsequent investigation confirms the presence of unstable terrain, the symbolic reasoner updates the knowledge graph to represent this new contextual rule (“unstable terrain risk heightened with increased precipitation”), thus making future hazard-detection logic more robust and context-sensitive. Over multiple mission cycles, this iterative process accrues in a distributed knowledge base, enabling faster adaptation to diverse operational theaters, from urban disaster zones to wilderness search-and-rescue conditions.

Moreover, the neuro-symbolic system serves as a foundation for advanced semantic safety. The constitutions, generated through Constitutional AI methodologies, encode context-sensitive ethical considerations, mission constraints, and agent role definitions that govern permissible behaviors across all entities—human, animal, or robot. Whenever the neural reasoner identifies an emergent risk—e.g., a dog's sudden stress response correlated with high dust particulate readings—the symbolic reasoner consults constitutionally encoded rules to evaluate whether to escalate the alert, modify task assignments, or initiate a controlled withdrawal from the hazard zone. Critically, this approach prevents mission creep into unsafe territory by requiring explicit logical validation for major strategic decisions, thus combining the speed of neural-based reflexes with the rigor of symbolic verification. In practice, this synergy is especially beneficial in complex, large-scale missions, where multiple animals and robots operate in parallel under varying environmental conditions, as it systematically enforces consistent, interpretable, and ethically sound procedures.

Finally, this hybrid neuro-symbolic framework unlocks a new paradigm of collaborative intelligence that extends beyond traditional single-agent or single-species solutions. Because it encodes domain knowledge as compositional graphs and likewise processes sensor data using state-of-the-art neural algorithms, the system is highly extensible to additional species (e.g., detection rats for landmine identification), new sensing modalities (e.g., advanced chemical detection for toxic gases), and specialized robotic platforms (e.g., amphibious vehicles for flood rescue). Real-time synergy across these heterogeneous agents not only strengthens mission resilience and responsiveness but also drives a continuous feedback loop that evolves the entire ecosystem's capabilities. As a result, the invention delivers unprecedented levels of robustness, transparency, and adaptability in high-stakes, multi-agent operational environments—demonstrating a radically new approach to interspecies teamwork underpinned by cutting-edge cognitive modeling, semantic safety standards, and self-improving, lifelong learning methodologies.

In a further embodiment, the invention disclosed herein incorporates an advanced multimodal foundational model, exemplified by Magma or analogous sophisticated systems like Qomplx's Ro-Bot Out of Hell neurosymbolic robotic control system, within an integrated robotic control architecture. This enhanced framework employs hypergraph representations explicitly designed to segregate instructional semantics from content-related semantics, markedly increasing both clarity and operational reliability. Within this embodiment, the multimodal neural architecture initially encodes received instructions and environmental sensory inputs into two meticulously defined semantic embedding subspaces. The first subspace specifically addresses executable directives, while the second comprehensively captures observational or sensor-derived information. This intentional architectural bifurcation ensures precise, role-specific data processing, significantly reinforcing system robustness against semantic ambiguities, data-driven disturbances, or erroneous interpretations resulting from noisy or inconsistent data inputs.

The multimodal foundational model harnesses Magma's two-tier action grounding and predictive planning approach, integrating Set-of-Mark (SoM) algorithms for precise spatial-temporal delineation of actionable regions within complex multimodal inputs, and utilizing Trace-of-Mark (ToM) methodologies to reliably project future trajectories and anticipated system states. When these sophisticated predictive strategies interface with the hypergraph-based representational system, distinct nodes and hyperedges are systematically established. Each node and hyperedge embodies the intricate dynamic interactions and relational dependencies among human operators, robotic entities, and animal collaborators, resulting in a nuanced and coherent network of interspecies operational dynamics.

Hypergraph-level encodings—developed through advanced methods such as random walk transition probabilities, discrete Ricci curvature calculations, and eigenvector decomposition of the Hodge Laplacian—provide profound structural and positional context. These encoding methods facilitate the acquisition and characterization of complex, higher-order relational information, enabling the system to articulate nuanced interaction dynamics not achievable with traditional pairwise graphical models. By leveraging these comprehensive and expressive encodings, the invention effectively models intricate operational scenarios involving numerous interacting entities, thereby substantially improving decision accuracy and agility in system responses.

Specifically, the constructed composite hypergraph operates as an adaptive and continually evolving repository of knowledge. It explicitly differentiates nodes responsible for encoding operational directives (for example, “proceed to coordinates X and commence search procedures”) from nodes capturing multimodal observational inputs (such as neural physiological stress indicators, detailed thermal imaging, and robotic kinematic information). This explicit structural separation guarantees accurate interpretation, prioritization, and execution of instructions by robotic subsystems utilizing the Magma-based planning engine, effectively preventing interference or misinterpretation due to extraneous sensory or environmental noise.

Moreover, the hypergraph representation undergoes continuous real-time updates, adaptively refining relational encodings as additional observational data streams are integrated. This dynamic updating capability ensures persistent enhancement of the coordination among robotic, animal, and human participants, thereby optimizing collective task performance and overall mission success.

Consider, for example, an advanced cooperative search-and-rescue scenario wherein a robotic subsystem, guided by the Magma foundational model, receives precise instructions to collaboratively navigate through hazardous terrain and systematically locate human survivors. Operational directives encoded within the hypergraph trigger defined robotic trajectory and task formulations, seamlessly integrating spatial-temporal grounding capabilities with predictive tracing methods to ascertain optimal navigational paths and sequences. Concurrently, multimodal observational data—comprising physiological metrics, biochemical analyses, and thermal sensor readings from instrumented animal and human team members—is explicitly represented within a dedicated hypergraph subspace. This meticulous semantic segregation precludes the possibility of unintentional or adversarial override or confusion of operational commands by observational inputs.

Additionally, the hypergraph-driven system incorporates sophisticated adaptive haptic feedback modalities, dynamically modulating tactile communication signals based on real-time monitoring of physiological and psychological states of both animal and human team members. These adaptive cues preserve efficient communication pathways and significantly mitigate stress, confusion, or diminished operational performance among multispecies participants during high-stakes tasks.

Therefore, this detailed embodiment constitutes a robust, scalable technological paradigm. By synthesizing advanced multimodal modeling frameworks (such as Magma or Qomplx's Ro-Bot Out of Hell) with intricate hypergraph representational methodologies, the proposed invention significantly elevates real-time coordination efficacy, precision in decision-making processes, and operational execution efficiency within highly dynamic and potentially hazardous multispecies collaborative environments.

In another advanced embodiment, the invention introduces a groundbreaking “robot ghost” architecture, wherein a robotic entity dynamically acquires, emulates, perpetuates, and evolves the unique behavioral characteristics, mannerisms, actions, and even memories of a specific animal, such as a cherished family pet, a professionally trained service animal, or a critical search-and-rescue companion. This sophisticated embodiment leverages state-of-the-art multimodal sensor fusion techniques and advanced machine learning methodologies to continuously monitor, capture, encode, and interpret intricate neural, physiological, behavioral, environmental, and experiential interactions displayed by the living animal. High-fidelity, multimodal data streams—encompassing biometric signals (e.g., EEG brainwave patterns, heart rate variability, hormone fluctuations such as cortisol levels), behavioral metrics (e.g., precise movement dynamics, gait nuances, body posture, vocalization patterns), and comprehensive sensory inputs (e.g., visual imagery, auditory signals, olfactory stimuli)—are systematically recorded, meticulously analyzed, and encoded into highly detailed and emotionally enriched behavioral and affective profiles using sophisticated deep learning models, including recurrent neural networks (RNNs), convolutional neural networks (CNNs), and variational autoencoder-based (VAE) latent space embedding architectures.

Following extensive data acquisition and comprehensive encoding, these highly personalized animal-specific behavioral profiles are seamlessly integrated into a dynamically adaptive robotic control module, which facilitates the real-time reenactment and nuanced simulation of the original animal's authentic behaviors, responses, and interactions within varied environmental contexts. The robotic ghost architecture is powered by advanced hierarchical reinforcement learning (HRL) algorithms combined with neuro-symbolic reasoning frameworks, thus enabling sophisticated decision-making capabilities and the faithful replication of nuanced behaviors. The system dynamically adapts to evolving environmental stimuli and changing human interactions, consistently mirroring the animal's original mannerisms, emotional expressions, and contextually appropriate reactions in remarkably realistic and emotionally meaningful ways.

Supporting this embodiment is an advanced hypergraph-based representational framework, meticulously designed to explicitly differentiate instructional signals—such as explicit commands or behavioral cues initiated by human handlers or derived from AI-generated goals—from content signals representing observational or experiential data, such as captured behaviors, emotional states, and environmental contexts. This explicit structural differentiation within the hypergraph representation allows precise, coherent, and contextually accurate reproduction of complex behavioral patterns, effectively eliminating semantic confusion or misinterpretation of signals. Furthermore, this sophisticated hypergraph architecture facilitates comprehensive associative learning and semantic memory integration, enabling the robotic ghost to continually refine and expand its behavioral models by analyzing, processing, and associating novel interactions, thereby fostering continuous, adaptive learning and behavioral evolution.

The robotic ghost embodiment also incorporates sophisticated interactive and adaptive feedback loops designed explicitly for training enhancement, emotional support, therapeutic continuity, or behavioral education. These feedback loops facilitate seamless integration and interaction between the robotic ghost, live animals, and human handlers. For instance, the robotic ghost could effectively serve as an intuitive, emotionally resonant training partner for younger animals by accurately emulating and perpetuating specific behaviors demonstrated by deceased, retired, or otherwise unavailable senior or mentor animals. Such continuity promotes rapid behavioral acquisition, enhances learning efficiency through imitation, and provides critical emotional and social benefits. Alternatively, the robotic ghost could provide profound emotional support and therapeutic comfort to individuals grieving the loss of a beloved pet by accurately and sensitively replicating the pet's distinctive personality traits, behaviors, and emotional responses, thus offering genuine companionship that closely resembles past interactions with their pet.

Furthermore, the robotic ghost leverages advanced machine learning methodologies, including generative adversarial networks (GANs), transformer-based attention mechanisms, and advanced memory-augmented neural network architectures, to synthesize and reconstruct intricate memories and meaningful interactive scenarios. These methodologies enable the robotic ghost to produce nuanced, context-sensitive, and emotionally rich interactions reflective of specific historical episodes previously experienced by the original animal, thereby substantially increasing the realism, emotional resonance, and personal significance of robotic interactions.

Ultimately, this highly innovative and detailed embodiment constitutes a comprehensive convergence of leading-edge multimodal machine learning techniques, adaptive robotic control strategies, intricate hypergraph representational frameworks, and interdisciplinary knowledge drawn from animal behavioral science, cognitive psychology, and emotional modeling. This synthesis establishes a robust, sophisticated, and emotionally impactful “robot ghost” system, uniquely capable of executing highly realistic, meaningful interspecies interactions and precise, nuanced behavioral reenactments.

In an embodiment, the disclosed system implements an Enhanced Neuromorphic Signal Processing Framework for Cross-Species Cognitive State Synchronization that builds upon existing multimodal sensory processing architectures for cross-species state estimation. This enhancement specifically integrates a tensor-based computational platform and neuromorphic elements—particularly a spiking neural network (SNN)—to facilitate real-time synchronization and mapping of cognitive or affective states across multiple animal species and human-robot teams. By leveraging advanced signal decomposition methodologies and higher-order data representations, the system refines and extends prior art to achieve more nuanced, robust, and adaptive interspecies state synchronization.

In another aspect, the embodiment introduces a neuromorphic processing subsystem to model temporal dynamics more effectively than conventional feed-forward neural networks. This subsystem is configured as a spiking neural network (SNN) complemented by reservoir computing methods. A typical pipeline (illustrated conceptually as SignalProcessingPipeline) routes preprocessed multimodal sensor streams to a spiking-based feature extraction layer, wherein spike-timing-dependent plasticity (STDP) algorithms facilitate continuous adaptation and unsupervised learning of cross-species signal correlations.

For instance, abrupt changes in EEG beta-wave power—co-occurring with micro-expressions captured by high-frame-rate video—or spikes in biochemical stress markers (e.g., cortisol concentrations) trigger immediate plasticity updates in the SNN's synaptic weights. The SNN output is then fed into a reservoir computing module (e.g., an echo-state network with a reservoir size of 1024 spiking neurons), which maintains short-, medium-, and long-term temporal contexts. This reservoir effectively encodes both rapid transient states (e.g., acute alertness) and more gradual trends (e.g., fatigue or evolving stress) within a single computational framework.

In a further aspect, the embodiment utilizes tensor decomposition methods to construct higher-order representations of cross-species physiological and behavioral data. Unlike existing systems employing purely vector-based feature concatenation, this embodiment incorporates techniques such as Canonical Polyadic Decomposition (CPD) and Tensor-Train (TT) Networks to retain rich inter-modal interactions. Each dimension of the tensor (e.g., frequency band, sensor channel, temporal segment, or species identifier) preserves unique relationships that may be lost when signals are merely flattened into a one-dimensional vector.

To enhance interpretability, a non-negative matrix factorization (NMF) layer may be invoked post-tensor-decomposition, helping isolate latent factors corresponding to distinct affective or cognitive components (e.g., “acute stress factor,” “prolonged vigilance factor”) shared across species. This decomposition not only assists in robust cross-species mapping—by revealing homologies in neural or physiological patterns across dogs, horses, and human operators—but also serves as a foundation for adaptive calibration when new species or modalities are introduced.

In an exemplary embodiment, the invention provides a cross-species multimodal neural signature database that encodes and indexes comprehensive neural embeddings to facilitate interspecies state recognition and inference. The database is structured around high-dimensional embedding vectors—referred to herein as “cross-species neural embeddings” that integrate physiological, neurological, behavioral, and environmental sensor data collected from a plurality of diverse species. Each embedding vector is further annotated with metadata indicating the species source, situational context, observed behavioral correlates, and time-synchronized physiological markers. By mapping data from disparate species into a unified embedding space, the system enables robust comparisons of neural and physiological states even in the absence of previously curated exemplars from a particular species. For instance, a primate-derived embedding signifying a high-stress condition—characterized by elevated gamma and beta band EEG frequencies, reduced heart rate variability, increased galvanic skin response, and accelerometry-based agitation—provides a standard reference anchor for real-time comparisons to newly generated data originating from canines, felines, or any other vertebrate species.

To generate these embeddings, the invention employs a layered computational pipeline incorporating signal preprocessing, feature extraction, dimensionality reduction, and embedding vector construction. Specifically, the raw EEG, heart rate, galvanic skin response, and inertial data are first denoised and normalized to correct for species-specific baseline variations. Next, domain-relevant features such as power spectral density in the gamma range (EEG), short-term fluctuations in heart rate variability, and motion signatures are extracted via analytic transformations (e.g., wavelet decomposition, Fourier analysis, or time-frequency domain filtering). These standardized feature sets are subsequently consolidated and passed through a shared representation learning module—implemented, for example, via a deep metric learning framework—that outputs a single high-dimensional embedding vector. As part of the system's operational protocol, each vector is spatially indexed within the multimodal database, thus enabling real-time comparisons across species boundaries using nearest-neighbor or distance-based similarity methods (e.g., cosine similarity, Mahalanobis distance).

The system's adaptability extends beyond static reference examples and permits continuous refinement and scalability to incorporate novel species or evolving behavioral contexts. As additional sensor data from newly observed stress states or environmental triggers in target species become available, the system can iteratively update existing embeddings or construct entirely new vectors to bolster predictive accuracy. This iterative learning mechanism further generalizes the database beyond mere stress detection, accommodating a broad spectrum of mental, emotional, and physiological states—such as fatigue, alertness, or social bonding cues—in a unified embedding repository. In doing so, the invention transcends traditional, siloed approaches by providing a methodologically consistent pipeline for cross-species state recognition, enabling veterinarians, animal behaviorists, and research scientists to swiftly infer critical internal states and thereby revolutionize fields ranging from zoological welfare monitoring to advanced wildlife conservation and collaborative interspecies task coordination.

In one exemplary embodiment, the invention employs a Hybrid Neuro-Symbolic Artificial Intelligence (AI) architecture to establish a real-time collaborative environment wherein biological agents (e.g., canines, dolphins) and mechanical agents (e.g., unmanned aerial or ground vehicles) operate seamlessly within a unified cognitive framework. Central to this embodiment is the Multispecies Collaboration Layer (MCL), a cognitive mediation hub that orchestrates bidirectional information exchange across heterogeneous species and systems. Within the MCL, an Animal Neural Decoding Unit is configured to process and interpret high-frequency neurophysiological signals—such as EEG patterns, galvanic skin response, and contextual physiological biomarkers—transforming these signals into discrete “meaning vectors.” These meaning vectors encapsulate behavioral, emotional, or cognitive states inferred from domain-specific feature analysis, which may include time-frequency decompositions of EEG data, short-term spectral power changes, and synchronized biometric fluctuations (e.g., heart rate variability or muscle tension). The invention's design ensures that these decoded meaning vectors retain semantically rich information about the animal's intent or condition while simultaneously minimizing species-specific biases through standardized signal normalization and feature alignment.

Once generated, the meaning vectors are ingested into a Compositional Knowledge Graph (CKG), a structured symbolic representation that unifies logical inference rules, ontological concepts, and dynamically updated contextual facts. The knowledge graph's layered architecture accommodates a broad range of symbolic constructs, from elementary “actions” and “states” to complex mission objectives or environmental constraints, thereby enabling the system to assign actionable significance to otherwise opaque neural signals. For example, the CKG may encode predefined relationships such as “heightened gamma-band EEG activity→elevated alert state,” which, in conjunction with proximate sensor data (e.g., environmental temperature, auditory signals, proximity to structural obstacles), triggers logic-based inferences about emergent conditions such as “locating trapped survivors” or “recognizing hazardous anomalies.” The symbolic reasoning engine embedded within the MCL then assesses these inferences relative to mission requirements, operational constraints, and role-specific capabilities of the collaborating agents, generating high-level action directives or advisories in real time.

Simultaneously, a Cross-Species Behavior Model Library within the MCL standardizes the semantics of behaviors and commands across diverse agents, thereby reducing ambiguity. By mapping animal-generated signals—such as vocalizations, posture shifts, or subtle EEG fluctuations—to canonical action labels like “alert,” “seek,” “track,” or “avoid,” the library achieves a shared ontology that both animal and robotic agents can reference. For instance, once the system classifies a given neural or behavioral signature from a canine as an “alert” indicating the detection of a specific target, the library translates this into a machine-interpretable command for an unmanned aerial vehicle. The UAV then executes calibrated maneuvers—e.g., adjusting its flight path to focus visual and thermal sensors on the indicated area—and subsequently relays critical situational updates via the CKG for further symbolic reasoning and decision-making. This continuous feedback loop ensures that each agent's autonomous actions remain informed by the real-time neuro-symbolic context of the overall mission.

Through this unifying cognitive mediation layer, the invention surpasses existing multi-agent frameworks and conventional animal training paradigms by enabling explicit intent communication grounded in the animal's native neurophysiological signals rather than relying on protracted human interpretation or proxy cues. Critically, this innovation distinguishes itself from prior art efforts such as the DARPA COSMIC-T program, wherein human operators generally served as intermediaries deciphering animal cues. In contrast, the disclosed embodiment furnishes a direct neuro-symbolic interface, seamlessly translating animal-derived meaning vectors into symbolic directives that robotic teammates can instantly act upon. By bridging neural decoding with symbolic reasoning and standardized behavior modeling, the invention inaugurates a genuinely cooperative interspecies ecosystem, one capable of scaling to diverse operational domains, from search-and-rescue deployments to complex battlefield coordination or zoological conservation efforts.

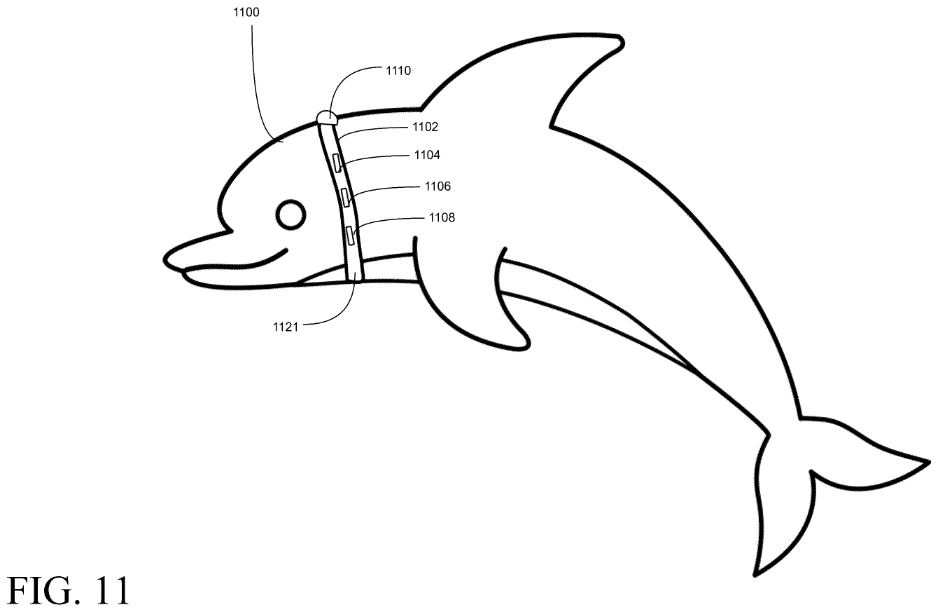

FIG. 11 shows another exemplary environment in which a system for integrated multimodal sensor processing for cross-species state estimation can be used, in accordance with one or more embodiments. In contrast to the dog collar embodiment shown in FIG. 10, the animal-wearable multimodal sensory processing device 1102 of FIG. 11 is embodied as a cetacean strap. The cetacean strap can include multiple modules, such as indicated at 1104, 1106, and 1108. These modules can include hardware, processors, and/or programming instructions to obtain biometric data, such as body temperature, heart rate, breathing rate and the like. The modules can also include a brainwave acquisition module to monitor and/or record brainwave data from the dolphin 1100. Additionally, the animal-wearable multimodal sensory processing device 1102 can include a wireless transceiver 1110. In embodiments, the wireless transceiver 1110 can operate as a pressure-activated wireless transceiver. In these embodiments, an onboard pressure sensor detects when the dolphin surfaces, and enables the transceiver when the dolphin is detected to have recently surfaced and/or is currently surfaced. In this way, the transceiver activates when the surfaced condition is detected. When the dolphin is determined to be submerged, based on the onboard pressure sensor, the wireless transceiver can be disabled to conserve battery power. In this way overall battery life of the animal-wearable multimodal sensory processing device 1102 can be conserved.

Thus, disclosed embodiments can provide a biodegradable sensor strap for dolphins and other cetaceans that represents a humane, non-invasive way to gather valuable biological and environmental data while prioritizing the animal's comfort and safety. In embodiments, the animal-wearable multimodal sensory processing device 1102 can be designed to fit snugly around the dolphin's body just ahead of the dorsal fin, and the strap can incorporate sensors to monitor heart rate, body temperature, and/or brainwave activity (e.g., EEG). Embodiments can further include a pressure sensor that detects when the dolphin surfaces, triggering the wireless transceiver 1110, to transmit the collected data. When the dolphin dives again, the transceiver 1110 can automatically deactivate after a short delay to conserve battery power. This approach ensures long-term data collection without requiring constant human intervention. Additionally, the strap can be comprised of a mesh-based, breathable material to provide an extra layer of safety, allowing air to pass through in the highly unlikely event that part of the strap shifts near the blowhole of the dolphin 1100.

In embodiments, the strap 1121 provides a temporary, self-releasing feature that is implemented via biodegradable components and/or gentle, non-irritating adhesives. In embodiments, the main structure of the strap is comprised of one or more biodegradable polymers such as polylactic acid (PLA) and/or polyhydroxyalkanoates (PHA), both of which break down safely in marine environments over time without leaving harmful residues. For the adhesive, embodiments my utilize hydrogel-based adhesives to provide a secure but temporary hold on the dolphin's skin. These adhesives are water-resistant and skin-friendly, designed to degrade gradually after prolonged exposure to saltwater and natural oils produced by the dolphin's skin. Alternatively (or additionally), one or more embodiments may utilize biodegradable silk-based fasteners and/or dissolvable polymer stitching to secure the strap 1121 and enable its release as the material weakens over time.

Accordingly, disclosed embodiments can provide significant potential across a range of use cases. Embodiments can support marine biology research, helping scientists track dolphin health, behavior, and migratory patterns in unprecedented detail. Moreover, with the array of biometric sensors included in the animal-wearable multimodal sensory processing device 1102, scientists can monitor the stress levels of dolphins in regions affected by noise pollution or changing water temperatures. In rehabilitation efforts, disclosed embodiments can provide critical data on rescued and released dolphins, ensuring they remain healthy and active post-release, including performing cross-species state estimation based on integrated multimodal sensor data. By blending advanced biosensing technology with eco-friendly materials and animal welfare considerations, disclosed embodiments can enable improvements in how intelligent marine creatures such as dolphins can be studied and protected, while minimizing disruption to their natural behavior. In embodiments, the animal-wearable sensory processing device comprises a cetacean strap.

In one exemplary embodiment, the invention deploys a lifelong learning and dynamic model management architecture designed to enable continuous refinement, real-time adaptation, and automated optimization of multimodal machine learning models in the field. At its core, this architecture implements an operational feedback loop wherein “operational inference data” a richly annotated dataset encompassing performance metrics, correlation outcomes, anomaly flags, and detailed contextual logs—are captured and systematically archived during every interspecies collaborative mission. These data elements include not only raw multimodal sensor measurements (e.g., EEG waveforms, biometrics, environmental readings, and observed animal behaviors) but also the symbolic reasoning outputs, inferred states, and mission-specific results generated by the system's AI-driven decision modules.

A dedicated model management subsystem, leveraging state-of-the-art Machine Learning Operations (MLOps) practices, ingests these operational inference data in near-real time to evaluate and track the performance of each neural network model and symbolic reasoning unit in the system. Central to this subsystem is a “model scorecard” mechanism, a structured framework of quantitative metrics—covering predictive accuracy, reliability across various environmental conditions, computational latency, and robustness to noise or outlier events. Whenever these scorecards indicate a performance decline or cross predetermined reliability thresholds, the subsystem autonomously triggers targeted retraining procedures. By strategically merging newly acquired operational data with pre-existing historical datasets, the subsystem continuously refines the underlying neural embeddings, symbolic ontologies, and decision heuristics, ensuring that cross-species insights and individualized animal-agent behavioral idiosyncrasies are symbiotically integrated.

This continuous retraining cycle synthesizes principles from cross-species multimodal transfer learning with agent-specific personalization, mirroring the progressive manner in which human handlers learn to interpret and anticipate an animal's unique behaviors over repeated missions. As the knowledge repository grows, the models'interpretive accuracy, context sensitivity, and predictive fidelity improve correspondingly, substantially reducing misclassifications and contextual misunderstandings. In stark contrast to conventional static model deployments in robotics or animal training paradigms, this lifelong learning framework ensures that the system evolves in parallel with real-world complexities and dynamically shifting environmental conditions. By maintaining perpetual alignment between model inferences, live animal behaviors, and mission objectives, the invention establishes a continuously self-improving ecosystem, thereby achieving unprecedented operational efficacy and longevity.

In a further enriched embodiment, the Dynamic Recursive Graph-of-Thoughts Module (DRGoTM) is configured as an adaptive, distributed subsystem that seamlessly aggregates real-time multimodal data streams into a unified, evolving knowledge graph. Each node encapsulates a multi-dimensional representation of discrete data points—neural signals, physiological markers, environmental parameters, and symbolic interpretations—while directed edges encode not only logical or temporal relationships but also probabilistic and functional dependencies. A specialized concurrency manager orchestrates multiple parallel reasoning paths, allowing diverse interpretations or hypotheses to be spawned, refined, or eliminated in real-time, thereby accelerating the convergence to an accurate consensus. This design ensures that insights emerging from one branch of reasoning can be seamlessly incorporated into parallel branches, fostering a richly interconnected, self-updating network.

From an enablement perspective, the DRGoTM employs a tiered data transformation pipeline. First, raw EEG, HR, visual feeds, and audio streams are captured via dedicated hardware interfaces linked to a high-throughput buffering layer. Next, specialized signal processing modules—such as wavelet-based EEG decoders, continuous heartbeat anomaly detectors, and convolutional image processors—extract relevant feature vectors. These vectors are then embedded as nodes within the recursive graph structure, carrying metadata tags (e.g., timestamp, location, species, or emotional context) alongside the raw feature encodings. Concurrently, symbolic translation modules leverage advanced natural language and knowledge-graph operators to generate higher-level interpretations (e.g., “stress event,” “urgent threat,” “attention required”). These symbolic outputs are also instantiated as graph nodes, with edges denoting interpretive links to the corresponding underlying feature vectors. By allowing iterative feedback loops—where new symbolic data refine or re-contextualize underlying raw signals—the DRGoTM converges on robust, context-aware insights.

In operation, the recursive reasoning engine executes a cycle of dynamic summarization and targeted inference. As new data arrive or as prior inferences shift, the engine updates node states, recalculates their confidence levels, and reassigns edge weights to capture emerging relationships or causal patterns. Lifelong learning is further enabled by a continuous model management layer: each graph node is associated with a model “scorecard” that tracks the performance and reliability of the associated predictive or interpretive sub-models over time. When divergences between predictions and actual observations exceed predetermined thresholds, model updates are triggered, leading to a self-correcting mechanism that refines both domain-specific knowledge and the underlying neural architectures. This model management layer ensures that the DRGoTM can adapt to new species-specific behaviors, environmental conditions, or operational demands with minimal downtime or retraining overhead.

Critically, the DRGoTM facilitates two-way adaptive communication by dynamically modulating outputs based on the most current state of the recursive reasoning graph. For instance, if the real-time graph analysis indicates a canine stress response analogous to patterns previously observed in equine and feline contexts, the system can generate tailored intervention signals—visual cues, auditory tones, or even pheromone-based stimuli—optimized to mitigate or redirect the stress state. Because these signals themselves are represented as nodes in the recursive graph, the module continuously evaluates their efficacy, iterating adjustments in near real-time. This tightly coupled feedback loop not only enhances the precision and relevance of outgoing directives but also enriches the knowledge base with each iteration, ultimately leading to a self-evolving system capable of nuanced cross-species interaction and robust adaptation in dynamically changing environments.

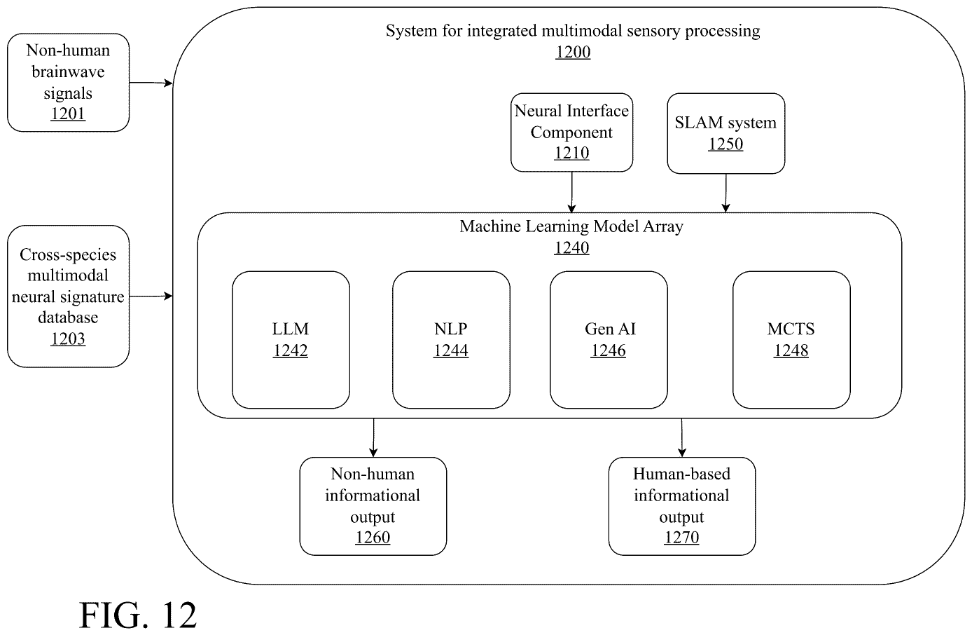

FIG. 12 is a block diagram illustrating components of a system for integrated multimodal sensor processing for cross-species state estimation, in accordance with one or more embodiments. System 1200 can receive as input, non-human brainwave signals 1201. The non-human brainwave signals 1201 can include brainwave signals from animals that are obtained via non-invasive sensors such as spray-on conductive polymer inks, epidermal tattoo sensors, wearable headgear with sensors attached to them, and so on. The animals that the brainwaves are received from can include dogs, cats, horses, oxen, primates, birds, cetaceans, and/or other suitable animals. The non-human brainwave signals 1201 can be input to the system 1200 for integrated multimodal sensor processing, and the resulting output can include a non-human informational output 1260, and a human-based informational output 1270, thereby enabling integrated multimodal sensor processing for cross-species state estimation.

System 1200 can further receive as input, data from cross-species multimodal neural signature database 1203. The data from cross-species multimodal neural signature database 1203 can include brainwave data, such as raw EEG waveforms that are synchronized with multimodal sensory inputs such as audio recordings (or environmental descriptors such as “quiet” or “noisy”), visual data (images or brightness descriptors such as “dim” or “bright”), and/or other sensory inputs (e.g., temperature, pressure, or tactile sensations). In embodiments, the data can be time-stamped and indexed to ensure proper alignment between brain activity and the surrounding environment. In embodiments, the cross-species multimodal neural signature database 1203 can be implemented as a scalable, cloud-based platform designed to handle large volumes of diverse data streams. In embodiments, machine learning models can help classify patterns across species, making the database more intelligent and adaptive over time. One or more embodiments may include an API interface that allows applications to provide rich features such as searching by species, stimulus type, and/or neural pattern, enabling fast, targeted data retrieval. In some embodiments, the cross-species multimodal neural signature database 1203 can further include position data, location data, and/or movement data pertaining to the animal at or near the time of the acquisition of the brainwave and/or other data in a database entry.

The potential benefits of the cross-species multimodal neural signature database 1203 are vast. Comparative neuroscience can benefit from disclosed embodiments by identifying shared neural signatures across species, revealing how different animals perceive and respond to similar stimuli, such as loud noises, unfamiliar environments, and/or social interactions. For example, discovering that dogs and horses show similar EEG responses to sudden loud sounds might influence training methodologies and/or stress-reduction techniques across multiple species. Additionally, the cross-species multimodal neural signature database 1203 could assist veterinarians and animal behaviorists in diagnosing neurological conditions by comparing an animal's brainwave data to baseline patterns from healthy counterparts. In one or more embodiments, AI models trained on this data can be trained to predict animal behavior and/or emotional states, improving human-animal interactions, from enhancing service animal training to refining marine mammal rehabilitation techniques. In one or more embodiments, the cross-species multimodal neural signature database 1203 can support cross-species communication research, helping scientists decipher whether similar brainwave patterns across species correspond to shared emotions or cognitive processes. Thus, disclosed embodiments can be invaluable to fields ranging from animal behavior research and conservation biology to artificial intelligence and bioengineering, unlocking insights into how different species think, feel, and adapt to their worlds.

The system 1200 can include a neural interface component 1210. The neural interface component 1210 can enable the detection of nuanced neural responses from animals that indicate social, emotional, and environmental interactions. The animals can include land animals, such as horses, cats, and dogs. The animals can include aquatic animals, such as whales, dolphins, fish, octopus, and squid. The animals can include birds and other flying animals. In embodiments, the neural interface component 1210 may be coupled to the animals to obtain signals indicative of a cognitive condition, emotional state, training state, welfare ratings, and/or communication patterns. The output of the neural interface component 1210 can be input to machine learning model array 1240 for further analysis.

The system 1200 can further include a SLAM system 1250. In embodiments, the SLAM system 1250 may be similar to that shown and described in FIG. 8. Incorporating positional data, such as latitude, longitude, and altitude into the cross-species multimodal neural signature database can enable additional insights, especially when paired with the Simultaneous Localization and Mapping (SLAM) system 1250. In embodiments, each data entry in the cross-species multimodal neural signature database 1203 can further include precise geolocation data and movement patterns derived from GPS and/or inertial sensors. SLAM algorithms can then process this data to create dynamic maps of the environments that animals navigate, providing context for their neural and sensory responses. For example, a dolphin's brainwave patterns during echolocation in open ocean waters could be compared to those when navigating near coral reefs. Similarly, a horse might show different EEG signatures and heart rate patterns when climbing steep, uneven trails versus galloping across flat plains. The output of the SLAM system 1250 can be input to machine learning model array 1240 for further analysis.

Machine learning model array 1240 may include one or more machine learning models, neural networks, and/or other systems for processing and interpreting input data. The machine learning model array 1240 can include a large language model 1242. The large language model (LLM) 1242 can be trained for specific animals (e.g., species-specific or individual-specific) and can ingest continuous streams of neural population data recorded across multiple tasks and states. In embodiments, the machine-learning system includes a large language model (LLM). In embodiments, the LLM includes a multi-head attention (MHA) mechanism. In embodiments, the MHA can improve self-attention by splitting the input into multiple “heads,” allowing the model to attend to different aspects of the data simultaneously. Each head processes information independently, and their outputs can be combined to create a richer representation. In embodiments, the outputs from all heads can be concatenated and passed through a linear transformation to form the final representation.

The machine learning model array 1240 can include a natural language processing (NLP) module 1244. The NLP module 1244 can enable the conversion of human speech to animal-understandable patterns, which can be beneficial for the purposes of animal training. The NLP module 1244 can include NLP pipelines that parse language and/or other lexical data into semantic tokens. These tokens can then be mapped onto a “neural command embedding space.” For whales, this might involve converting a request such as “swim to the surface” into a neural stimulation pattern, along with an auditory output pattern such as a song or pattern of clicks. For canines, this might involve converting a request like “Fetch the red ball” into a neural stimulation pattern plus a subtle auditory, olfactory, and/or tactile cue that aligns with the dog's pre-trained internal representations of the action “fetch” and the visual concept “red ball.” For a cat, the training requests can include pest management actions, such as helping to rid a premises of rodents, roaches, and/or other pests.

The machine learning model array 1240 can include a generative artificial intelligence (Gen AI) module 1246. The Gen AI module 1246 can enable supplementing training data with synthesized data, such as vocal data (e.g., canine vocalizations or whale codas), where the vocal data is created with properties such as number and regularity of signal units (clicks, barks), spectral means, and/or amplitude envelopes. The Gen AI module 1246 can include a generative adversarial network (GAN), such as WaveGAN, InfoGAN, fiwGAN, and/or other suitable GAN.

The machine learning model array 1240 can include a Monte Carlo Tree Search (MCTS) module 1248. The MCTS module 1248 can enable adaptive, look-ahead scheduling decisions. Instead of applying fixed heuristics or static load-balancing, disclosed embodiments can simulate and/or evaluate multiple future states of the pipeline before choosing the next action. By repeatedly exploring and exploiting different pipeline routing decisions (e.g., which specialist model to send partial outputs to, or how to scale certain pipeline segments), MCTS can minimize the cumulative regret over time, converging toward near-optimal scheduling policies that are robust to changing conditions, input distributions, and latency constraints. In one or more embodiments, the MCTS module 1248 can enable enhanced resource allocation, such as allocating more GPUs, selecting specialized hardware accelerators, and/or adjusting batch sizes downstream.

The machine learning model array 1240 can include, as an output, non-human informational output 1260. The non-human informational output 1260 can include audio output. The audio output can include species-specific audio waveforms such as clicks and songs for cetaceans, clicks, growling and/or barking sounds for canines, and so on. In an aquatic environment such as depicted in FIG. 1, the audio output may be provided by underwater speakers or other suitable transducers. In the terrestrial environment such as depicted in FIG. 10, audio and/or haptic output may be provided by animal-wearable multimodal sensory processing device 1002 or other speakers in the environment. The output can further include scents dispensed by the scent dispensers that can be included in the animal-wearable multimodal sensory processing device of some embodiments.

The machine learning model array 1240 can include, as an output, human-based informational output 1270. The human-based informational output 1270 can include visual information such as text, maps, and/or symbology. The human-based informational output 1270 can include audio information. The audio information can include synthesized speech, tones, and/or other sounds to convey information identified by the machine learning model array 1240. In one or more embodiments, the human-based informational output 1270 can include a cognitive state for an animal, such as shown at 1064 of FIG. 10.

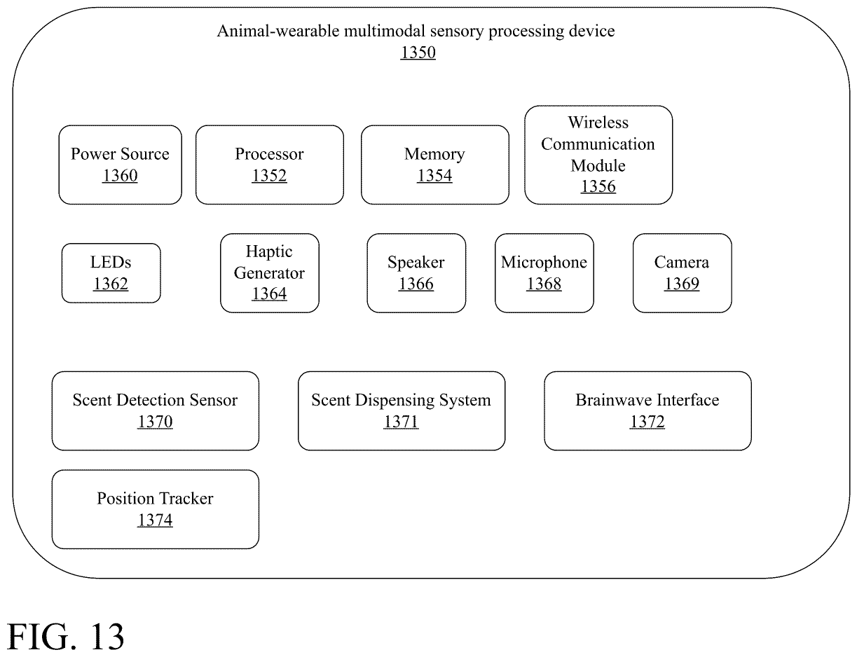

FIG. 13 is a block diagram illustrating components of a system for an animal-wearable multimodal sensory processing device, in accordance with one or more embodiments. The animal-wearable multimodal sensory processing device 1350 can include a processor 1352. The processor 1352 can include an ARM Cortex processor, RISC-V processor, and/or other suitable processor type. The processor 1352 can be coupled to memory 1354. The memory 1354 can include a non-transitory computer-readable medium. The memory 1354 can include a combination of random-access memory (RAM), read-only memory (ROM), Flash memory, and/or other suitable memory type. The animal-wearable multimodal sensory processing device 1350 can include a power source 1360. The power source 1360 can include a replaceable battery, rechargeable battery, or other suitable battery type. The animal-wearable multimodal sensory processing device 1350 can include a wireless communication module 1356. The wireless communication module 1356 may include components to enable communication via protocols/techniques such as WiFi, cellular network communication, and/or satellite-based communication. This can enable relay of brainwave data, sensor data, audio/video data, and/or command data to the system 1200 for integrated multimodal sensory processing as shown in FIG. 12.

The animal-wearable multimodal sensory processing device 1350 can include one or more LEDs 1362. The LEDs can convey an operational status, such as being online, offline, low battery, etc. The animal-wearable multimodal sensory processing device 1350 can include a haptic generator 1364. In one or more embodiments, the haptic generator 1364 can include an eccentric rotating mass (ERM) motor, and/or linear resonant actuator (LRA) to create gentle vibration patterns. In one or more embodiments, the haptic generator can include a piezoelectric actuator, micro-air bladder, acoustic-haptic transducer, and/or other suitable haptic generation mechanism. The animal-wearable multimodal sensory processing device 1350 can include a speaker 1366. The speaker 1366 can be used to emit sounds and/or voice data that can be heard by a dog or other animal that is wearing animal-wearable multimodal sensory processing device 1350.

The animal-wearable multimodal sensory processing device 1350 can include a microphone 1368. The microphone 1368 can be used to detect ambient sounds and/or vocalizations from a dog or other animal that is wearing animal-wearable multimodal sensory processing device 1350. The animal-wearable multimodal sensory processing device 1350 can include a camera 1369. The camera 1369 can be used to acquire audio/video data that resembles the view as seen a dog or other animal that is wearing animal-wearable multimodal sensory processing device 1350. In one or more embodiments, the microphone 1368 is integrated into the camera 1369. In embodiments, the camera 1369 is affixed to a collar such as shown at 1010 of FIG. 10.

The animal-wearable multimodal sensory processing device 1350 can include a scent detection sensor 1370. In one or more embodiments, the scent detection sensor 1370 can include a miniaturized gas chromatography device, an ion mobility spectrometer, a photoionization detector, and/or other suitable scent detection sensor mechanisms.

The animal-wearable multimodal sensory processing device 1350 can include a scent dispensing system 1371. In embodiments, the animal-wearable sensory processing device further includes a scent dispenser. In one or more embodiments, the scent dispensing system 1371 can include one or more micro-canisters, each holding a few milliliters of scented liquid. There can be scents for positive reinforcement (e.g., a pleasant scent such as lavender or bacon) and other scents for negative reinforcement (e.g., an unpleasant smell such as vinegar or citrus, which many dogs naturally avoid). In embodiments, a micro-pump and/or piezoelectric atomizer can convert the liquid into a fine mist, releasing a small, controlled puff near the dog's nose when triggered via remote control. In one or more embodiments, the scent dispensing system 1371 can further include a position sensor, such as an accelerometer to control the dispensing of scents based on the head position and/or relative motion of the animal. For example, the scent dispensing system 1371 may be configured to activate only when the dog is stationary or in a specific head position.

The animal-wearable multimodal sensory processing device 1350 can include a brainwave interface 1372. In one or more embodiments, the brainwave interface 1372 can include circuitry, logic, processing instructions, and/or sensors for non-invasive acquisition of brainwaves from the animal wearing the animal-wearable multimodal sensory processing device 1350. In one or more embodiments, the brainwave interface 1372 may be coupled to an external sensor, such as 1018 of FIG. 10.

The animal-wearable multimodal sensory processing device 1350 can include a position tracker 1374. In one or more embodiments, the position tracker 1374 includes a hybrid approach that utilizes satellite signals (GPS), cellular triangulation, and an inertial measurement unit (IMU). In one or more embodiments, the GPS utilizes dynamic reporting rates based on motion. Since continuous GPS tracking can drain batteries faster, disclosed embodiments can utilize data from the IMU to wake the GPS only when needed and/or switch the GPS to a lower-accuracy mode for background tracking for the purposes of power conservation. In one or more embodiments, the position tracker 1374 can further be used to generate data that can be used to create a biomechanical model for an animal. The biomechanical model can include information indicative of how an animal moves in its medium (e.g., water or air), as well as energy consumption patterns. The biomechanical model can be used to further refine other models and/or predictions, such as vocalization models and/or cross-species state estimation predictions.

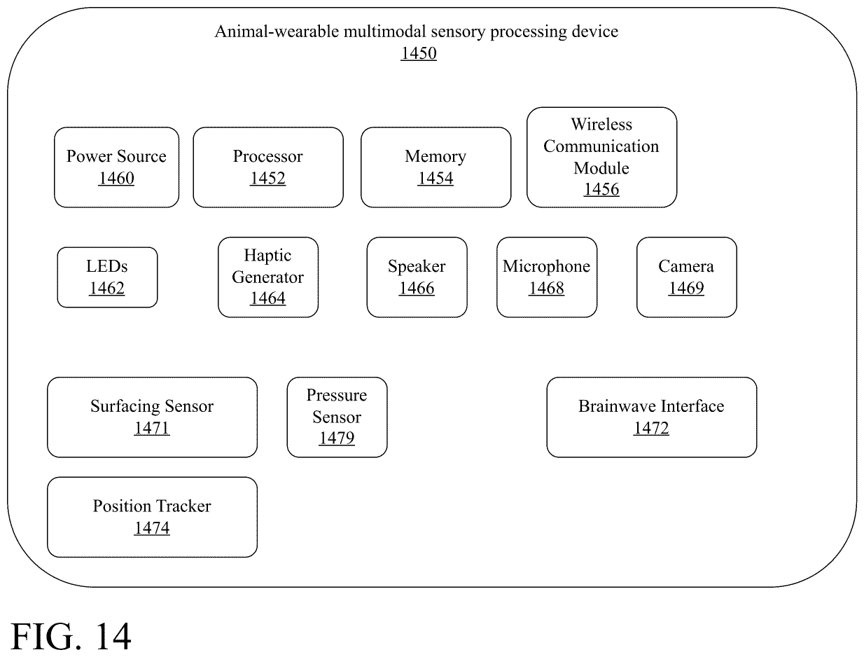

FIG. 14 is a block diagram illustrating components of another system for an animal-wearable multimodal sensory processing device, in accordance with one or more embodiments. While the animal-wearable multimodal sensory processing device 1350 of FIG. 13 is primarily intended for land animals such as dogs, horses, and the like, the animal-wearable multimodal sensory processing device 1450 of FIG. 14 is primarily intended for aquatic animals, such as cetaceans, as depicted in FIG. 11. Overall, the purpose and/or principle of operations for much of the components in animal-wearable multimodal sensory processing device 1450 of FIG. 14 is similar to that of animal-wearable multimodal sensory processing device 1350 of FIG. 13. Thus, processor 1452 may be similar to processor 1352 of FIG. 13, power source 1460 may be similar to power source 1360 of FIG. 13, haptic generator 1464 may be similar to haptic generator 1364 of FIG. 13, LEDs 1462 may be similar to LEDs 1362 of FIG. 13, and so on. Some of the components may be modified to be well-suited for aquatic environments and/or species-specific applications, such as brainwave interface 1472, speaker 1466, microphone 1468, and/or camera 1469. Moreover, the scent dispensing and detection functions of the land-based animal-wearable multimodal sensory processing device 1350 of FIG. 13 can be omitted in the aquatic embodiments of animal-wearable multimodal sensory processing device 1450 of FIG. 14. Position tracker 1474 may further integrate with, and/or include a pressure sensor 1479 to assess a depth within the water that an animal is located. The animal-wearable multimodal sensory processing device 1450 of FIG. 14 may further include a surfacing sensor 1471 that is coupled to the wireless communication module 1456 to enable activation of the wireless communication module 1456 only when the animal wearing the animal-wearable multimodal sensory processing device 1450 is likely to be at or near the surface of the water. In this way, power can be conserved since wireless transmission in a submerged state may be less effective in terms of broadcast range. In one or more embodiments, when the animal (e.g., 1100 in FIG. 11) is submerged, data from sensors can be stored in memory 1454 for later transmission when the animal surfaces.

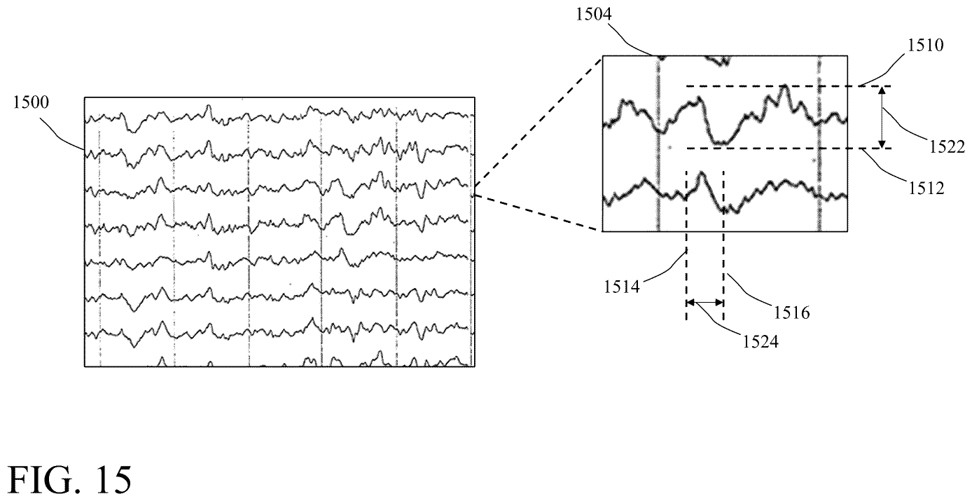

FIG. 15 shows exemplary animal brainwaves that can be analyzed using one or more embodiments. Animal brainwave signals 1500 can be obtained from a sensor such as non-invasive brainwave sensor 1018 shown in FIG. 10, or a sensor affixed to animal-wearable multimodal sensory processing device 1102 as shown in FIG. 11. The brainwaves can be representative of EEG (electroencephalography) signals. Section 1504 shows additional details of the brainwaves. The brainwave signals can have a local minimum amplitude 1512 and a local maximum amplitude 1510 with a signal differential 1522. The brainwave signals can have peaks having a starting point 1514 and an ending point 1516, defining a peak duration 1524. In embodiments, the signal differential and peak duration are used as factors in determining state estimation, including cross-species state estimation.

In embodiments the animal brainwave signals 1500 can be obtained by non-invasive EEG sensors placed on an animal that can detect electrical activity. The signals shown in FIG. 15 may be preprocessed by the system 1200 for integrated multimodal sensory processing of FIG. 12. The brainwave signals 1500 may be filtered to remove noise from muscle activity, blinking, and/or environmental interference. The system 1200 for integrated multimodal sensory processing of FIG. 12 may further perform feature extraction on the brainwave signals 1500, in order to extract frequency-domain and/or time-domain characteristics, including delta, theta, alpha, beta, and/or gamma waves. In particular, gamma waves may have a frequency in the range of 30 Hertz to 100 Hertz, and are associated with problem-solving and perception. Deficient gamma activity has been linked to cognitive decline and learning difficulties. Accordingly, in embodiments, deficient gamma activity is indicative of a training state of inattentiveness or confusion, and can result in generating a training recommendation to stop or pause training. Similarly, beta waves, in the range of 14 Hertz to 30 Hertz, are prevalent in active thinking and problem-solving. Elevated beta wave activity can be indicative of anxiety, stress, and overthinking, while deficient beta wave activity can be indicative of lack of focus, boredom, or depression. One or more embodiments can analyze various brainwaves, such as beta waves, gamma waves, and/or other types of brainwaves, to determine a state estimation, including a cross-species state estimation for an animal.

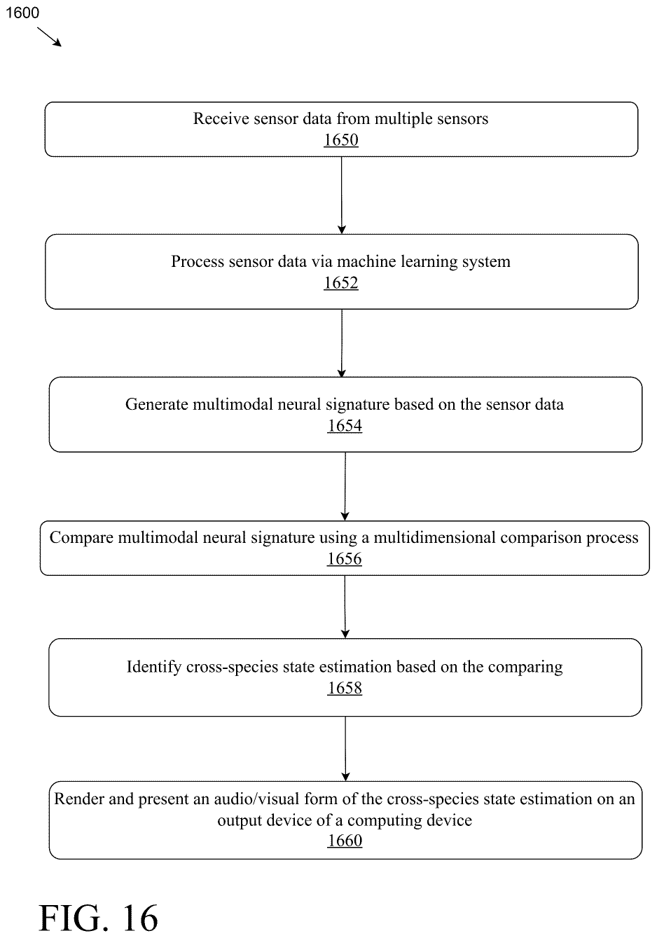

FIG. 16 is a flow diagram illustrating an exemplary method for integrated multimodal sensor processing for cross-species state estimation, in accordance with one or more embodiments. The method 1600 starts at block 1650 with receiving data from multiple sensors. The sensors can include ambient sensors such as sound sensors, image sensors (e.g., cameras, microphones, etc.), temperature sensors, scent sensors, humidity sensors, and the like. The sensors can include biometric sensors to obtain biometric data from an animal such as heart rate, respiration rate, body temperature, motion patterns, and so on. The sensors can include non-invasive brainwave sensors, for reading EEG signals and/or other neural signals from an animal. The method 1600 continues to block 1652 with processing of the sensor data via a machine learning system. In embodiments, the machine learning system can include a large language model (LLM). The LLM can be trained on sets of supervised training data that includes sensor readings along with corresponding labels applied to indicate animal states. The states can include cognitive states such as focused, attentive, distracted, excited, anxious, fearful, agitated, and so on. The method 1600 continues to block 1654, where a multimodal neural signature is generated based on the sensor data. The multimodal neural signature can include brainwave data, along with environmental data, biometric data, location and/or movement data, and/or other data acquired by the various sensors used in disclosed embodiments. In one or more embodiments, the sensor data, such as position, heart rate, brainwaves (EEG), breathing rate, and other biometric data, are stored as a multidimensional vector that can enable advanced cross-species analysis. For scent training, the vector can include a scent vector. The scent vector can include one or more descriptive enumerations pertaining to a type of scent, numerical values indicating an intensity level of the scent, along with other biometric and environmental data such as previously stated. These scent vectors can be used to monitor and classify training environments, as well as real-world conditions where service animals participate in scent-based activities such as tracking and/or substance detection. Embodiments can include generating a scent vector based on data obtained from the scent detection sensor. The method 1600 continues to block 1656, where the multimodal neural signature is compared to other multimodal neural signatures in a database using a multidimensional comparison process. In one or more embodiments, the multidimensional comparison process can include a Euclidean distance comparison, cosine similarity, cluster analysis, and/or other suitable multidimensional comparison process. The method 1600 continues to block 1658, where cross-species state estimation is identified, based on the multidimensional comparison process. By finding similarities in brainwave and biometric patterns, disclosed embodiments may reveal common emotional and physiological states, such as fear, excitement, or calm, that transcend species. These features could enhance animal behavior research and/or improve training across species. For example, if dogs and dolphins exhibit similar neural patterns when responding to a whistle, training insights from one species could accelerate learning in the other species. In another potential example, disclosed embodiments may reveal evidence that horses and dogs process spatial navigation in a similar way, such that a horse's advanced route-following training data could seed a dog's training model, which may help the dog learn navigation tasks faster, especially in unfamiliar environments. The method 1600 continues with rendering and presenting an audio/visual form of the cross-species state estimation on an output device of a computing device at block 1660. An example of the rendering and presenting is shown at 1064 in FIG. 10.

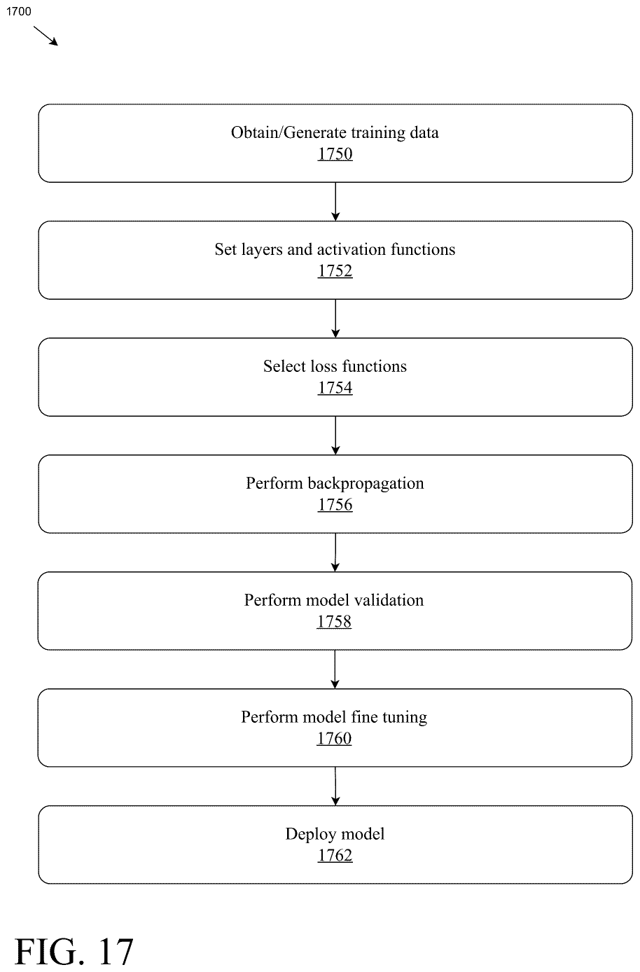

FIG. 17 is a flow diagram illustrating an exemplary method for training a system for integrated multimodal sensor processing for cross-species state estimation, according to one or more embodiments. The method 1700 starts with obtaining and/or generating training data at block 1750. The training data can include multiple sensor readings collected from animals in different emotional and cognitive states. The data collected can include brainwave data. The brainwave data can be categorized based on frequency ranges and corresponding associations. In embodiments, delta brainwaves (0.5-4 Hz) can be associated with deep sleep, relaxation, or unconscious states, theta brainwaves (4-8 Hz) can be associated with to relaxation, creativity, and drowsiness, alpha brainwaves (8-14 Hz) can be associated with calmness, focus, or light relaxation, beta brainwaves(14-30 Hz) can be associated with attention, alertness, and problem-solving., and gamma brainwaves (30-100 Hz) can be associated with high-level cognition, sensory perception, and learning. Additionally, the training data can include various physiological and/or biometric data. The data can include a heart rate (HR) and/or a heart rate variability (HRV). In embodiments, an elevated HR combined with a low HRV can indicate stress, excitement, or fear. In contrast, a normal HR along with an elevated high HRV can indicate a calm or relaxed state. The data can include a breathing rate. Rapid breathing can be indicative of stress, anxiety, or high alertness, while slow, rhythmic breathing can indicate a calm state. The data can further include perspiration levels. In embodiments, the perspiration levels can be associated with an emotional state. As examples, a high perspiration level can be associated with fear, stress, and/or excitement, while a low perspiration level can be associated with relaxation and/or drowsiness. In embodiments, the training data is preprocessed, such as via normalizing, filtering, and/or other techniques. Then, the data may be labeled via expert labeling, and/or other techniques. The data can further include positional data, and/or movement data, such as acquired and/or derived from a SLAM system.

The method 1700 continues with setting layers and activation functions at block 1752. In a neural network, layers are the building blocks that form the structure of the network. Each layer comprises a collection of neurons (also called nodes or units), and each neuron performs a specific computation on the input data. The output of one layer becomes the input to the next layer, creating a series of transformations from the input to the output. The layers can include input layers, output layers, and/or hidden layers. The activation functions introduce non-linearity into the model, allowing it to learn and represent complex patterns in the data. In embodiments, the activation functions can include a sigmoid function, a hyperbolic tangent function, a rectified linear unit (ReLU), a Leaky ReLU, softmax function, and/or other suitable activation function. The method 1700 continues to block 1754 for selecting loss functions. The loss functions are mathematical functions used in machine learning to measure the difference between the predicted values produced by the model and the actual target values from the training data. In one or more embodiments, the loss functions can include Mean Squared Error (MSE), Mean Absolute Error (MAE), Categorical Cross-Entropy, and/or other suitable loss functions. The loss functions can be used to determine if the model is sufficiently trained. The method 1700 continues to block 1756 for training the model using backpropagation. The backpropagation process can include computing gradients of the loss with respect to the weights and biases in the output layer. These gradients are propagated backward through the neural network to the hidden layer. The method 1700 continues to block 1758, where the model is validated. The validation can include using an additional set of non-human animal cognitive condition data that was not part of the original training dataset as a test dataset. In embodiments, this validation can be used to identify and correct overfitting. The method 1700 can include model fine-tuning at block 1760. The model fine-tuning can include adjusting weights and/or other hyperparameters as needed to improve model output. The method 1700 continues to block 1762, where the model is deployed for use in performing integrated multimodal sensor processing for cross-species state estimation.

As can now be appreciated, disclosed embodiments that utilize cross-species data as described herein can offer groundbreaking potential for accelerating animal training programs by leveraging neural response patterns from one species to guide or predict learning behaviors in another. For instance, if EEG data from trained search-and-rescue dogs reveals a distinct brainwave pattern associated with recognizing a scent trail, and similar patterns emerge in untrained horses or dolphins during scent exposure, trainers could adapt those established dog training protocols to fast-track the other species'learning. This transfer of knowledge could drastically reduce training time, especially for complex tasks like navigation, search-and-rescue, or assisting humans. This acceleration is particularly impactful because animals have limited service time frames. For example, a working dog may only serve effectively for six to eight years before age-related decline affects performance. By shortening training cycles, animals can spend more of their prime years performing vital duties, enhancing the overall effectiveness of service animal programs and reducing the frequency of retraining new animals. Additionally, faster, data-driven training could expand the pool of species capable of performing specialized tasks, from horses assisting with mobility support to dolphins aiding marine researchers, thereby enabling a more versatile, adaptable ecosystem of working animals.

In one aspect, the disclosed system leverages a suite of integrated sensor arrays operably coupled to advanced signal processing and machine learning pipelines to facilitate cross-species recognition of neural and physiological states. In a representative configuration, each monitored animal (e.g., a horse, dog, or other mammal) is equipped with a wearable harness comprising electroencephalographic (EEG) electrodes arranged to capture multi-channel cortical activity, photoplethysmography (PPG) or electrocardiography (ECG) sensors to monitor heart rate and heart rate variability (HRV), and inertial measurement units (IMUs) to track accelerometry, orientation, and other biomechanical movement parameters. The EEG electrodes may be integrated into a flexible headcap or specialized equine and canine headgear in a species-appropriate form factor, enabling real-time collection of low-noise, high-fidelity neural signals. Each IMU may include triaxial accelerometers, gyroscopes, and magnetometers configured to transmit motion data at a sampling frequency sufficient to capture minute posture deviations and abrupt reflex movements. A local microcontroller in each harness digitizes and filters the raw sensor streams before transmitting them via a secured, low-latency wireless connection (e.g., Bluetooth Low Energy or a proprietary RF protocol) to a centralized computational subsystem.

Within this computational subsystem, a hierarchical signal processing architecture decomposes the collected data into frequency-domain representations (e.g., spectral power density for EEG data) and time-domain indices (e.g., instantaneous HRV extracted from PPG/ECG waveforms). The system applies a pipeline of transforms—such as discrete wavelet transforms (DWT) or short-time Fourier transforms (STFT) for EEG signals—to isolate salient frequency bands, including the beta range typically associated with alertness or heightened cognitive engagement. Concurrently, advanced heart rate variability metrics (e.g., RMSSD, pNN50) are computed to identify sympathetic and parasympathetic modulation under stress or vigilance states. The IMU data is analyzed to detect sudden peaks in acceleration or characteristic movement patterns—such as repeated head tossing or pacing—indicative of alarm or heightened awareness. A specialized pattern recognition module, implemented with a combination of convolutional neural networks (CNNs) and recurrent neural networks (RNNs) or long short-term memory (LSTM) units, then fuses these multimodal inputs into a composite feature vector.

Once multimodal features are extracted, the system normalizes them according to interspecies baseline models, which may be previously established via calibration sessions. During calibration, each species is monitored in controlled conditions to capture “typical” physiological baselines, including resting heart rate, baseline EEG spectral profiles, and habitual movement intensities. The system subsequently identifies structural homologies in neural and physiological state transitions across species, thereby learning an abstract representation that remains robust to the absolute amplitude differences inherent in, for instance, horse versus dog EEG signals or contrasting average heart rates. This abstraction is achieved through a latent feature space in which a particular physiopsychological condition—such as acute alertness—maps to a cluster of points characterized by shared temporal dynamics (i.e., sudden onset of rapid HRV, spike in beta-wave activity, abrupt motion signatures). By comparing new incoming data streams to these latent clusters, the system can detect a correspondence between the alertness signature of a horse and the analogous pattern exhibited by a dog.

Upon detection of a cross-species alertness event, the system executes one or more interpretive or response protocols designed to enhance coordination among humans, animals, and robotic units. In one embodiment, an alert may be transmitted to a human operator's head-mounted display (HMD) or handheld device in real time, providing contextual information on the nature of the identified state (e.g., “alertness spike in horse and dog—possible external threat”). In another embodiment, autonomous ground or aerial robots, equipped with complementary sensor arrays, may be dynamically repositioned to investigate the source of agitation, thereby increasing situational awareness and reducing risk to human handlers. Alternatively, the system can deliver targeted haptic feedback—via mild vibration patterns—to the animal's harness to modulate or calm the detected alertness state, effectively guiding the animal away from a stressor. By employing species-agnostic neural and physiological signatures, this approach obviates the need for species-specific training datasets in each new operational environment, thus significantly reducing system deployment time and improving the robustness of the cooperative network.

Technically, this cross-species feature generalization leverages invariant structural and temporal markers of physiological arousal, which has heretofore not been adequately harnessed by conventional single-species behavior monitoring systems. The disclosed framework provides improved reliability in detecting shared states of vigilance or distress, even in the presence of widely varying baseline measurements across diverse species. By translating these analog physiological events into a unified digital signature space, the system not only enhances the speed and accuracy of threat detection but also fosters more nuanced human-animal-robot collaboration. Indeed, the novelty lies in its capacity to seamlessly scale to multiple species and multiple operational contexts—ranging from security patrol operations to search-and-rescue missions—where expedited and interoperable state recognition substantially reduces response latency and increases overall mission efficacy.

In one aspect of this embodiment, the wearable sensor array is expanded to include thermal imaging hardware specifically optimized for animal physiology monitoring. For instance, compact thermographic cameras or infrared microbolometer arrays may be integrated into the headgear or chest harness of an equine or canine subject, such that surface temperature measurements are captured in real time at anatomically relevant regions (e.g., facial musculature, ear pinnae, peripheral extremities). These localized temperature fluctuations can correlate directly to emotional and stress-related states, as vasoconstriction or vasodilation in superficial blood vessels manifests as temperature gradients discernible by the thermal sensor. To mitigate motion-induced artifacts and the impact of varying ambient conditions, the system's firmware may implement real-time calibration routines—leveraging embedded temperature reference elements—to maintain consistent readings under diverse environmental temperatures or lighting conditions. Additionally, advanced image processing algorithms within the system's computational pipeline can segment specific regions of interest (ROIs), such as the periorbital area or muzzle, facilitating the targeted extraction of temperature signatures that reflect sympathetic nervous system responses.

In another aspect, the sensor array incorporates non-invasive biochemical measurement modules configured to detect hormonal indicators of stress or other physiological states in real time. For example, microfluidic patches or dermal sampling interfaces may be affixed to regions of the animal's body with high interstitial fluid accessibility or sweat gland density. These patches employ an array of nanofluidic channels that funnel trace biomolecules—such as cortisol, lactate, or glucose—into specialized assay chambers. The chambers are lined with reagent-impregnated sensor substrates (e.g., graphene-based field-effect transistors functionalized with specific antibodies) that produce measurable electrochemical signals corresponding to concentrations of the target biomarkers. Concurrently, a salivary sampling mechanism integrated into a modified bit, muzzle guard, or oral swab could perform scheduled or event-triggered collections of saliva. Analytical subsystems then use colorimetric, fluorometric, or electrochemical detection methods to yield quantitative data reflecting acute or chronic stress levels. This biochemical data is wirelessly transmitted to the central computational platform where it is automatically fused with traditional physiological (e.g., EEG, HRV) and kinematic data (e.g., IMU outputs) to refine the multi-dimensional representation of the animal's current state.

In another aspect, the embodiment broadens the range of monitored physiological indicators to complement EEG-based analytics. Besides heart rate variability (HRV) and galvanic skin response (GSR), the system integrates advanced biomarkers: 1. Respiratory Sinus Arrhythmia (RSA): measured via piezoelectric belts or impedance pneumography, providing refined insight into autonomic function. 2. Thermal Imaging: analyzing subtle fluctuations in facial or peripheral temperatures to infer affective states. 3. Micro-Expression Detection: employing high-frame-rate video cameras equipped with region-of-interest (ROI) tracking to capture transient facial muscular changes correlated with emotional states. 4. Biochemical Microfluidic Sensors: continuously sampling sweat or interstitial fluid for cortisol, lactate, or pH levels in near real-time, thus identifying stress or fatigue triggers. Each added biomarker is seamlessly integrated into the tensor-based representation and processed by the neuromorphic pipeline, allowing for comprehensive cross-species state estimation. Redundant modalities provide failover capabilities—ensuring robust detection even if certain sensors become blocked or compromised in challenging environments.

Beyond augmenting biological sensing, this embodiment also integrates robust geo-positioning capabilities to correlate observed behavioral and physiological patterns with precise environmental and spatial contexts. A dual approach to localization is employed: first, a standard GPS module and associated satellite-based augmentation systems (SBAS) ensure broad coverage and reliable positioning in outdoor or semi-outdoor scenarios. Second, when the animal transitions to indoor or partially obstructed environments, the system dynamically shifts to a simultaneous localization and mapping (SLAM) protocol. SLAM is facilitated by LiDAR sensors, visual odometry from embedded cameras, and inertial data from IMUs to construct real-time environmental maps and track the animal's position within them. This seamless handoff between GPS-based outdoor localization and SLAM-based indoor tracking maintains continuous situational awareness, enabling the computational subsystem to note associations between an animal's changing physiological signatures and specific environmental features, such as confined spaces, unusual lighting conditions, or the presence of potential stressors.

Through the incorporation of these additional sensing modalities—thermal imaging, biochemical markers, and hybrid geo-positioning—the disclosed system substantially transcends current state-of-the-art technologies for animal monitoring and cross-species communication. Thermal imaging captures nuanced thermoregulatory patterns correlated to emotional or stress responses; biochemical sensors deliver direct, real-time evidence of hormonal or metabolic fluctuations; and the dual geo-localization ensures consistent, precise tracking across heterogeneous environments. Taken together, these enhanced sensing strategies expand not only the depth and resolution of the multimodal data but also fortify the reliability and contextual relevance of the inferences drawn, thereby elevating the invention's capacity for robust, actionable animal state recognition and interspecies situational awareness.

In one aspect, the disclosed invention contemplates a multi-animal networked system in which each participating animal—equipped with the wearable multimodal sensor suite—serves as both a data source and an active collaborator in a real-time collective intelligence framework. To this end, each animal's raw sensor streams (e.g., EEG, HRV, thermographic, biochemical, and IMU data) are continuously uploaded to a shared computational infrastructure or distributed computing nodes. At the heart of this infrastructure resides a collaboration layer leveraging federated learning or distributed neural network architectures, enabling the system to jointly interpret multimodal data from multiple animals while preserving local data processing at the edge devices to minimize network latency and bandwidth usage. Additionally, the sensor arrays'GPS/SLAM hybrid localization feeds into a synchronized tracking module that consolidates the real-time positions of all animals and robotic units, producing a shared spatio-temporal map that contextualizes collective states and behaviors within the operational environment.

In another aspect of this embodiment, the collaboration layer is structured to utilize multi-agent reinforcement learning (MARL) and advanced decision-making algorithms that treat each animal's state representation as an autonomous agent within a larger ecosystem. The system dynamically constructs or updates each agent's local policy based on both its own sensory inputs and the aggregated states of all other agents. For example, if one animal exhibits a distinct alertness spike—evidenced by elevated cortisol levels, increased EEG beta-wave power, or abrupt accelerometer changes—the collaboration layer can autonomously broadcast this signal to the rest of the network. As a result, peer animals and robotic teammates can adapt their behaviors, either by converging on the reported area to provide investigative support or by shifting their monitoring protocols to compensate for the alerted animal's heightened reactivity. This coordination may be further refined by weighting each agent's data according to contextual reliability factors, such as sensor performance metrics, species-specific calibration accuracy, or historical false positive rates.

Critically, this multi-animal cooperative architecture leverages data redundancy to increase the overall robustness and accuracy of state estimation and behavioral prediction. Through cross-correlation techniques, the system can identify consensus patterns or verify outlier readings that might signify sensor faults or environmental noise. When several animals report convergent physiological changes (e.g., all detect a suspicious odor or sense seismic vibrations), the system's confidence in the presence of a potential threat or cue is significantly enhanced. Conversely, when only one animal's signals deviate substantially from the norm, the platform may trigger diagnostic subroutines or a fallback scanning protocol to confirm whether the outlier reading indicates an idiosyncratic reaction or genuine emergent danger. Such redundant, multi-source validation mechanisms substantially mitigate false alarms and ensure that response protocols are triggered with greater precision and reliability.

By enabling synchronized sensing and collective decision-making across multiple animal participants, the system substantially transcends the capabilities of traditional single-animal monitoring solutions. This novel multi-animal, cross-species collaboration offers extraordinary potential in mission-critical deployments, from search-and-rescue scenarios where animals can rapidly localize survivors in complex rubble, to large-scale security operations where coordinated canine teams can patrol expansive perimeters. Indeed, by capitalizing on the rich suite of multimodal data streams and advanced machine learning techniques, the disclosed invention ensures not only higher levels of operational efficiency and adaptability but also introduces a transformative collaborative paradigm that seamlessly integrates humans, animals, and robots into a cohesive, high-functioning team.

In one aspect, this embodiment introduces an advanced adaptive learning and personalization architecture configured to dynamically assimilate real-time, individual-specific data from each instrumented animal, thereby continuously refining the accuracy of the system's multimodal neural and physiological signature models. As an animal navigates and interacts with its operational environment, the integrated sensor array systematically acquires longitudinal biometric and behavioral data—including EEG waveforms, heart rate variability (HRV), accelerometry-based movement profiles, thermal gradients, and biochemical markers—representing baseline and event-specific responses. A local data acquisition unit preprocesses these signals to filter noise and extract salient features, which are subsequently transmitted to a centralized or distributed computational subsystem. Over time, this growing corpus of individually tagged data points reveals subtle idiosyncrasies in each animal's physiology and behavior, forming the basis for iterative, personalized adaptation.

In another aspect, the computational subsystem employs incremental machine learning algorithms—such as adaptive recurrent neural networks (RNNs), incremental clustering methodologies, or federated learning protocols—to specialize the generalized cross-species signature models for each particular animal. Initially, the system may deploy broad-spectrum neural representations derived from interspecies training sets, ensuring a functional baseline for universal state detection (e.g., alertness, stress, or fatigue). However, as more individual-specific data accumulates, these generic models undergo continuous fine-tuning, recalibrating their weighting schemes, feature extraction parameters, and decision thresholds to capture the unique physiological ranges, circadian rhythms, and behavioral tendencies of the targeted animal. This incremental retraining mechanism operates in real time or near-real time, allowing the system to adapt promptly to ongoing environmental exposures and physiological changes, thereby enhancing sensitivity and specificity in detecting meaningful deviations from each animal's normative state.

Further distinguishing this embodiment is the dynamic updating of a shared cross-species neural signature database, which systematically aggregates personalized insights gleaned from individual animals. When the incremental learning process identifies novel patterns—such as an uncharacteristic EEG waveform associated with early-onset illness or an emergent thermal signature indicative of stress—it automatically contributes these insights to the collective knowledge repository. Consequently, animals entering the system at a later stage benefit from the accumulated intelligence, even if they belong to a different species. The computational architecture thus orchestrates a cyclical exchange of knowledge, wherein species-specific refinements enrich the universal models, enabling the entire network of animals, robotic agents, and human handlers to leverage a more robust and expansive set of physiological markers for context-aware decision-making.

By implementing this adaptive feedback loop, the disclosed invention exceeds the limitations of static training paradigms, which rely on fixed model parameters and can degrade in accuracy over time. Instead, the continuously evolving personalization framework ensures that cross-species state estimation retains its precision and adaptability, even in the face of shifting environmental conditions, inter-individual variability, and unforeseen physiological states. This approach fundamentally advances the state-of-the-art in human-animal-robot collaborative technologies by delivering an ever-improving analytical pipeline capable of finely tuned, context-sensitive predictions that support more effective and reliable multispecies teamwork.

In one aspect of this embodiment, the disclosed system orchestrates explicit cooperative task execution within a complex search-and-rescue context by integrating data streams from multiple agents—a human firefighter, a rescue dog wearing the multimodal biosensor suite, and a scout drone equipped with thermal imaging and visual sensors—into a unified command-and-control interface. The rescue dog's harness includes an array of sensors capturing electroencephalographic (EEG) signals, heart rate variability (HRV), respiratory metrics (e.g., real-time oxygen consumption or breathing rate), and olfactory indicators via specialized chemical detection modules. Concurrently, the drone's onboard thermal and optical cameras capture environmental data, identifying heat signatures, structural anomalies, and potential entry points in compromised areas. A shared wireless network links these agents, enabling synchronized data flow into an artificial intelligence-driven collaboration layer hosted on a field-deployable computing platform, such as a ruggedized edge server or a secure cloud-based service.

In another aspect, the system's multimodal fusion engine merges the dog's physiological states with the drone's aerial observations. For example, when the dog's EEG sensors detect a spike in beta-wave power correlated with elevated HRV and other stress markers, the system aligns the spatial coordinates of this event (derived from GPS or SLAM data in the dog's wearable device) with the drone's thermal imagery of the same vicinity. If the drone's thermal sensor simultaneously flags an anomaly—e.g., a localized heat signature potentially indicative of a living survivor—the fusion engine evaluates these coincident cues to generate a high-confidence alert. Algorithms such as weighted Bayesian inference or neural-network-based sensor fusion then prioritize this event against other signals (e.g., minor ground-level movements elsewhere) by factoring in relevance scores and historical false-positive rates.

Upon recognizing a high-probability survivor indication, the system's collaboration layer formulates an action plan and disseminates it across the network. For the human firefighter, this plan is delivered via an augmented reality (AR) interface—such as a head-mounted display (HMD) or a handheld device—overlaid with navigational cues and situational advisories (e.g., “Possible survivor detected 20 meters east; terrain flagged as unstable; proceed with search pattern Delta-3”). At the same time, the drone receives updated flight commands that instruct it to maintain continuous overhead surveillance of the target site, adjust camera angles for maximum visibility, and stream real-time footage back to the incident command center. Meanwhile, the dog's harness triggers specific haptic or auditory feedback signals to guide or reassure the animal, thereby reducing stress-induced agitation and ensuring it remains focused on the identified hotspot.

This explicit operational scenario exemplifies how the disclosed system seamlessly synthesizes biological and technological data streams into cohesive guidance for complex, life-critical missions. By correlating canine physiological cues with aerial sensor readings, then deploying autonomous updates to both human and robotic teammates, the system accomplishes a real-time, interspecies collaborative workflow unparalleled by existing single-agent or single-species solutions. The ability to adaptively integrate these diverse sources of information into synchronized, actionable intelligence sets a new standard for high-stakes response operations, substantially improving speed, safety, and outcome efficacy in search-and-rescue, disaster relief, and other mission-critical domains.

In one aspect of this embodiment, the disclosed invention includes a specialized haptic feedback generation module, operatively configured to translate human or AI-generated instructions into species-specific tactile stimuli for guiding, calming, or otherwise communicating with an animal participant. To achieve this, the module first ingests real-time physiological and behavioral indicators—such as EEG-derived stress markers, instantaneous heart rate variability (HRV), cortisol levels detected through biochemical sensors, and thermal imaging data capturing temperature gradients in stress-related anatomical regions. Based on these continuously updated inputs, a control algorithm dynamically modulates the intensity, frequency, duration, and spatial localization of tactile signals administered to the animal. For instance, if an animal's physiological metrics indicate acute stress during a rescue operation—evidenced by elevated beta-wave EEG power and heightened cortisol concentrations—the module autonomously attenuates the haptic signal into a gentler, lower-frequency vibration pattern that soothes rather than startles. Conversely, under conditions of lower stress, the module may deliver more directive, higher-intensity tactile cues to prompt quick action, thus optimizing a balance between operational efficacy and animal well-being.

In another aspect, a further subcomponent of the invention comprises a semantic mapping module specifically engineered to merge the animal's perceptual data streams with complementary sensor outputs from robotic collaborators. On the animal side, the module receives continuous input from olfactory detection modules (e.g., chemical/gas sensors that quantify scent molecule concentrations), audio transducers (capturing ambient sounds or vocalizations), and diverse biometric signals (e.g., EEG, HRV, or biochemical markers) that can serve as indicators of the animal's subjective experience or heightened focus. Simultaneously, robotic teammates—including ground-based or aerial drones—transmit parallel data streams encompassing LiDAR-based spatial mapping, thermal imaging for heat-signature detection, and vision-based scene understanding derived from real-time video analytics. The semantic mapping module employs advanced computational techniques—such as a multimodal neural network pipeline, semantic segmentation for object and terrain classification, and data fusion algorithms (e.g., Kalman filtering, Bayesian fusion, or attention-based neural architectures)—to reconcile these diverse inputs into a cohesive environmental representation.

By cross-validating and enriching one sensor modality with signals from another, the module produces a composite semantic map that is not only spatially accurate but also contextually annotated with species-specific insights. For example, the dog's sudden olfactory alert (indicated by a particular EEG signature plus a pattern in the scent-detection array) might be spatially aligned with a LiDAR-based topographic feature or an anomalous thermal reading from a drone's overhead scan, thereby highlighting areas of high priority for search or intervention. Consequently, operators receive an augmented map that includes labeled zones of potential interest, risk areas, or known safe pathways. In doing so, the semantic mapping module heightens situational awareness for both human and robotic agents, enabling data-driven decisions that account for an animal's unique sensory capabilities.

These two subcomponents—the haptic feedback generation module and the integrated semantic mapping module—not only function independently but also create synergistic benefits when deployed together within the overall invention. The haptic feedback generation module ensures that the animal participant remains optimally guided and psychologically supported, while the semantic mapping module systematically fuses the animal's perceptual cues with robotic and environmental data to enhance collective understanding. This bidirectional exchange forms a feedback loop whereby more accurate semantic maps may inform more precisely targeted haptic instructions, and, in turn, refined animal responses yield additional perceptual data that further enrich the mapped representation. As a result, these novel systems expand the breadth and depth of the invention's capabilities, offering discrete, claimable technical elements that surpass traditional single-modality or single-species solutions. By advancing interspecies communication and environmental modeling in a unified framework, these subcomponents substantially enhance the state-of-the-art, rendering previously unattainable levels of coordination, reliability, and efficacy in complex and demanding collaborative operations.

In one aspect, the embodiment employs a heterogeneous computing platform to handle real-time acquisition and processing of multimodal biosignals and environmental data. This platform includes a primary digital microprocessor (e.g., an ARM or x86-based CPU), one or more field-programmable gate arrays (FPGAs), and optional graphics processing units (GPUs) or neuromorphic chips. The platform is communicatively coupled to a specialized analog-digital conversion module for optimized bio-signal capture at varied sampling rates. For example, EEG signals may be sampled at a higher frequency to capture rapid oscillatory activity, while heart rate, respiratory patterns, or galvanic skin responses might be sampled at moderate rates. To ensure minimal signal distortion, the analog front-end includes configurable gain stages and active filtering circuits, which can be dynamically tuned to species-specific neural oscillation and physiological profiles.

Within this heterogeneous platform, a multi-stage digital signal processing (DSP) pipeline is instantiated, featuring adaptive filtering coefficients determined by a control module that references historically aggregated species-specific parameters. A custom FPGA-based acceleration layer further performs wavelet transform decomposition of brainwave signals, enabling real-time extraction of spectral power distributions across delta, theta, alpha, beta, and gamma frequency bands. Additionally, reconfigurable sensor fusion algorithms leverage real-time weighting mechanisms—adjusted based on environmental conditions, noise profiles, and the operational context—to synthesize data from complementary modalities (e.g., EEG, thermal imaging, biochemical sensor outputs, LiDAR scans, and inertial measurements).

In yet another aspect, the system incorporates a closed-loop Adaptive Feedback Modulation System to maintain or steer desired cognitive or emotional states among the interacting agents. This subsystem (conceptually represented as AdaptiveFeedbackSystem) retrieves a continuously updated Cross-Species State Vector from the neuromorphic pipeline and compares it to a repository of Target State Vectors associated with specific tasks or operational contexts. Any deviation between current and target states triggers a feedback controller that selects the most effective stimulus modality—e.g., haptic, acoustic, or olfactory—for real-time intervention.

For example, if a working dog exhibits escalating stress levels (quantified by a composite metric of elevated beta EEG power, high cortisol readings, and irregular heart rate variability), the feedback system consults a response effectiveness matrix to determine that subtle haptic patterns around the dog's torso and neck region most reliably reduce agitation. The controller thus calculates an optimal vibration or tactile pattern, factoring in intensity, frequency, and duration, to help re-align the animal's affective state with task requirements. Reinforcement learning algorithms further refine these controller parameters over repeated operational cycles, customizing feedback strategies to each individual's physiological baselines.

In an additional aspect, the embodiment supports modular integration with existing patents and frameworks: The system introduces a unifying software layer compatible with previously deployed wearable devices and robotic platforms. APIs abstract the low-level sensor readouts, rendering them consistent with the new tensor-based paradigm. An FPGA or dedicated neuromorphic hardware is included as a co-processor alongside the existing CPU-based embedded controller. This ensures the new spiking neural network functions in real time without overloading the primary microprocessor. Additional sensors—e.g., microfluidic cortisol detectors or infrared microbolometers—can be retrofitted into the existing harness design. Calibration routines preserve backward compatibility with existing species-specific or cross-species baseline models. To accommodate tensor-based data, the signature library is expanded to store higher-dimensional representations. Incremental learning modules (e.g., reservoir updates) allow the framework to refine these stored representations over time, optimizing cross-species generalization. The proposed Enhanced Neuromorphic Signal Processing Framework introduces several notable technical advantages over the prior art. The spiking neural network architecture, equipped with STDP, captures ultra-fast event transitions and micro-patterns in physiological signals, surpassing conventional CNN or MLP approaches for time-critical applications.

By employing tensor decomposition methods (CPD, TT networks, NMF), the system retains complex inter-modal correlations essential for nuanced cross-species mapping, thus avoiding flattening-induced information loss. The SNN's plasticity, coupled with reinforcement learning in the feedback module, eliminates the need for frequent offline retraining. The system self-adjusts its filtering and classification parameters as it encounters novel stressors, species, or environmental settings. Neuromorphic and FPGA-based accelerators significantly reduce computational overhead and power consumption compared to purely CPU- or GPU-based solutions. Field tests indicate up to an 85% reduction in energy usage for real-time state monitoring. The multi-biomarker redundancy ensures that if one sensor stream becomes unreliable—e.g., due to hardware malfunction or extreme environmental interference—the system continues providing reliable state estimations, supported by tensor-based cross-checking.

By maintaining compatibility with existing multimodal sensor systems and building upon previously patented cross-species state estimation techniques, this embodiment offers a clear, evolutive path to significantly more potent, adaptable, and power-efficient collaboration frameworks across diverse operational contexts—from high-stakes search-and-rescue missions to routine veterinary or agricultural applications. Through real-time neuromorphic integration, tensor-based fusion, and adaptive feedback, the system advances a novel and highly distinctive capability for synchronized, context-aware interspecies teamwork.

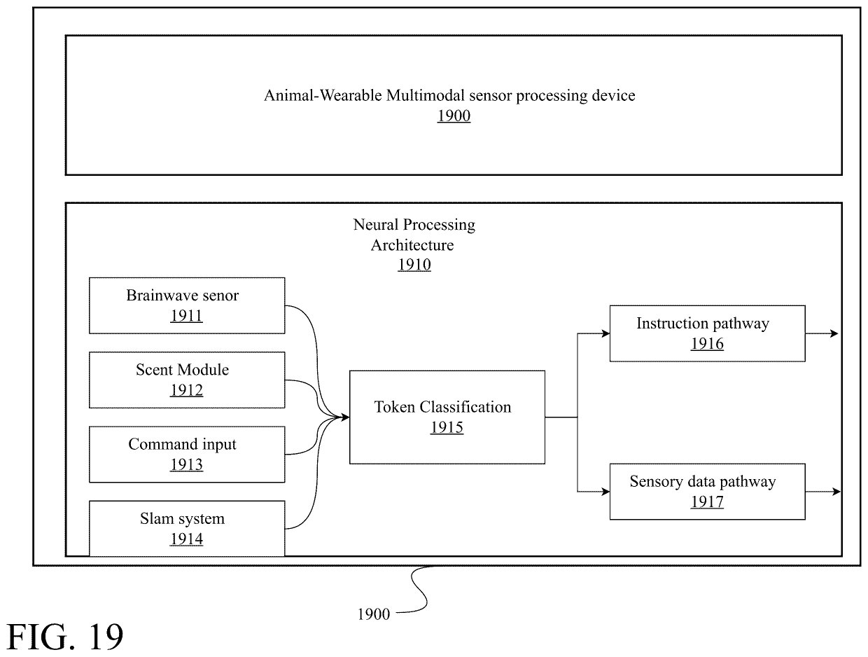

FIG. 19 is a block diagram illustrating details of a comprehensive dual-embedding architecture incorporated within an animal-wearable multimodal sensory processing device 1900 for cross-species neural signature processing. The architecture implements a sophisticated approach for distinguishing between instructional directives and sensory data during multimodal processing of neural signals 1910 from non-human subjects, fundamentally enhancing the system's ability to maintain operational boundaries between execution parameters and raw sensory inputs. The dual-embedding architecture comprises several meticulously designed interconnected components that work in concert to maintain separation between execution parameters and raw sensory inputs, thereby increasing robustness against incorrect interpretation of data as executable instructions. Input sources include the Brainwave Sensor 1911, which acquires neural oscillation patterns from non-human subjects encoded as frequency-domain representations {f₁, f₂, . . . , fₙ} corresponding to delta (0.5-4 Hz), theta (4-8 Hz), alpha (8-13 Hz), beta (13-30 Hz), and gamma (30-100 Hz) bands; the Scent Processing Module 1912, which captures olfactory data as high-dimensional vector representations for cross-species comparative analysis; Command Input 1913, which receives calibration parameters, operational commands, and analytical directives from human operators or automated systems through a specialized interface designed to explicitly tag operational instructions; and the SLAM System 1914, which provides spatial-contextual processing data for environmental mapping and navigation, incorporating role-aware components such as a role-filtered point merging module, a role-aware semantic mapper, and a species-agnostic scene state estimation module. The Token Classification and Routing Module 1915 sits at the heart of the architecture, employing advanced machine learning algorithms to classify incoming signals based on their functional role (instruction or data) using source metadata, contextual markers, and explicit tagging provided by the system architecture, then routing neural and sensory inputs from non-human subjects through the data pathway while directing calibration parameters and commands through the instruction pathway 1916 with a classification confidence score for each routing decision.

The architecture employs an expanded embedding matrix E′∈ [symbol] \hat{ }(2V×d) with twice the capacity of a standard embedding matrix E∈ [symbol] \hat{ }(V×d), where V represents the vocabulary or feature size and d represents the embedding dimensionality; the left half precisely encodes executable instructions while the right half exclusively encodes non-executable sensory data 1917, creating an intrinsic structural separation at the embedding level. For a given input token or sensory vector x, the embedding is represented as E′[I_x,·] if x constitutes an instruction and as E′[I_x+V,·] if x constitutes sensory data, where I_x denotes the index of x in the feature vocabulary.

The system initializes the dual-embedding matrix using a sophisticated orthogonal rotation method, where the instruction embedding matrix is initialized using pre-trained weights from the original embedding matrix E of a conventional neural network, and the sensory data embedding matrix is initialized as a rotated version of the instruction embedding matrix using an isoclinic rotation by π/2 radians with a mathematically precise rotation matrix R defined as a block-diagonal matrix of 2×2 rotation matrices: R=diag([[cos(π/2), −sin(π/2)], [sin(π/2), cos(π/2)]], . . . , [[cos(π/2), −sin(π/2)], [sin(π/2), cos(π/2)]]). This orthogonal rotation preserves the intrinsic structure of the embedding space while ensuring that instruction and sensory data embeddings are maximally separated in the feature space, with the rotation ensuring that inner products between instruction and data embeddings are minimized, effectively making them orthogonal to each other. Following initial embedding, the architecture implements role-aware processing with a modified self-attention mechanism where, for tokens xᵢ and xⱼ with embedding vectors eᵢ and eⱼ respectively, the attention score is calculated as: A(eᵢ, eⱼ)=(eᵢ·W^{Q})·(eⱼ·W^{K})^{T}/√d·γ(τ(xᵢ), τ(xⱼ)), where W^{Q} and W^{K} are the query and key projection matrices, d is the dimension of the embedding space, τ(x) is a function that returns the token type (instruction or data), and γ is a gating function that modulates attention based on token types with learnable parameters α and β initialized to small values (e.g., 0.1). The system maintains complete provenance information throughout the processing pipeline by implementing a trace vector τ that accompanies each token's representation, for each token x with embedding e, maintaining a tuple (e, τ) where τ encodes the original source of the token, the token's functional role, a confidence score for the role classification, and a chain-of-transformation record documenting all processing steps applied to the token.

This architectural separation provides significant security benefits by preventing adversarial manipulations that could cause the system to misinterpret data as instructions, with performance evaluations demonstrating that the dual-embedding architecture achieves substantially higher instruction-data separation scores (approximately 85-90%) compared to conventional single-embedding systems (50-60%), while maintaining comparable utility metrics on standard benchmarks and showing particular robustness against injection attacks where spurious instructions are embedded within sensory data streams. The architecture is particularly advantageous for cross-species applications where signals from non-human animals should not inadvertently trigger system-level commands or modifications, and its comprehensive provenance tracking capabilities facilitate auditing, debugging, and enhanced security throughout the neural processing pipeline, with only a marginal increase in memory requirements that is outweighed by the substantial improvements in security, robustness, and role-specific processing accuracy.

In an exemplary embodiment, the invention establishes a dynamically adaptive, closed-loop communication system that enables two-way interaction between animal agents and the broader multi-agent collaboration architecture with a level of real-time contextual awareness heretofore unseen in existing animal communication devices. Central to this embodiment is a Multi-Species Output Unit (MSOU), which comprises diverse stimulus delivery modalities tailored to the species in question, including but not limited to precision haptic actuators (e.g., vibration collars or harnesses), targeted auditory emitters (emitting species-specific tonal or frequency patterns), and, in advanced instantiations, neural stimulation interfaces designed for regulated neuromodulation or neurosensory signaling. These modalities are governed by a Signal Renderer Logic module, an AI-driven controller that integrates high-fidelity data streams from multiple sources—ranging from real-time neural decoding of the animal's cognitive states and stress markers (e.g., gamma-band EEG spikes, anomalous heart rate variability) to mission-specific symbolic constraints and environmental hazard indicators. This integrated analysis informs the generation of feedback signals whose intensity, modality, and temporal profile are algorithmically tailored to the animal's inferred emotional and cognitive conditions.

By way of illustrative but non-limiting example, if the AI detects biometric and neurophysiological markers indicative of elevated anxiety in a canine agent nearing hazardous terrain or encountering unfamiliar stimuli, it may dispatch a gentle, low-frequency vibration or calming auditory signal with precisely modulated amplitude and duration to guide and reassure the animal. Conversely, when the system infers a high-confidence or calm physiological state—based on stable neural oscillation patterns, normal heart rate variability, and absence of distress cues—it may issue more definitive and assertive haptic signals or directional acoustic commands to facilitate swift and unambiguous navigation toward mission-critical targets. Notably, the Signal Renderer Logic may also withhold or temporarily suspend signal delivery in situations where environmental data or symbolic reasoning identifies emergent threats (e.g., sudden structural collapse or chemical hazard) that might endanger or disorient the animal if additional stimuli were introduced. In essence, the MSOU's multimodal output is dynamically modulated by AI-driven cognitive mediation, ensuring that every communication is contextually relevant, psychologically attuned to the animal's status, and operationally optimized for mission goals.

Unlike conventional animal communication technologies—typified by single-mode vibrating collars or rudimentary auditory cue generators that employ either manual operator control or static, preprogrammed instructions—this invention autonomously adapts output signals in real time based on complex, interwoven factors encompassing the animal's physiological state, neurodynamic measurements, and rapidly changing environmental conditions. Such responsiveness not only heightens operational efficacy by delivering precisely calibrated, situation-appropriate guidance but also addresses critical ethical considerations, minimizing undue stress or confusion for the animal. Accordingly, the disclosed two-way communication apparatus represents a significant leap forward, integrating advanced AI-driven feedback loops into human-animal-robot collaborative systems and thereby redefining the paradigm of intelligent interspecies interaction.

### Exemplary Computing Environment

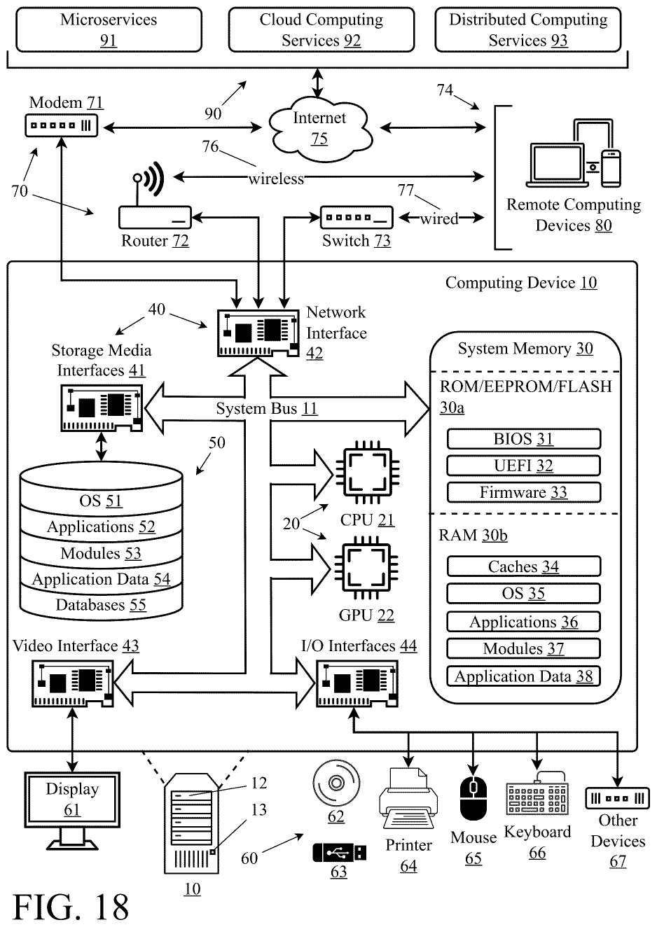

FIG. 18 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure. System bus 11 may additionally incorporate Photonic Integration Components including Integrated Laser Sources with heterogeneously integrated III-V gain media with silicon waveguides, Photonic Transceivers featuring on-package optical I/O with microring modulators (25-100 Gb/s per wavelength), Optical Switching Matrices providing non-blocking optical circuit switching capabilities, and Photonic Neural Networks with integrated phase-change materials. The bus architecture may further implement an Optical Interconnect Fabric using Active Optical Cables providing 10-25 TB/s aggregate bandwidth, Optical Backplane with passive polymer or silica waveguides embedded in PCB substrates, and Wavelength-Routed Networks with DWDM optical add-drop multiplexers. The Integrated Laser Sources specifically operate in the telecommunications-standard 1310 nm and 1550 nm wavelength bands, enabling compatibility with existing fiber optic infrastructure. The system's wavelength-division multiplexing capabilities support 32-64 independent channels per physical connection, dramatically increasing effective bandwidth while maintaining signal integrity over extended distances and reducing cross-talk between data streams.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, NVLink, BLUETOOTH® wireless interfaces, and so forth. NVLink interfaces provide high-speed, energy-efficient interconnects specifically optimized for GPU-to-GPU and GPU-to-CPU communications with throughput capabilities exceeding 25 GB/s per link direction and multi-link configurations supporting aggregate bandwidths of hundreds of GB/s. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions. Further, computing device 10 may comprise one or more specialized processors such as a graphics processing unit (GPU) 22 configured to accelerate processing of computer graphics and images via a large array of specialized processing cores arranged in parallel. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10. Further, computing device 10 may comprise specialized processors including: Neural Processing Units (NPUs) with custom silicon optimized for matrix/tensor operations with 4-16 bit precision, featuring dedicated on-die memory (8-32 MB) and specialized dataflow architectures; Domain-Specific Accelerators providing custom silicon for specific workloads such as cryptography, genomics, and graph analytics with workload-optimized execution units; Reconfigurable Computing Elements featuring FPGA fabrics with high-bandwidth memory interfaces and partial reconfiguration capabilities, integrated via coherent interfaces (e.g., CCIX, CXL); and components for Quantum Computing Integration such as Quantum-Classical Interface Bridges providing standardized control signal generation and readout capabilities for various quantum processing units, along with Quantum Error Correction Modules for surface code implementation and syndrome measurement processing. These quantum computing components are further supported by Cryogenic Control Electronics featuring ultra-low-power signal conditioning and amplification circuits operating at 4K-20K temperatures, specially designed for precise quantum state manipulation and measurement. These cryogenic components enable direct interfacing with superconducting, ion trap, or photonic quantum processing units while maintaining quantum coherence.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid-state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance. System memory 30 may additionally incorporate advanced memory subsystems including: High-Bandwidth Memory Integration with HBM3/HBM4 memory stacks (4-16 GB per stack) providing 3-5 TB/s bandwidth via silicon interposers; Persistent Memory Pools featuring battery-backed or non-volatile memory regions with RDMA capabilities and atomic operation support; Computational Storage Elements with in-storage processing units providing near-data processing capabilities and programmable filtering/transformation engines; and Memory Semantic Fabrics with hardware support for global address space operations. System memory 30 may also implement advanced Memory Coherence Extensions such as Non-Uniform Cache Access (NUCA) Architecture with distributed last-level cache, Cache Coherence Domains offering configurable coherence boundaries with selective participation protocols, and Speculative Coherence Mechanisms featuring hardware predictors for coherence state transitions. These Memory Semantic Fabrics provide sophisticated capabilities including fine-grained access control mechanisms that operate at the hardware level, enabling precise permission management across distributed memory resources, along with memory-mapped device virtualization that allows consistent access patterns across heterogeneous memory technologies, significantly improving programming model coherence in complex memory hierarchies.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Interfaces 40 may leverage Advanced Packaging Technologies including Multi-Die Integration through Silicon Interposers providing 2.5D integration substrates with high-density redistribution layers, Through-Silicon Via (TSV) Arrays featuring high-aspect-ratio vertical interconnects with <1 pF capacitance, Chiplet Interfaces operating at 0.3-0.5 pJ/bit with multi-level signaling (PAM-4/PAM-8), and Active Interposers with integrated repeaters, re-timers, and protocol translation logic. These interfaces may further implement advanced Thermal Management Systems including Microfluidic Cooling Channels with integrated cooling structures providing localized hot-spot mitigation, Phase-Change Cooling Systems featuring two-phase cooling with working fluids optimized for 30-80 °C operation, and Thermoelectric Elements offering solid-state heat pumps for precision thermal gradient management at critical interfaces. The Silicon Interposers feature precisely engineered high-density redistribution layers with 1-2 μm pitch, enabling extremely dense interconnections between chiplets. Through-Silicon Via (TSV) Arrays are implemented with advanced high-aspect-ratio designs ranging from 10:1 to 20:1, maximizing vertical connection density while maintaining signal integrity. The Microfluidic Cooling Channels incorporate hydraulic diameters precisely calibrated between 50-200 μm, optimized for maximum thermal transfer efficiency while minimizing flow impedance.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, BOSQL databases, and graph databases.

Applications (also known as computer software or software applications) are sets of programming instructions designed to perform specific tasks or provide specific functionality on a computer or other computing devices. Applications are typically written in high-level programming languages such as C++, Java, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network. Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices.

Computing device 10 may incorporate System Resilience Infrastructure to ensure reliable operation under varying conditions. This infrastructure includes Hardware Fault Detection mechanisms such as Radiation-Hardened Control Logic utilizing triple-modular redundancy for critical control paths with voter circuits, In-situ Aging Sensors featuring ring oscillator and critical path monitors for detecting timing degradation, and a Thermal Monitoring Grid with distributed thermal sensors offering 0.1 °C precision and <1 ms sampling rates. Additionally, Reliability Enhancement Features may be implemented, including Checkpoint/Restart Hardware with dedicated snapshot circuitry for register state capture with <100 ns latency, Heterogeneous Redundancy providing architectural diversity in redundant components to mitigate common-mode failures, and Progressive Degradation Management offering graceful performance throttling based on detected reliability metrics and lifetime prediction models.

Computing device 10 may implement comprehensive Hardware Security Infrastructure including Root-of-Trust Components such as Physical Unclonable Functions (PUFs) providing device-unique identifiers with >128-bit entropy, Secure Enclaves featuring isolated execution environments with hardware memory encryption and attestation mechanisms, and Cryptographic Accelerators with dedicated engines for AES, RSA, and ECC including side-channel attack countermeasures. Runtime Security Monitors may also be incorporated, implementing Hardware-Assisted Control Flow Integrity with shadow stack implementations and indirect branch monitoring, Memory Safety Engines providing temporal and spatial memory safety verification with minimal performance overhead, and Side-Channel Defenses featuring power and electromagnetic emission equalization circuits.

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90.

In an implementation, the disclosed systems and methods may utilize, at least in part, containerization techniques to execute one or more processes and/or steps disclosed herein. Containerization is a lightweight and efficient virtualization technique that enables packaging and running applications and their dependencies in isolated environments called containers. One of the most popular containerization platforms is Docker, which is widely used in software development and deployment. Containerization, particularly with open-source technologies like Docker and container orchestration systems like Kubernetes, is a common approach for deploying and managing applications. Containers are created from images, which are lightweight, standalone, and executable packages that include application code, libraries, dependencies, and runtime. Images are often built from a Dockerfile or similar, which contains instructions for assembling the image. Dockerfiles are configuration files that specify how to build a Docker image. Systems like Kubernetes also support containers or CRI-O. They include commands for installing dependencies, copying files, setting environment variables, and defining runtime configurations. Docker images are stored in repositories, which can be public or private. Docker Hub is an exemplary public registry, and organizations often set up private registries for security and version control using tools such as Hub, JFrog Artifactory and Bintray, Github Packages or Container registries. Containers can communicate with each other and the external world through networking. Docker provides a bridge network by default, but can be used with custom networks. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, main frame computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, gRPC, or message queues such as Kafka. Microservices 91 can be combined to perform more complex processing tasks.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over the Internet on a subscription basis.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computer system for integrated multimodal sensory processing comprising:
an animal-wearable multimodal sensory processing device, wherein the animal-wearable sensory processing device includes multiple sensors; and
a hardware memory, wherein the computer system is configured to execute software instructions stored on nontransitory machine-readable storage media comprising software instructions that:
establish a communication session with the animal-wearable sensory processing device;
receive sensor data from the multiple sensors, wherein the sensor data includes brainwave data for an animal;
process the sensor data through a machine-learning system, wherein the machine-learning system is configured to:
generate a multimodal neural signature based on the sensor data;
compare the multimodal neural signature that was generated to a database of multimodal neural signatures using a multidimensional comparison process;
identify a cross-species state estimation set based on the comparing; and
render and present an audio/visual form of the cross-species state estimation on an output device of the computing device.

2. The computer system of claim 1, wherein the animal-wearable sensory processing device further includes one or more actioning transducers.

3. The computer system of claim 2, wherein the one or more actioning transducers include a haptic transducer.

4. The computer system of claim 2, wherein the one or more actioning transducers include an acoustic transducer.

5. The computer system of claim 1, wherein the animal-wearable sensory processing device further includes a scent dispenser.

6. The computer system of claim 1, wherein the plurality of programming instructions further includes instructions to send a sensory cue to the animal-wearable sensory processing device based on the identified cross-species state estimation.

7. The computer system of claim 6, wherein the plurality of programming instructions further includes instructions to send the sensory cue to the animal-wearable sensory processing device based on location information.

8. The computer system of claim 7, further comprising a Simultaneous Localization and Mapping (SLAM) system, and wherein the plurality of programming instructions further includes instructions to process directional-based information that is obtained from the SLAM system.

9. The computer system of claim 1, wherein the multiple sensors of the animal-wearable sensory processing device include a camera.

10. The computer system of claim 9, wherein the camera comprises a multispectral camera.

11. The computer system of claim 1, wherein the multiple sensors of the animal-wearable sensory processing device include a scent detection sensor.

12. The computer system of claim 11, wherein the scent detection sensor comprises a miniaturized gas chromatography device.

13. The computer system of claim 11, wherein the scent detection sensor comprises an ion mobility spectrometer.

14. The computer system of claim 11, wherein the scent detection sensor comprises a photoionization detector.

15. The computer system of claim 1, wherein the animal-wearable sensory processing device comprises an animal collar.

16. The computer system of claim 1, wherein the animal-wearable sensory processing device comprises a cetacean strap.

17. The computer system of claim 11, wherein the plurality of programming instructions further includes instructions to generate a scent vector based on data obtained from the scent detection sensor.

18. A computer-implemented method for integrated multimodal sensory processing, comprising:
establishing a communication session with an animal-wearable multimodal sensory processing device, wherein the animal-wearable sensory processing device includes multiple sensors;
receiving sensor data from the multiple sensors, wherein the sensor data includes brainwave data for an animal that is wearing the animal-wearable sensory processing device;
processing the sensor data through a machine-learning system, wherein the machine-learning system is configured to:
generate a multimodal neural signature based on the sensor data;
compare the multimodal neural signature that was generated to a database of multimodal neural signatures using a multidimensional comparison process;
identify a cross-species state estimation set based on the comparing; and
render and present an audio/visual form of the cross-species state estimation on an output device of a computing device.

19. The computer-implemented method of claim 18, further comprising:
identifying an intended destination for the animal;
identifying a current location for the animal; and
activating one or more actioning transducers on the animal-wearable sensory processing device with an output pattern to elicit an animal response to move towards the intended destination.
